(19) United States
(12) Patent Application Publication
(10) Pub. No.: US 2006/0015858 A1
(43) Pub. Date: Jan. 19, 2006

(54) System development method and data processing system

(76) Inventors: Tadaaki Tanimoto, Foothill Ranch, CA (US); Masurao Kamada, Higashimurayama (JP)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 10/533,062

(22) PCT Filed: Oct. 7, 2003
(86) PCT No.: PCT/JP03/12840

§ 371 Date: Apr. 28, 2005

(30) Foreign Application Priority Data
Oct. 28, 2002 (JP) 2002-313201

(51) Int. Cl. G06F 9/45

(52) U.S. Cl. 717/140

(57) ABSTRACT

Program descriptions (1) which define a plurality of devices by employing a program language capable of describing parallel operations are input, the input program descriptions are converted into an intermediate expression (S2), parameters which satisfy a real-time restriction are generated for the intermediate expression (S3), and circuit descriptions which are based on a hardware description language are synthesized on the basis of the generated parameters (S4). The intermediate expression is a concurrent control flow flag, a temporal automaton having a concurrent parameter, or the like. Parametric model checking is performed for the parameter generation. The program descriptions define the devices by using a “run” method, and define the clock synchronizations of the devices by using barrier synchronizations. Thus, a bus system meeting the real-time restriction can be designed.

### FIELD OF THE INVENTION

The present invention relates to a method which develops a digital circuit on the basis of a language capable of describing parallel operations, and further to a data processing system which synthesizes the hardware of a digital circuit on the basis of a language capable of describing parallel operations.

### BACKGROUND OF THE INVENTION

In recent years, system LSIs have fulfilled more and more important functions in realizing mobile computing environments. Besides, how a real temporal restriction is satisfied is often posed as a problem in mobile computing. Further, in case of designing the mounting of the system LSI so as to meet a required performance, the design of a bus system becomes important. It is the present situation, however, that only a method based on a system simulation has been proposed as design techniques for efficiently designing the bus system so as to satisfy the real temporal restriction. Examples of documents in which the system simulation is stated are the following patent documents:

Patent Document 1: JP-A-2002-279333

Patent Document 2: JP-A-2000-035898

Patent Document 3: JP-A-07-084832

### SUMMARY OF THE INVENTION

An object of the present invention is to decrease the number of man-hour of the hardware design of a bus system or the like by employing a program language, such as “Java”®, which is capable of describing parallel operations.

An object of the invention is to provide a novel design technique for a bus system satisfying a real-time restriction as employs a program language capable of describing parallel operations, and parametric model checking.

Another object of the invention is to provide a new design technique which is based on the merge of a model checking technique and a hardware synthesis technique.

Still another object of the invention is to realize modeling which is based on a program language capable of describing parallel operations for a bus system having a real-time restriction, and verification and also hardware synthesis which are based on parametric model checking.

The above and other objects and novel features of the invention will become apparent from the description of this specification when read in conjunction with the accompanying drawings.

Typical aspects of performance of the invention will be briefly outlined below.

Program descriptions which define a plurality of devices by employing a program language capable of describing parallel operations are input, the input program descriptions are converted into an intermediate expression, parameters which satisfy a real-time restriction are generated for the intermediate expression, and circuit descriptions which are based on a hardware description language are synthesized on the basis of the generated parameters.

In this way, a bus system or the like is modeled in the program language, such as “Java”®, which is capable of describing the parallel operations, whereby the system which meets the real-time restriction can be designed. Thus, it is permitted to decrease the number of man-hour of the hardware design.

In one aspect of the invention, the intermediate expression is a concurrent control flow flag, a temporal automaton with a concurrent parameter, or a temporal automaton with parameters.

In one aspect of the invention, parametric model checking is performed for the parameter generation. Thus, it is possible to provide a new design technique which is based on the merge of a model checking technique and a hardware synthesis technique.

In one aspect of the invention, the real-time restriction is given by RPCTL (Real-time Parametric Computation Tree Logic).

In one aspect of the invention, the program descriptions define the devices by using a “run” method and define clock synchronizations of the devices by using barrier synchronizations.

### BRIEF DESCRIPTION OF THE DRAWINGS

FIG. 1 is a flow chart exemplifying the whole design method according to the present invention;

FIG. 2 is an explanatory diagram exemplifying the design pattern of the modeling of a single bus system as based on the Java language;

FIG. 3 is an explanatory diagram showing an example in which a clock synchronization method based on barrier synchronization is employed as a clock synchronization mechanism in the modeling;

FIG. 4 is an explanatory diagram exemplifying the descriptions of modeling as realize the writing of a value into a register;

FIG. 5 is an explanatory diagram exemplifying methods which manage bus ownership acquisitions;

FIG. 6 is a call graph which expresses the calling relations of the methods in FIG. 5;

FIG. 7 is an explanatory diagram exemplifying the Java language descriptions of a bus ownership acquisition mechanism;

FIG. 8 is an explanatory diagram of the Java language descriptions showing a continuation to FIG. 7;

FIG. 9 is an explanatory diagram of methods for managing bus ownership releases;

FIG. 10 is a call graph which expresses the calling relations of the methods in FIG. 9;

FIG. 11 is an explanatory diagram exemplifying the Java language descriptions of a bus ownership release mechanism;

FIG. 12 is an explanatory diagram of the Java language codes of a “sync_read” method;

FIG. 13 is an explanatory diagram exemplifying “sync_read” method descriptions in a “run( ) ” method;

FIG. 14 is an explanatory diagram showing the Java language codes of a “sync_burst_read” method;

FIG. 15 is an explanatory diagram showing the Java language codes of an “endBurstAccess” method;

FIG. 16 is an explanatory diagram showing the Java language codes of a “freeBurstBusLock” method;

FIG. 17 is an explanatory diagram exemplifying the descriptions of burst read in the “run( )” method;

FIG. 18 is an explanatory diagram showing the Java language codes of a “sync_write” method;

FIG. 19 is an explanatory diagram exemplifying “sync_write” method descriptions in the “run( )” method;

FIG. 20 is an explanatory diagram showing the Java language codes of a “sync_burst_write” method;

FIG. 21 is an explanatory diagram exemplifying the descriptions of burst write in the “run( )” method;

FIG. 22 is an explanatory diagram showing the schematic specifications of an installation example based on Java language descriptions;

FIG. 23 is an explanatory diagram showing part of an installation example of a “run( )” method which concerns a command interface;

FIG. 24 is an explanatory diagram showing a continuation to the installation example in FIG. 23;

FIG. 25 is an explanatory diagram showing a continuation to the installation example in FIG. 24;

FIG. 26 is an explanatory diagram showing a continuation to the installation example in FIG. 25;

FIG. 27 is an explanatory diagram showing an installation example of the “run( )” method which concerns a unified memory;

FIG. 28 is an explanatory diagram showing an installation example of the “run( )” method which concerns a graphics rendering unit;

FIG. 29 is an explanatory diagram showing a continuation to the installation example in FIG. 28;

FIG. 30 is an explanatory diagram showing a continuation to the installation example in FIG. 29;

FIG. 31 is an explanatory diagram showing a continuation to the installation example in FIG. 30;

FIG. 32 is an explanatory diagram showing a continuation to the installation example in FIG. 31;

FIG. 33 is an explanatory diagram showing an installation example of the “run( )” method which concerns a display unit;

FIG. 34 is an explanatory diagram showing a continuation to the installation example in FIG. 33;

FIG. 35 is an explanatory diagram exemplifying the details of a process for conversion into an intermediate expression entirely;

FIG. 36 is an explanatory diagram exemplifying the form of a C-CFG;

FIG. 37 is an explanatory diagram showing the handling of a “synchronized” operation (for hardware synthesis);

FIG. 38 is an explanatory diagram showing the handling of a “synchronized” operation (for parametric model checking);

FIG. 39 is an explanatory diagram showing a CFG in the case of the command interface;

FIG. 40 is an explanatory diagram exemplifying a CFG for the hardware synthesis as to the command interface;

FIG. 41 is an explanatory diagram exemplifying a CFG for the parametric model checking;

FIG. 42 is an explanatory diagram exemplifying a CFG relevant to the graphics rendering unit;

FIG. 43 is an explanatory diagram showing a continuation to the CFG in FIG. 42;

FIG. 44 is an explanatory diagram exemplifying a CFG for the parametric model checking;

FIG. 45 is an explanatory diagram showing a continuation to the CFG in FIG. 44;

FIG. 46 is an explanatory diagram exemplifying a CFG relevant to the display unit;

FIG. 47 is an explanatory diagram exemplifying a CFG for the parametric model checking;

FIG. 48 is an explanatory diagram exemplifying the linked state of respective start nodes in the CFG of the command interface, the CFG of the graphics rendering unit and the CFG of the display unit;

FIG. 49 is an explanatory diagram exemplifying a fixed priority scheduler;

FIG. 50 is a first explanatory diagram for showing the situation of abstraction for each CFG of the command interface in due course;

FIG. 51 is an explanatory diagram showing a continuation to FIG. 50;

FIG. 52 is an explanatory diagram showing a continuation to FIG. 51;

FIG. 53 is an explanatory diagram showing a continuation to FIG. 52;

FIG. 54 is an explanatory diagram showing a continuation to FIG. 53;

FIG. 55 is an explanatory diagram showing a continuation to FIG. 54;

FIG. 56 is an explanatory diagram showing a continuation to FIG. 55;

FIG. 57 is an explanatory diagram exemplifying the result of an abstraction process for each CFG of the graphics rendering unit;

FIG. 58 is an explanatory diagram exemplifying the result of an abstraction process for each CFG of the display unit;

FIG. 59 is an explanatory diagram for showing the situation of the conversion of the CFG of the command interface into a TNFA in due course;

FIG. 60 is an explanatory diagram showing a continuation to FIG. 59;

FIG. 61 is an explanatory diagram showing a continuation to FIG. 60;

FIG. 62 is an explanatory diagram for showing the situation of the conversion of the CFG of the graphics rendering unit into a TNFA in due course;

FIG. 63 is an explanatory diagram showing a continuation to FIG. 62;

FIG. 64 is an explanatory diagram showing a continuation to FIG. 63;

FIG. 65 is an explanatory diagram showing a continuation to FIG. 64;

FIG. 66 is an explanatory diagram for exemplifying the situation of the conversion of the CFG of the display unit into a TNFA in due course;

FIG. 67 is an explanatory diagram showing a continuation to FIG. 66;

FIG. 68 is an explanatory diagram showing a continuation to FIG. 67;

FIG. 69 is an explanatory diagram showing a constructional example of the product TNFA of the TNFAs which have been obtained in FIGS. 61, 64 and 68;

FIG. 70 is an explanatory diagram for showing a deletion course for transition branches which do not satisfy restrictions at the stage of constructing the product TNFA, when an upper-limit value has been afforded to parameters;

FIG. 71 is an explanatory diagram showing a continuation to FIG. 70;

FIG. 72 is an explanatory diagram showing a continuation to FIG. 71;

FIG. 73 is an explanatory diagram showing a continuation to FIG. 72;

FIG. 74 is an explanatory diagram showing a continuation to FIG. 73;

FIG. 75 is an explanatory diagram showing a continuation to FIG. 74;

FIG. 76 is an explanatory diagram showing a continuation to FIG. 75;

FIG. 77 is an explanatory diagram showing part of the course of a process in the case where the “abstraction of TNFA” has been opportunely called at a C-TNFA2TNFA;

FIG. 78 is an explanatory diagram showing a continuation to FIG. 77;

FIG. 79 is an explanatory diagram showing a continuation to FIG. 78;

FIG. 80 is an explanatory diagram exemplifying a result which has been obtained by solving the linear programming problem of minimizing the total of individual parameter values as is an objective function, as to an obtained parameter condition;

FIG. 81 is an explanatory diagram exemplifying a solution which has been obtained by adding the restrictions of kb1=2, kb2=1 and kb3=1 to the result in FIG. 80;

FIG. 82 is an explanatory diagram exemplifying a solution which has been obtained by further adding to the result in FIG. 81, the restriction that parameter variables except “krl” are at least “1”;

FIG. 83 is an explanatory diagram exemplifying the allotment of execution cycles to a “BasicBlock”;

FIG. 84 is an explanatory diagram exemplifying the fixed priority scheduler;

FIG.85 is an explanatory diagram exemplifying a CFG after having been transformed by employing part of the fixed priority scheduler shown in FIG. 84;

FIG. 86 is an explanatory diagram exemplifying part of the CFG of the command interface after the transformation;

FIG. 87 is an explanatory diagram showing a continuation to FIG. 86;

FIG. 88 is an explanatory diagram exemplifying a CFG which concerns the allotment of CFGs to isolated nodes;

FIG. 89 is an explanatory diagram exemplifying descriptions which are to be in-line-expanded for CFG generation concerning a shared register;

FIG. 90 is an explanatory diagram exemplifying pseudo C descriptions which concern the shared register; and

FIG. 91 is an explanatory diagram showing a continuation to FIG. 90.

### DETAILED DESCRIPTION OF THE PREFERRED EMBODIMENTS

As an example of the present invention, there will be described the modeling of a bus system having a real temporal restriction as based on “Java”®, and verification and hardware synthesis based on parametric model checking. In this specification, “Java”® shall also be written simply as the “Java language”.

<<Entirety of Design Method>>

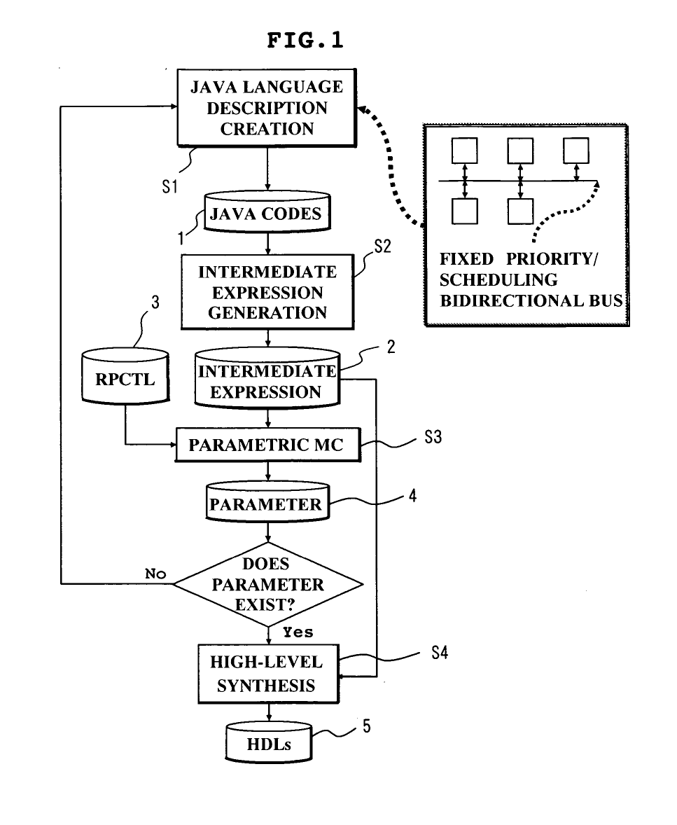

The entirety of a design method is shown in FIG. 1. The model of a system to-be-designed is designed by descriptions based on the Java language (Java language descriptions) (S1). In the design of the system model (also termed “modeling”) based on the Java language descriptions, each device on a single bus is described using the “run( ) method” of the Java language. In the “run( ) method”, program codes which are to be executed in a thread constituting a multi-thread is described within the parentheses ( ). A clock is expressed using barrier synchronization. In general, the “barrier synchronization” can be grasped as a synchronization technique for waiting for all data which ought to be processed at the same time, in case of receiving the data from a plurality of modules.

Subsequently, the Java language descriptions (Java codes) 1 generated at the step S1 are loaded, and are converted into an intermediate expression (S2). Here, the intermediate expression 2 is a concurrent control flow graph (hereinbelow, termed “C-CFG”), a time automaton having a concurrent parameter (hereinbelow, termed “C-TNFA”) or a time automaton having a parameter (hereinbelow, termed “TNFA”). In general, the “CFG (control flow graph)” signifies a graph which indicates the flow of a control within a function. The “TNFA (automaton)” can be grasped as the logical model of a circuit which receives finite sorts of inputs at discrete times, which divides the series of the inputs received from the past till the present, into classes in, at most, a number determined by the circuit, and then stores the classified input series, and which delivers finite sorts of outputs on the basis of the stored input series.

The TNFA obtained as the intermediate expression 2, and a real temporal restriction described by RPCTL (Real-time Parametric Computation Tree Logic) 3 are read so as to execute parametric model checking (S3), and to derive a parameter condition 4 which satisfies the input RPCT, etc.

If the satisfactory parameter condition does not exist, a scheme alteration is made to revise the Java language descriptions. On the other hand, if the satisfactory parameter condition exists, the C-CFG is read with the parameter condition as a cycle restriction, and it is converted into circuit descriptions 5 based on an HDL (Hardware Description language), by high-level synthesis (S4). The circuit descriptions 5 are of, for example, RTL (Register Transfer Level).

The development method is carried out in such a way that a program for incarnating the method is run by a computer apparatus. The development support program for obtaining the HDL from the Java language descriptions can be regarded as the design support program of a digital circuit.

Owing to this design technique, the modeling and verification of a single bus system in an upper stream process become possible, and the design automation of hardware satisfying the real temporal restriction becomes possible. The reason why the verification in the upper stream process is possible, is that the system to-be-designed is modeled by the Java language descriptions, so the descriptions themselves are executable.

<<Restrictions to Modeling Based on Java Language>>

There will be elucidated restrictions to Java language descriptions and a bus system in the case of modeling based on the Java language. For the purpose of the modeling of the single bus system as based on the Java language, the following restrictions are imposed on the Java language descriptions: 1) Inhibition of dynamic instantiation 2) Inhibition of “start( ) method” call from “run( ) method” The restriction 1) pertains to the process alteration of an LSI, and is considered an allowable restriction because hardware is handled here. Also, the restriction 2) is considered an allowable restriction for the reason that, insofar as the verification of a bus protocol is intended, only parts pertaining directly to bus operations may be modeled.

Besides, in view of the restrictions of a parametric model checking tool, the following restrictions are imposed on a model: 3) Single bi-directional bus system 4) Bus ownership control Being of fixed priority 5) Each device on bus Ending process every predetermined cycle The relaxations of the above restrictions can be thought as new problems.

<<Design Pattern for Modeling Based on Java Language>>

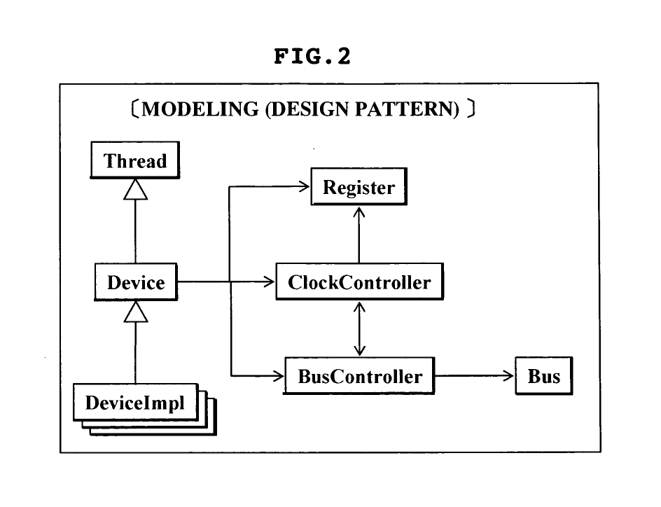

Exemplified in FIG. 2 is a design pattern for the modeling of a single bus system as based on the Java language. The modeling of the single bus system as based on the Java language is described along the design pattern in FIG. 2 as is given in a UML (Unified Modeling Language). Each device operation on a bus is installed in a “run( ) method” within “DeviceImpl Class”, a register within a device as is accessed through the bus is installed as an attribute within “Register Class”, and a synchronous communication method through the bus is installed as the method of the “Register Class”. Besides, there are installed “Bus Class” corresponding to the bus, “BusController Class” for performing the lock management of the bus, and “Clock Controller Class” for managing clock synchronization. The “lock management of the bus” signifies the control of bus arbitration. In the illustration of FIG. 2, a triangular symbol Δ to which a line is affixed signifies inheritance. The “DeviceImpl Class”, for example, is the child class of “Device Class” and can use the method of the “Device Class”. Symbol signifies “use”, and the “Device Class”, for example, uses the method of the “Clock Controller Class”.

By the way, in order to heighten the reusability of Java language codes, the design pattern is defined so that the alterations of the Java language codes may be possible, in accordance with the following policies: 1) Addition/Deletion of Device (Addition/Deletion of DeviceImpl Class) 2) Alteration of Device operation (Alteration of “run( ) method” of DeviceImpl Class) 3) Addition/Deletion of Shared variable (Addition/Deletion of Attribute of “Register Class”) 4) Addition/Deletion of Bus protocol (Addition/Deletion of Synchronous communication method of “Register Class”)

The individual classes in the design pattern in FIG. 2 will be explained.

(1) Device Class

This is an abstract class in which elements common to devices are collected. Even in a case where a plurality of registers or buses exist, the processing contents thereof are not different in themselves, and hence, the existence of the plurality of registers or buses can be expressed by generating a plurality of identical class objects. The processing contents of the devices, however, are different every device. Therefore, the “Device class” is installed as the class in which the elements that are common to the devices are collected, and that include member variables for inheriting “Thread class” in order to perform parallel operations, and for registering member variables expressive of the instance of the “Clock controller Class”, the instance of the “Register Class” and the instance of the “Bus Class”, and the information of a shared register accessible by the individual devices, and a method for registering the information of the shared register accessible by the individual devices.

(2) DeviceImpl Class

This is a class which corresponds to the actual device. Since the processing contents of the devices are different every device, the “Device class” in which elements necessary for the pertinent device are collected is inherited, and the processing contents of the pertinent device are described. That is, the installation classes of the “Device class” are existent for respective processes such as “DeviceImplA class” for performing a process A, and “DeviceImplB class” for performing a process B.

(3) Register Class

This is a class which corresponds to the shared register. The class consists of a member variable expressive of the value of the register, and methods for reading/writing the value.

(4) Bus Class

This is a class which corresponds to the bus. The class consists of a member variable expressive of a status as to whether or not the bus is occupied, a member variable expressive of the shared register connected to the bus, and a method for altering the status.

(5) BusController Class

This is a class which locks or unlocks the bus at the access to the shared register through the bus. This class is requested to lock/unlock the bus. In particular, the class includes a method which sets a flag variable to “1” when one device accesses the bus. The flag variable is included as a bus access flag in the form of a member variable, and a plurality of times of bus lock operations within an identical clock are avoided by the member variable.

(6) ClockController Class

This is a clock management class. For the purpose of causing the individual devices on the bus system to perform a clock synchronization operation, the notifications of the ends of processes for one clock are collected. When the ends of the processes of all the devices have been confirmed, a user is notified that processes in the next clock may be performed, and simultaneously, the bus access flag of the “BusController Class” is reset to “0”.

<<Clock Synchronization Mechanism in Modeling>>

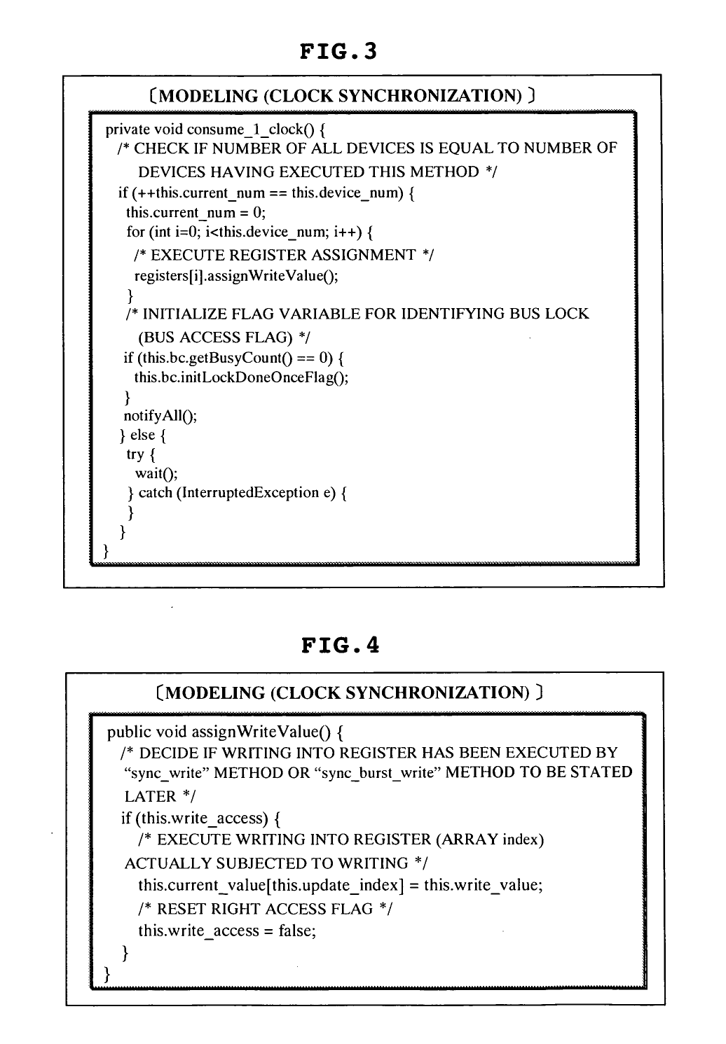

A clock synchronization mechanism will be explained. Clocks are realized by employing a clock synchronization method based on barrier synchronization as shown in FIG. 3. Concretely, the notifications of the ends of processes for one clock are collected, and when the ends of the processes of all devices have been confirmed, the user is notified that processes in the next clock may be executed.

Besides, in a case where the lock of a bus does not remain, the bus access flag of “Bus Class” is reset to “0”. Incidentally, clock transitions are parameterized in being input to parametric model checking, and hence, they are not always in single-clock units.

Modeling which is higher in the degree of abstraction than modeling at a cycle accuracy is realized by the parameterization of the clock transitions.

Since the writing of a value into a register requires one clock, it needs to be realized. It is realized by calling the “assignwriteValue” method of “Register Class” as exemplified in FIG. 4, within a “consume_{—}1_clock” method.

<<Bus Ownership Acquisition Mechanism in Modeling>>

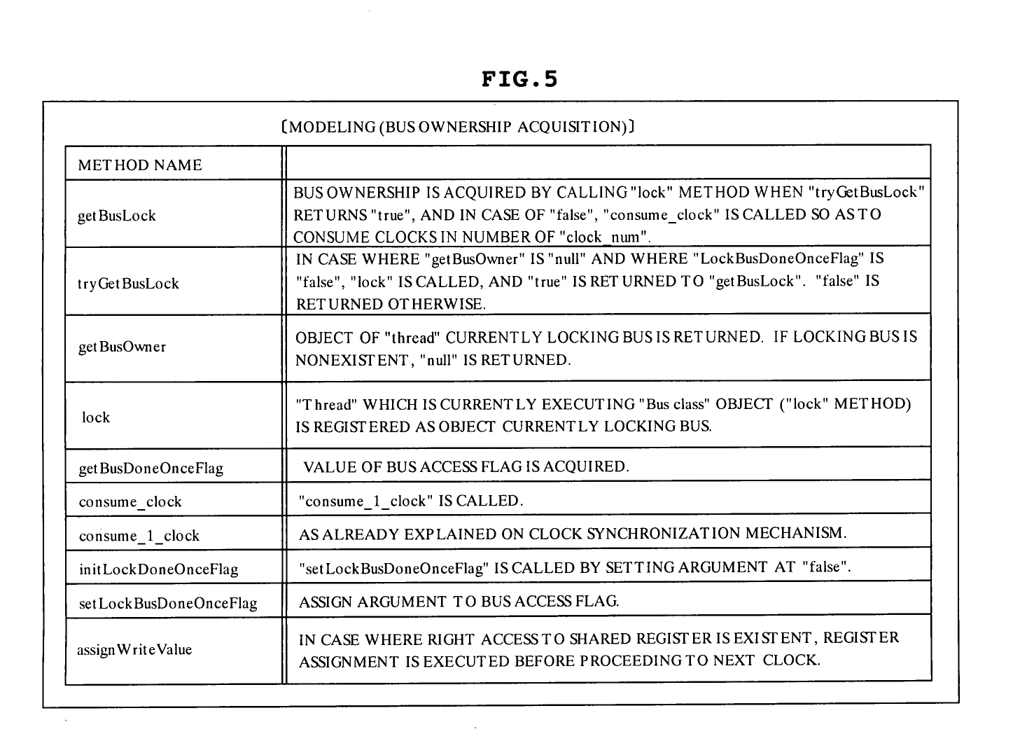

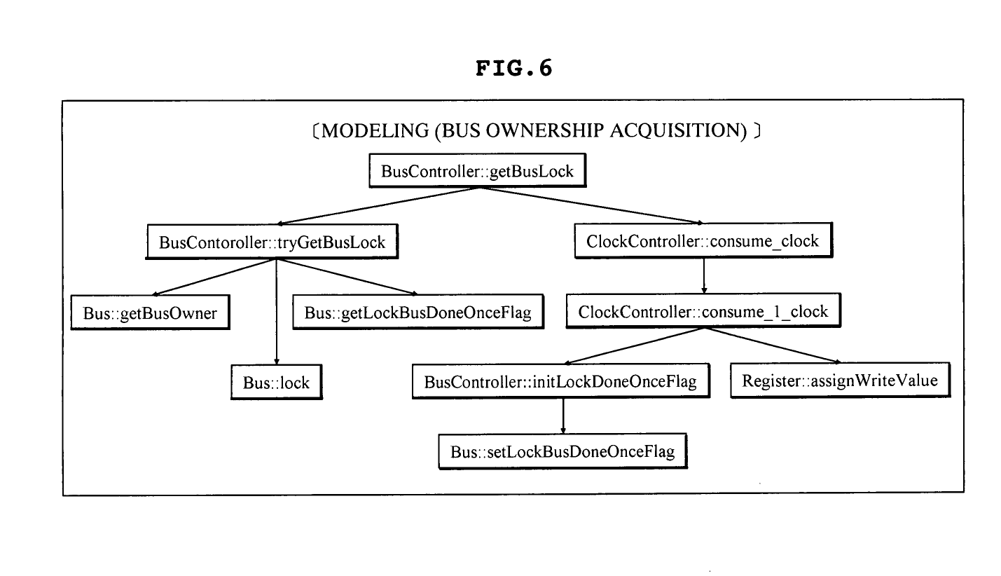

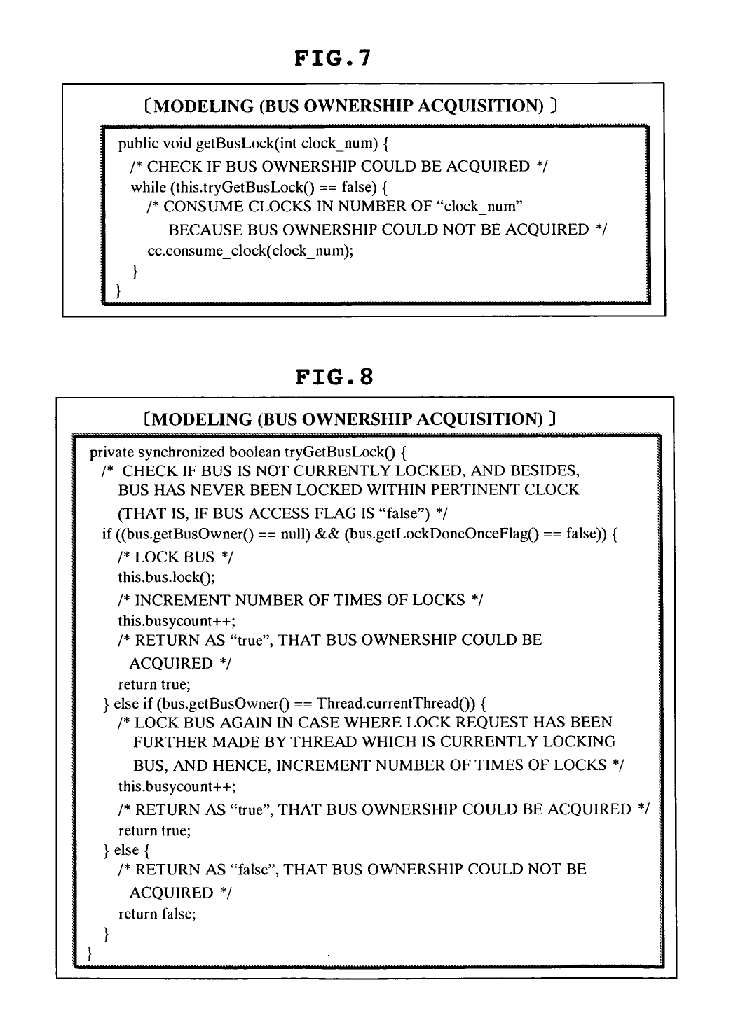

A bus ownership acquisition mechanism will be first explained as the synchronization mechanism of a bus ownership management. The bus ownership acquisition mechanism manages bus ownership acquisitions by methods shown in FIG. 5. A request for a bus ownership is made by a “getBusLock” method. A call graph which expresses the calling relations of the methods in FIG. 5, is shown in FIG. 6. The Java language descriptions of the bus ownership acquisition mechanism are exemplified in FIGS. 7 and 8.

<<Bus Ownership Release Mechanism in Modeling>>

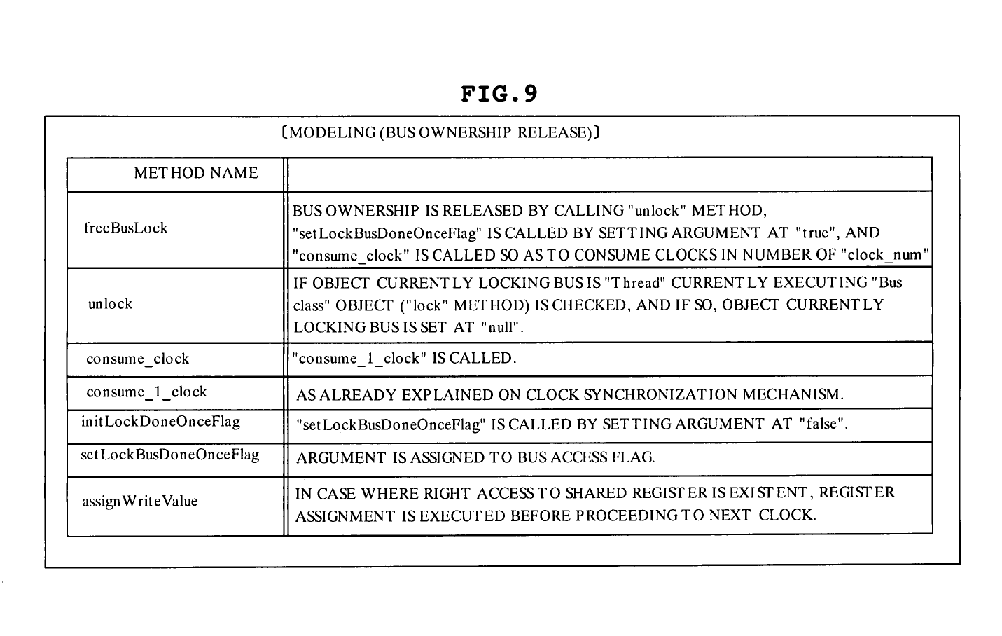

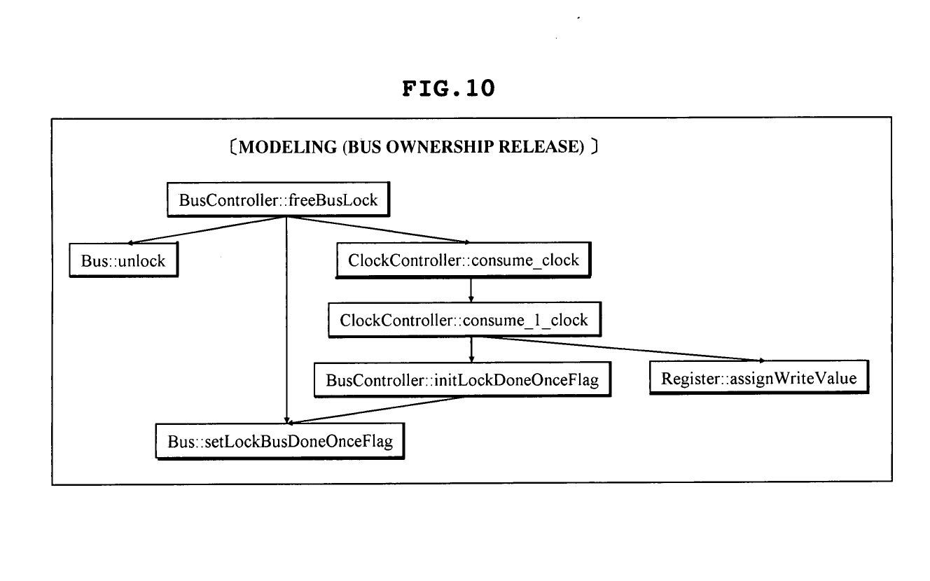

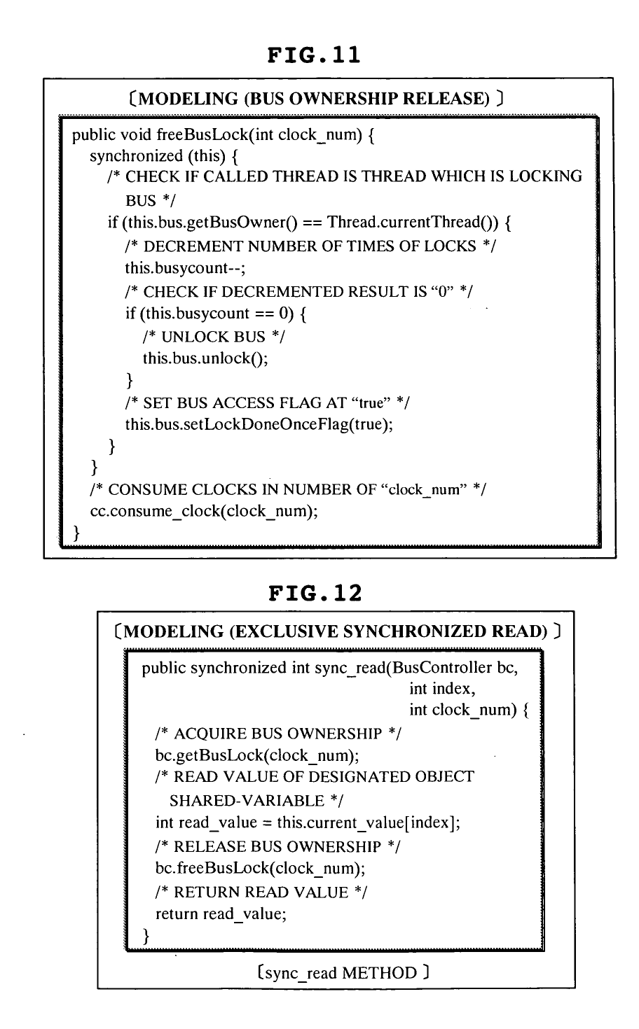

Next, a bus ownership release mechanism will be explained. The bus ownership release mechanism manages bus ownership releases by methods shown in FIG. 9. A bus ownership is released by a “freeBusLock” method. A call graph which expresses the calling relations of the methods in FIG. 9, is shown in FIG. 10. The Java language descriptions of the bus ownership release mechanism are exemplified in FIG. 11.

<<Exclusive Synchronized Read Method in Modeling>>

An exclusive synchronized read method will be explained as an exclusive synchronized access scheme for a bus. The exclusive synchronized read method includes single read and burst read as stated below. The single read is realized by calling a “sync_read” method in the “run( )” method. The burst read is realized using “sync_burst_read”, “endBurstAccess” and “consume_clock” methods within the “synchronized” block of the “run( )” method.

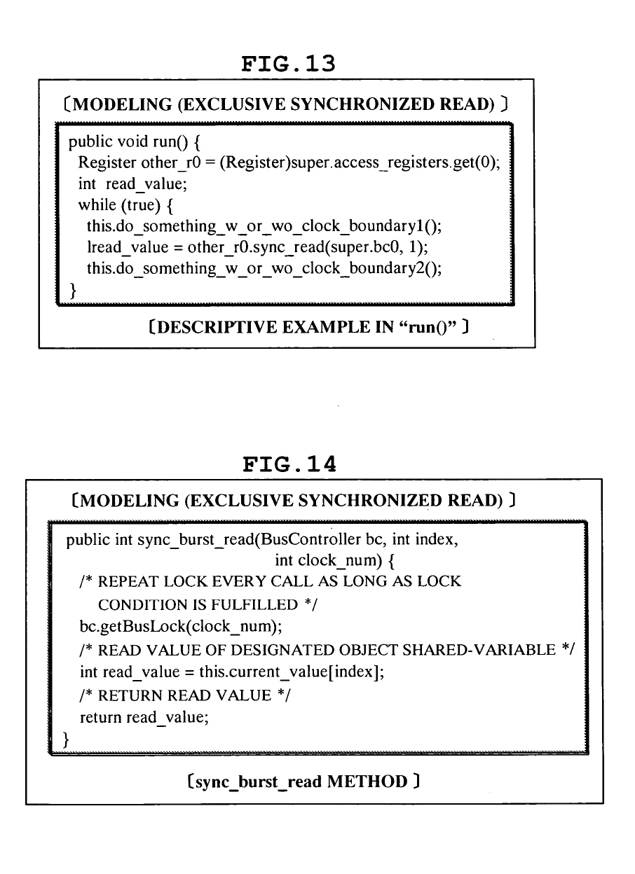

The Java language codes of the “sync_read” method are exemplified in FIG. 12, while the descriptions of the “sync_read” method in the “run( )” method are exemplified in FIG. 13. An undefined method which appears in the descriptive example in the “run( )” method, that is, “do_something_w_or_wo_clock_boundary( )” signifies any process which may include a clock boundary, whereas an undefined method “do_something_wo_clock_boundary( )” signifies any process which does not include the clock boundary.

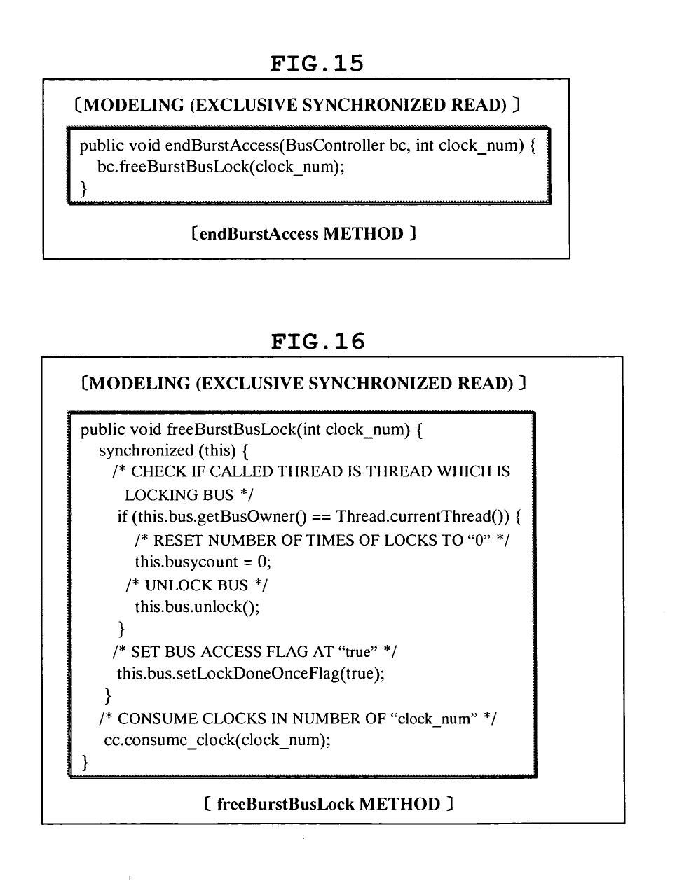

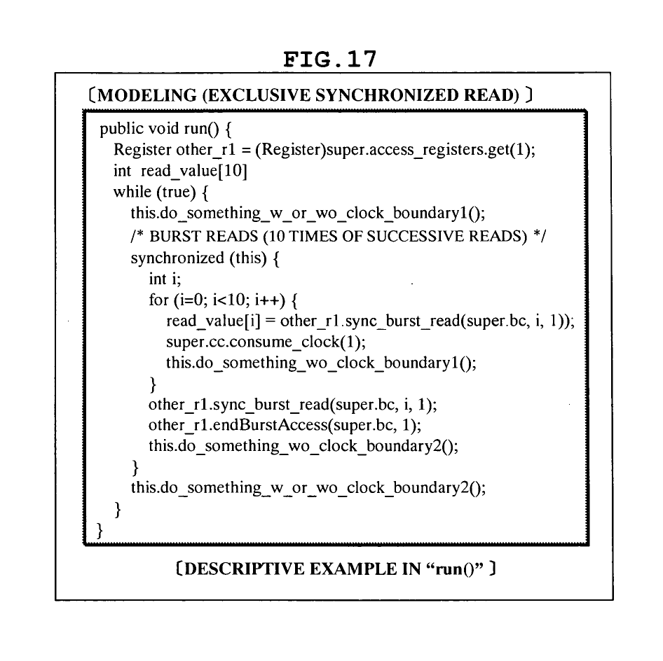

The Java language codes of the “sync_burst_read” method are exemplified in FIG. 14, the Java language codes of the “endBurstAccess” method in FIG. 15, the Java language codes of a “freeBurstBusLock” method in FIG. 16, and the descriptions of the burst read in the “run( )” method in FIG. 17. In the burst read, the lock of the bus is repeated every call, and values are returned without freeing the bus. Besides, when the number of times of burst reads have ended, the repeated locks are freed at one time. Owing to such an installation method, a burst operation in which the read value is returned every cycle is realized.

<<Exclusive Synchronized Write Method in Modeling>>

An exclusive synchronized write method will be explained as an exclusive synchronized access scheme for a bus. The exclusive synchronized write method includes single write and burst write as stated below. The single write is realized by calling a “sync_write” method in the “run( )” method. The burst write is realized using “sync_burst_write”, “endBurstAccess” and “consume_clock” methods within the “synchronized” block of the “run( )” method.

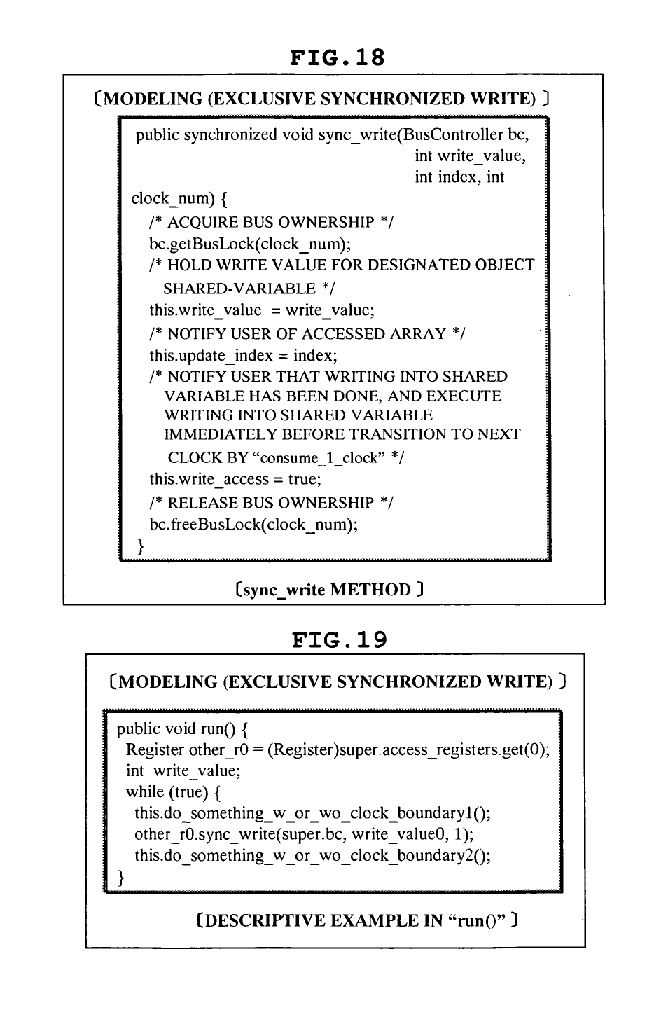

The Java language codes of the “sync_write” method are shown in FIG. 18, while a descriptive example of the “sync_write” method in the “run( )” method is shown in FIG. 19.

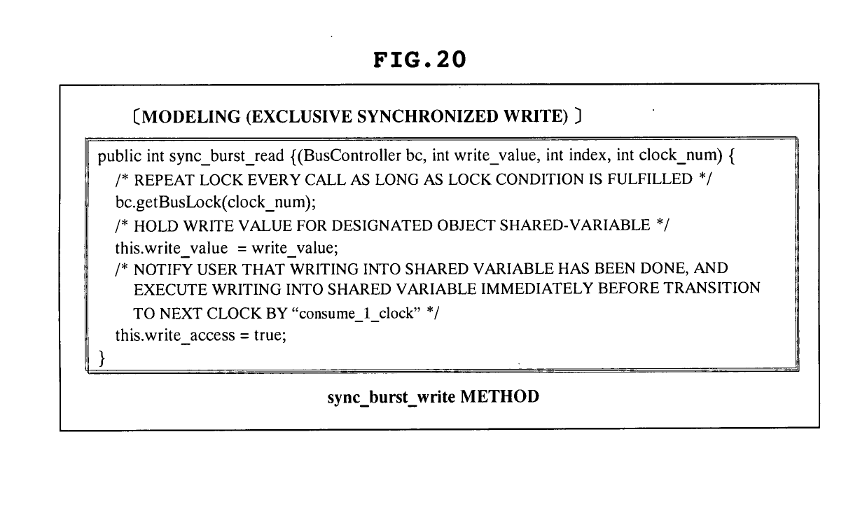

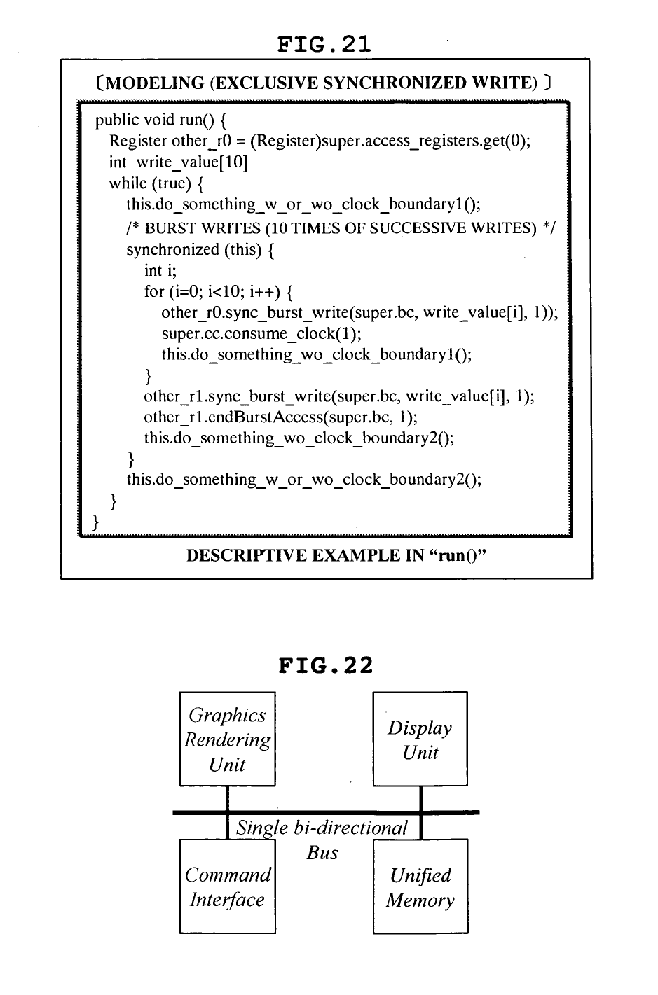

The Java language codes of the “sync_burst_write” method are shown in FIG. 20, while a descriptive example of the burst write in the “run( )” method is shown in FIG. 21. In the burst write, the lock of the bus is repeated every call, and a write process is ended without freeing the bus after the process. Besides, when the number of times of burst writes have ended, the repeated locks are freed at one time. Owing to such an installation method, a burst operation in which a write value can be written every cycle is realized.

<<Installation Example Based on Java Language Descriptions>>

An installation example based on Java language descriptions will be explained. The schematic specifications of the installation example are shown in FIG. 22. Here, a two-dimensional graphics rendering/display system of shared memory scheme shall be exemplified. The system shown in the figure includes a command interface, a unified memory, a graphics rendering unit and a display unit, which are shared by a single bi-directional bus.

(1) The command interface accepts a rendering command from outside, and transfers the accepted rendering command to the memory through the bus.

(2) The unified memory is a memory in which rendering commands, rendering source data and display data are stored unitarily. It is greatly effective for lowering the cost of the system and decreasing the number of components of the system. In order to simplify a model, it is expressed by arrays in the Java. This memory is a slave device.

(3) The graphics rendering unit checks if any rendering command exists in the unified memory, by polling. In the existence of such rendering commands, the graphics rendering unit performs rendering processes while reading the rendering commands and rendering data through the bus, it stores rendering results in an internal buffer, and it burst-transfers the rendering results to the unified memory at one time. In order to simplify the model, rendering command and rendering data transfers are realized by successive accesses to the arrays.

(4) The display unit displays display data line by line while reading the display data. In order to simplify the model, vertical synchronization is not modeled. Besides, the bus shall not be accessed during a horizontal retrace time.

The command interface, graphics rendering unit and display unit are bus master devices, and the unified memory is the bus slave device as stated above. The priority levels of bus ownership acquisitions in the case where the bus master devices have acquired bus ownership at the same time, shall be the “display unit>command interface>graphics rendering unit”.

Next, there will be explained installation examples of “run( )” methods for the specifications in FIG. 22.

(1) Command Interface

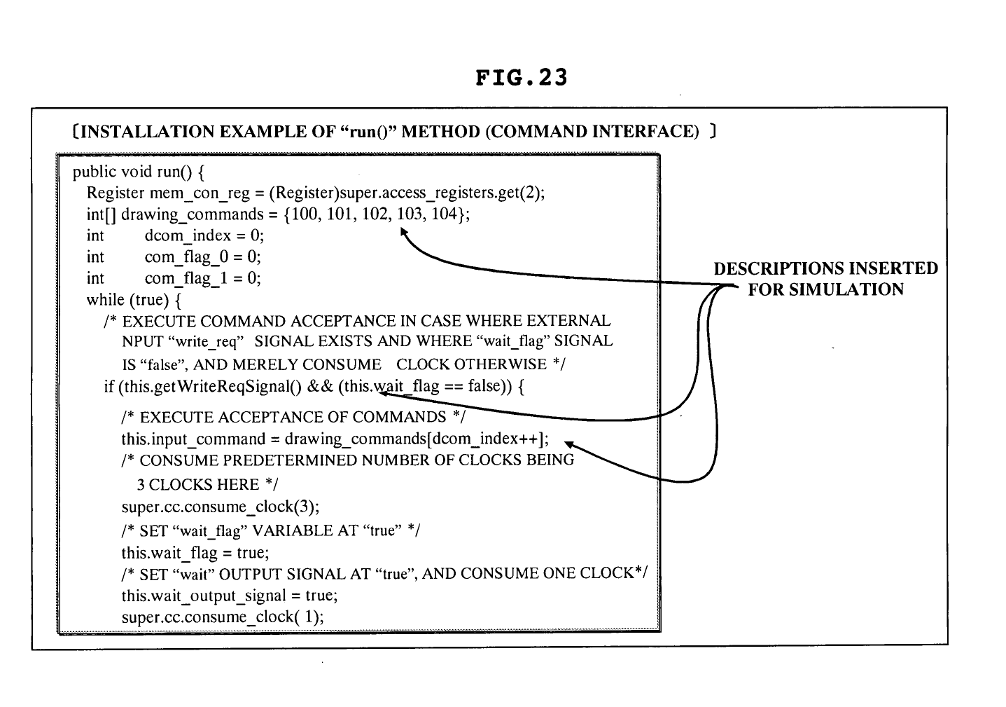

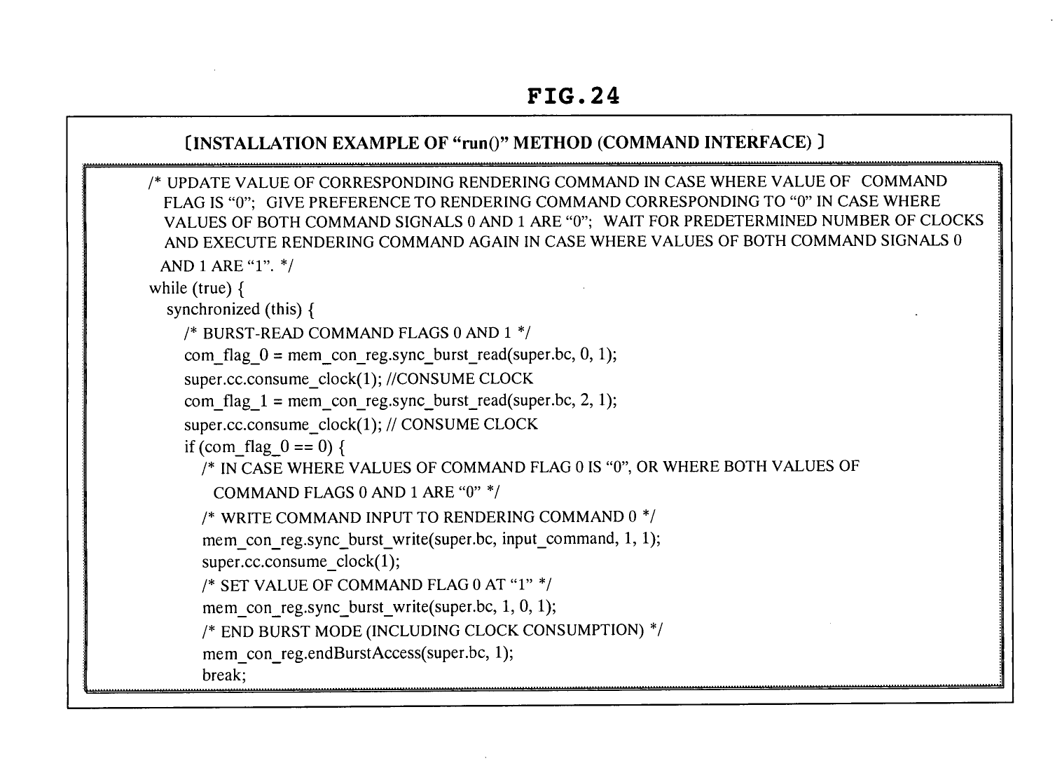

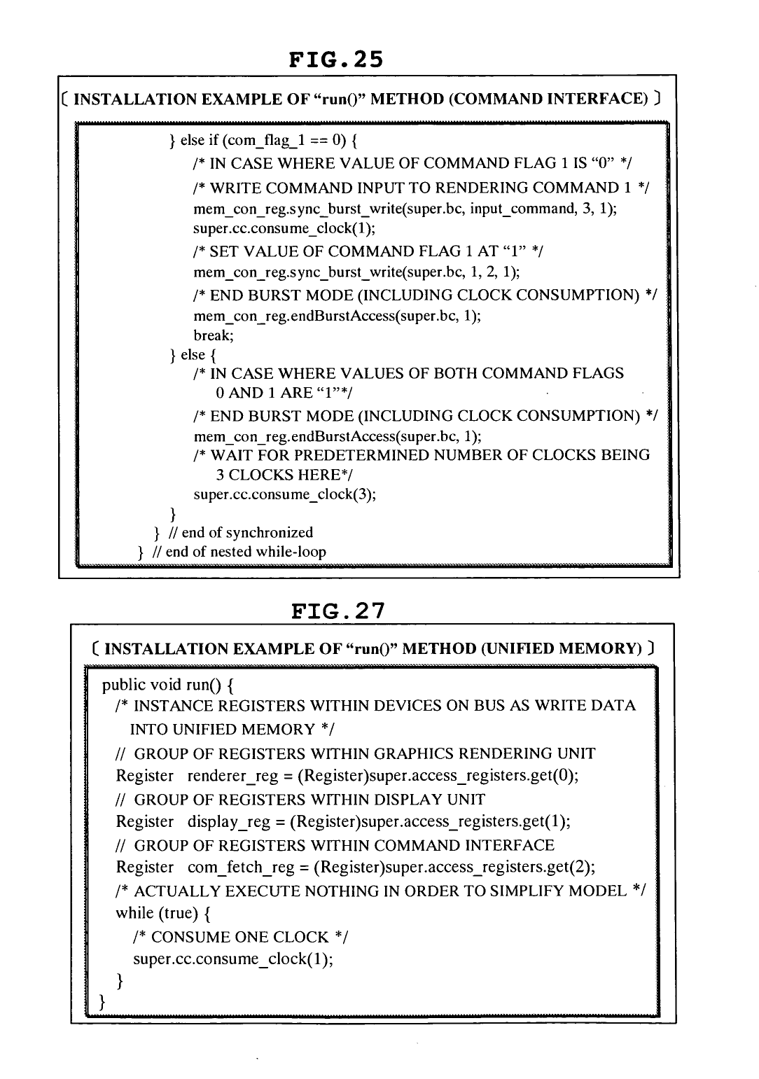

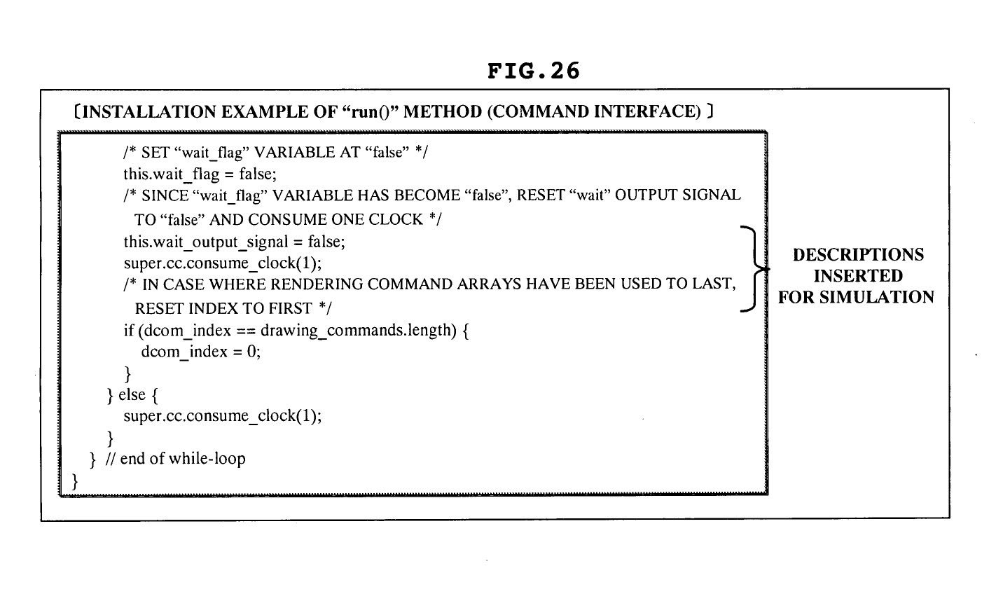

First, the installation example of the “run( )” method concerning the command interface will be explained. This installation example is shown in FIGS. 23 through 26. In a case where an external input “write_req” signal (concretely, a write signal from a CPU) exists, and where an internal variable “wait_flag” for use in determining the value of a “wait” output signal is “false”, the command interface executes command acceptances (by consuming a predetermined number of cycles), whereupon it first sets the “wait_flag” variable at “true”. Subsequently, it attempts to acquire bus ownership. When the command interface has acquired the bus ownership, it reads the command flags 0 and 1 of the unified memory by the “sync_burst_read” method, and it executes the “sync_burst_write” method for memory area corresponding to the command flag of the value “0” (for which the rendering command process has been performed), in the status in which the bus ownership has been kept acquired. Thereafter, the command interface transfers the command flags, rendering commands and rendering source data, and it sets the “wait_flag” variable at “false”. In order to simplify the model, however, even when both the command flags are “0”, only the write operation into the memory area corresponding to the command flag 0 as based on the “sync_burst_write” method shall be executed, and the transfer of the rendering source data is omitted.

The command interface sets a “wait” signal at “true” only in the case where the “write_flag” variable is “true” and where the “write_req” input signal is “true”, and it sets the “wait” signal at “false” otherwise. Especially, the command interface sets the “wait_flag” variable at “false” during the execution of the command acceptance. Incidentally, the initial values of both the “wait” signal and the “wait flag” variable are set at “false”.

Besides, the command which the command interface accepts consists of the storage start/end addresses of the command flag, the rendering command, the rendering source data and texture data, and the storage start/end addresses of the texture data shall be included in the rendering command.

(2) Unified Memory

The installation example of the “run( )” method concerning the unified memory will be explained. This installation example is exemplified in FIG. 27. The unified memory is a memory in which graphics rendering commands, rendering source data, and display data after rendering operations are stored unitarily. In order to simplify the model, the memory is realized as a thread which executes nothing. The entity of this memory is allocated as the instance of the “Register Class” within the “run( )” method.

By the way, in order to simplify the model, memory arrays are structured as follows: mem_con_reg.current_value[0]: command flag 0, mem_con_reg.current_value[1]: rendering command 0, mem_con_reg.current_value[2]: command flag 1, mem_con_reg.current_value[3]: rendering command 1, mem_con_reg.current_value[4]: rendering source data, and displaying data after rendering.

In actuality, a memory space which is formed by the array storing therein the rendering source data and the display data after rendering is divided in two (one of them is set as “Buffer0”, and the other as “Buffer1”), and the memory array is alternately changed-over every frame display so as to become: (Buffer0, Buffer1)=(rendering source data, displaying data after rendering) (Buffer0, Buffer1)=(displaying data after rendering, rendering source data) Accordingly, the rendering source data shall not be overwritten by the displaying data after rendering. Further, in order to simplify the model, the transfer of the rendering source data is omitted.

Besides, in order to simplify the model, texture data are omitted. Only, at most, two rendering commands shall be stored, and the sequence of the executions of the commands 0 and 1 shall not exert influence on rendering results.

(3) Graphics Rendering Unit

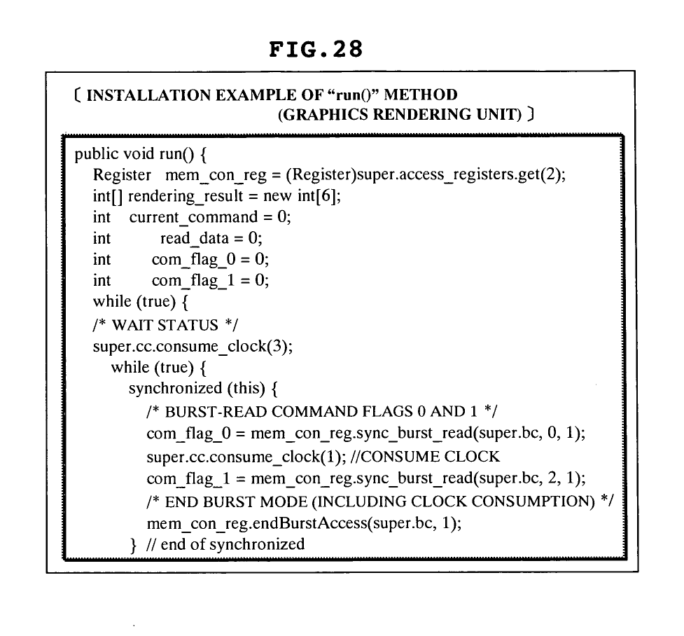

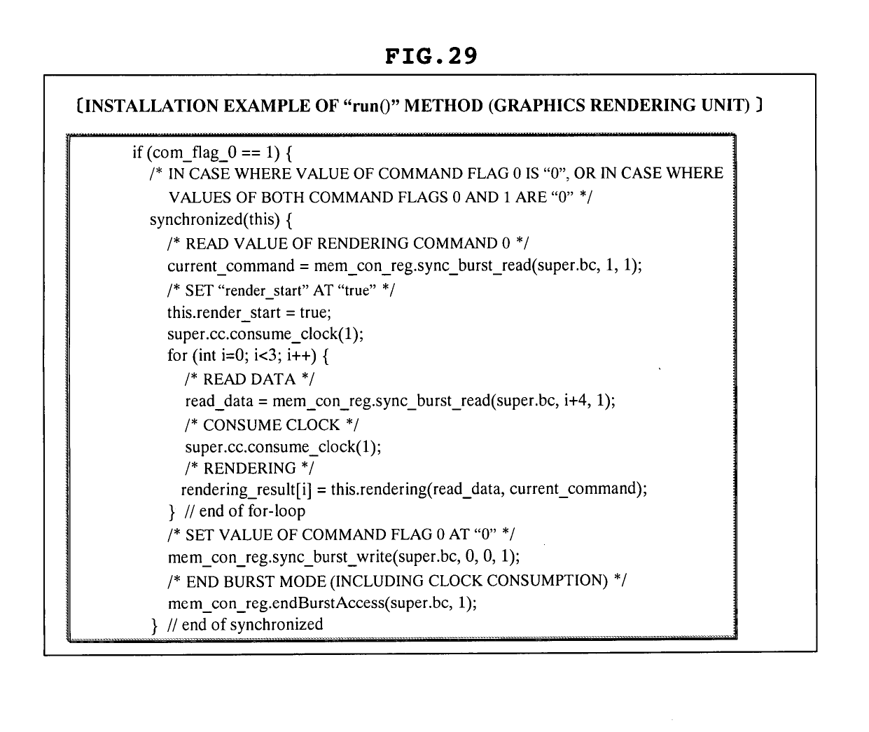

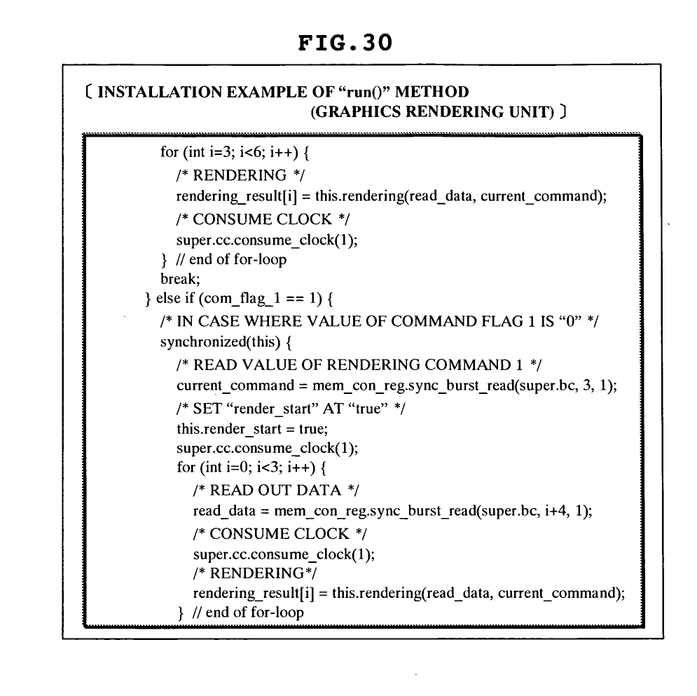

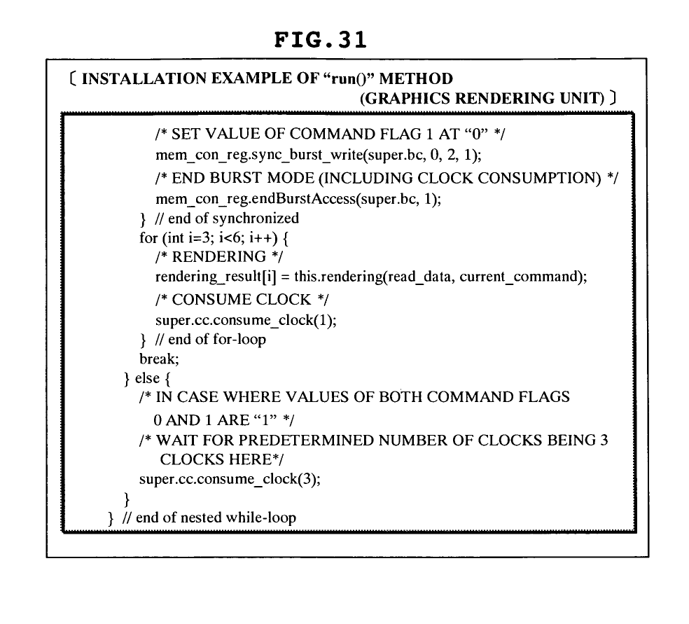

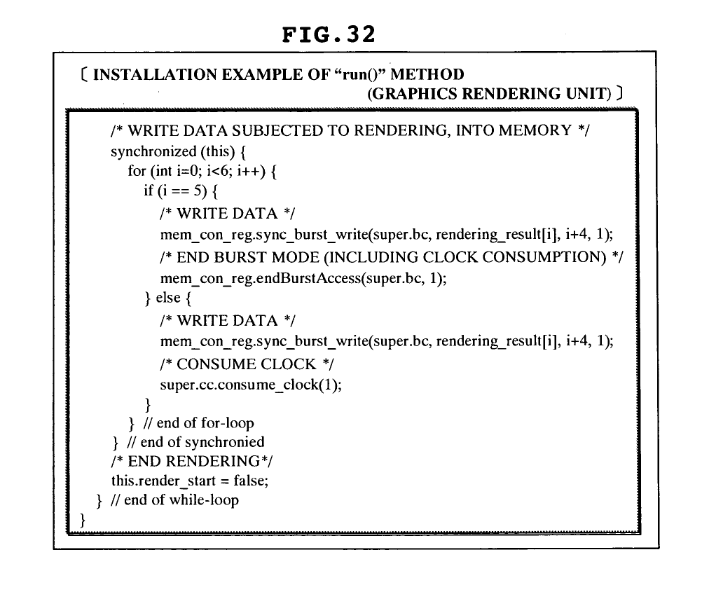

The installation example of the “run( )” method concerning the graphics rendering unit will be explained. This installation example is exemplified in FIGS. 28 through 32. The command flags 0 and 1 in the unified memory are read out by the “sync_burst_read” method every certain predetermined cycle (bus ownership acquisition and release operations). In a case where the value of either of the command flags is “1”, the graphics rendering unit sets an internal status variable “render_start” at “true”, and it attempts to acquire bus ownership. When the graphics rendering unit has acquired the bus ownership, it executes a rendering process while reading a rendering command and rendering data by the “sync_burst_read” method, and it writes a rendering result into an internal buffer (as soon as the graphics rendering unit has read the command and the data, it clears the command flags to “0” and releases the bus ownership). In order to simplify the model, however, even when both the command flags are “0”, only the rendering command corresponding to the command flag 0 shall be executed, and the transfer of rendering source data is omitted. The graphics rendering unit attempts to acquire bus ownership again, and when it has succeeded in the acquisition, it transfers the rendering result to the unified memory by the “sync burst_write” method. Thereafter, it releases the bus ownership and sets the internal status variable “render_start” at “false”. Incidentally, the initial value of the internal status variable “render_start” is “false”.

(4) Display Unit

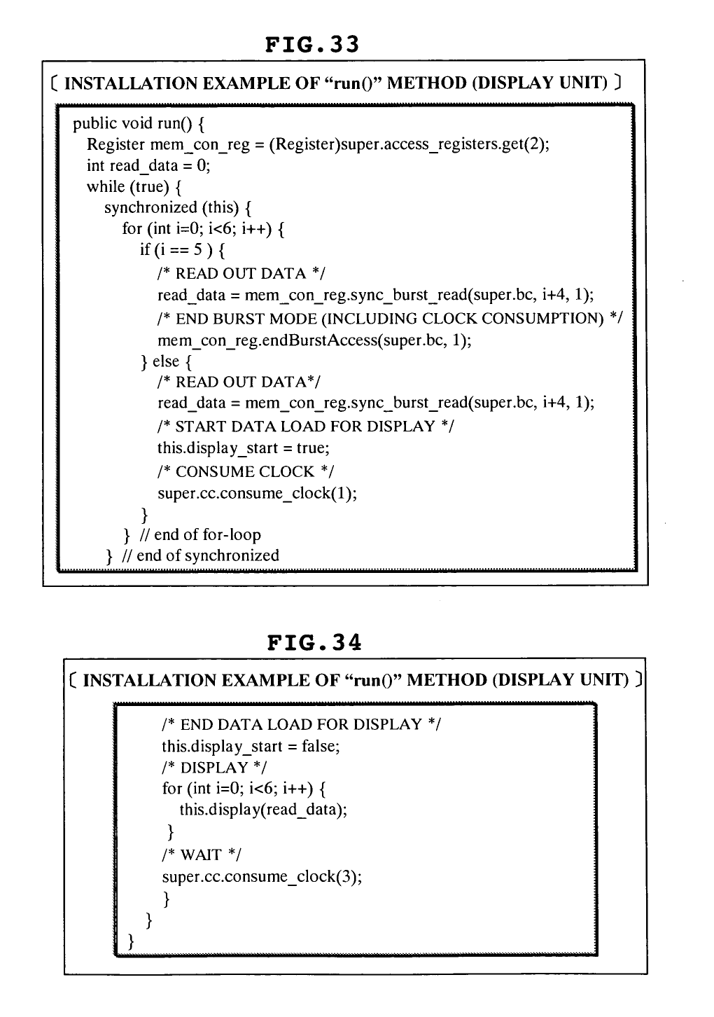

The installation example of the “run( )” method concerning the display unit will be explained. This installation example is exemplified in FIGS. 33 and 34. The display unit reads the displaying data after rendering, from the unified memory, and it outputs them to a CRT. In order to simplify the model, however, only horizontal synchronization shall be handled. This is because a cycle restriction for starting/ending rendering within a horizontal retrace time is intended to be found by parametric model checking.

Now, the display unit sets an internal variable “display_start” at “true” and reads the displaying data after rendering, from the unified memory by the “sync_burst_read” method. After the display unit has read the data, it sets the internal variable “display_start” at “false” and presents a line display. It shall present a line display again by the same procedure after having consumed a suitable number of cycles which correspond to the horizontal retrace time since the end of the first-mentioned line display. Besides, since only the transfer cycles may be modeled, memory addresses are expressed in simplified fashion, and the data shall be always read out of an identical memory space.

<<Parametric Analysis>>

The target of a parametric analysis will be explained here. It is essentially considered that for rendering, it is sufficient to end the execution of one frame in the display time period of one frame display and a vertical retrace time. Therefore, in consideration of a property which the rendering in the horizontal retrace time ought to satisfy, the derivation of the cycle restriction fulfilling the following conditions is sufficient as verification contents: “Rendering is started after the end of the acquisition of the displaying data, and the rendering is sometimes ended before the start of the next display. However, data transfer cycles are included in the rendering start/end, and the display is ended within “n” cycles.” When described by RPCTL (Real-time Parametric Computation Tree Logic), the above restriction becomes the AND condition of the following three restrictions: EF{<display_end>(AF(<render_begin>true) &&{AF(<render_end>true)AU(<display_begin>true)})} &&AG{[display_begin](AF<=n([display_end]true))} Incidentally, it shall be assumable that an unexecuted rendering command is always existent on the unified memory before the end of the display data acquisition. Here, the letter “n” is a suitable positive integer, and the variables express the following: display_begin: rise event of internal variable “display_start” from “0” to “1” display_end: fall event of internal variable “display_start” from “1” to “0” render_begin: rise event of internal variable “render_start” from “0” to “1” render_end: fall event of internal variable “render_start” from “1” to “0”

In order to heighten the speed of the parametric model checking, the RPCTL is separated into: AG{[display_begin](AF<=n([display_end]true))} (*) and the other part, and it is executed on the basis of, for example: EF{<display_end>(EF(<render_begin>true)&&{EF(<render_end>tr ue)AU(<display_begin>true)})} so as to derive a parameter condition. The parametric analysis of the part (*) shall be made in such a way that the upper limit of the number “n” of the part (*) is obtained from the derived parameter, and that this operation is iterated by decreasing the value of the number “n”, until a parameter condition which is not contradictory to parameter conditions already obtained can be derived.

The details of the RPCTL and the parametric model checking which employs it are contained in: “Akio Nakata and Teruo Higashino: Deriving Parameter Conditions for Periodic Timed Automata Satisfying Real-Time Temporal Logic Formulas”, Proc. of IFIP TCG/WG6.1 Int'l Conf. on Formal Techniques for Networked and Distributed Systems (FORTE2001), Cheju Island, Korea, Kluwer Academic Publishers, pp. 151-166, August 2001”.

<<Conversion into Intermediate Expression>>

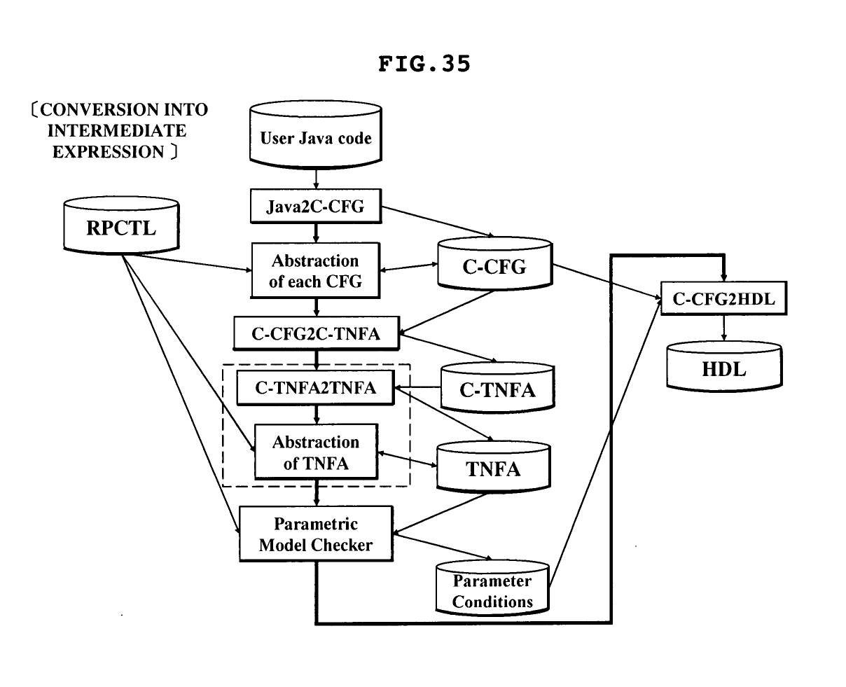

The details of a process for conversion into an intermediate expression are entirely exemplified in FIG. 35. Java language descriptions described by modeling the bus system are converted into a C (concurrent)-CFG (Java2C-CFG), the C-CFG is converted into a C-TNFA (C-CFG2C-TNFA), and the C-TNFA is converted into a TNFA (C-TNFA2TNFA). The C-CFG is converted into an HDL via the parametric model checking (C-CFG2HDL). By the way, in the above expressions of “Java2C-CFG” etc., it is to be understood that numeral “2” signifies “to”.

<<Java2C-CFG>>

A conversion algorithm from the Java language descriptions to the C-CFG will be outlined. The CFG corresponding to each “run( )” method is generated. Especially, the clock synchronization method (“consume_clock”) is identified as a clock boundary, and a calling method is expressed using a node expressive of calling relations. When the CFGs corresponding to the individual “run( )” methods have been generated, a fork node is provided, and fork branches from the fork node to the start nodes of the respective CFGs are affixed. Especially, premising that the Java is described with the “run( )” methods corresponding to the individual devices on the bus, it shall be designated that any CFG is not generated for the memory device.

Subsequently, the CFGs of the calling methods are created. In a case where the calling method exists within the “synchronized” block, the “synchronized” operation within the calling method is deleted from the CFG. Especially, in a case where the calling method is a communication method within the “Register” class, the CFG is not created, only the name of the communication method, and which register within which device is to be accessed are identified from instance relations, and the identified information items are held in the CFG. In the drawings, however, the information on the register to-be-accessed is omitted. By the way, in a case where the communication method includes the clock synchronization method therein, a clock boundary is marked at the output branch of this communication method. Further, excepting that the cycle restriction of the whole calling method is derived, the calling method is in-lined. Here in this example, the “Rendering” method and the “Display” method are not in-lined.

The “synchronized” operation is expanded into a predetermined CFG, and is automatically generated using a library in which a fixed priority scheduler for the hardware synthesis is previously given as a skeleton in the form of an FSM (Finite State Machine), and the number of the “run( )” method which have actually generated CFGs. Here, two sorts of CFGs for the hardware synthesis and for the parametric model checking are created.

Incidentally, fixed value propagation, and code level optimization such as the deletion of a local variable attributed to assignment are performed on the CFG. Especially, the input, output and input/output of signals are expressed by member variables, and the direction of a terminal is determined by analyzing whether the terminal lies at the right hand or the left hand in an assignment statement within a program, and how the variable is used in a conditional statement. In a case where the input/output signal has been identified, it is separated into an input and an output by appropriately renaming the signals in consideration of data dependency.

Regarding the Java2C-CFG, the CFG generation result and C-CFG generation result of the “run( )” methods and the FSM of the fixed priority/scheduler will be explained along Java description examples below.

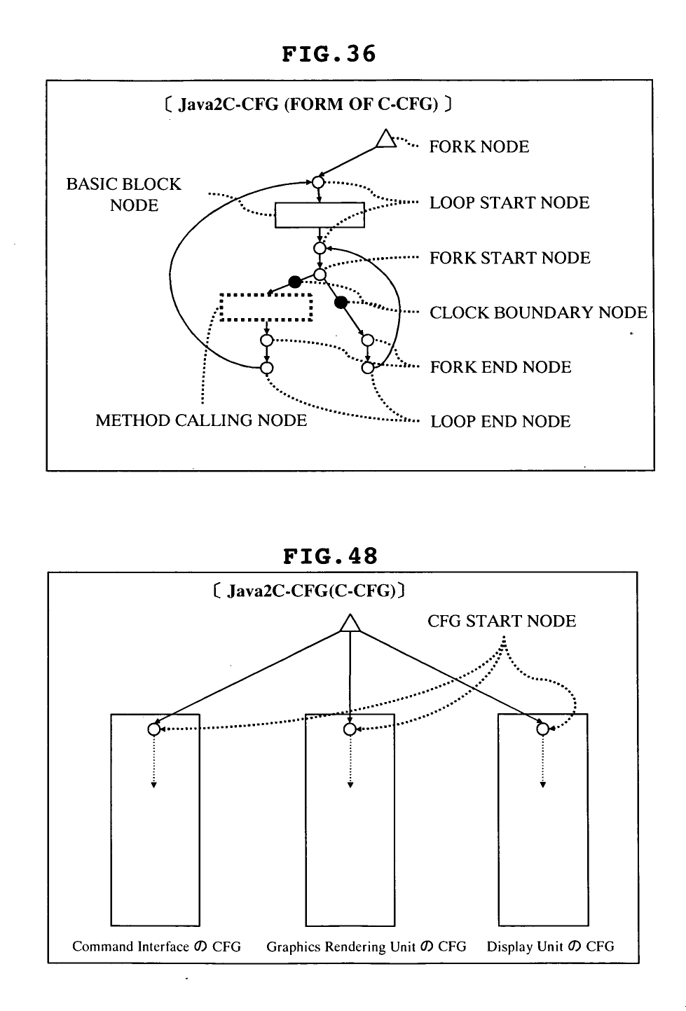

First, the form of the CFG will be explained. The form of the C-CFG is exemplified in FIG. 36. Each CFG has the form which includes nodes expressive of the start and end of a fork branch, and nodes expressive of the start and end of a loop branch, and in which a fork condition and a loop end condition are affixed to the corresponding branches. Especially, a clock boundary is expressed by affixing a clock boundary node onto the branch. Besides, a link to a sub CFG is expressed by employing a node which corresponds to a method call. A “fork” node which expresses the parallel execution of individual CFGs is expressed by affixing it to the top for the CFGs.

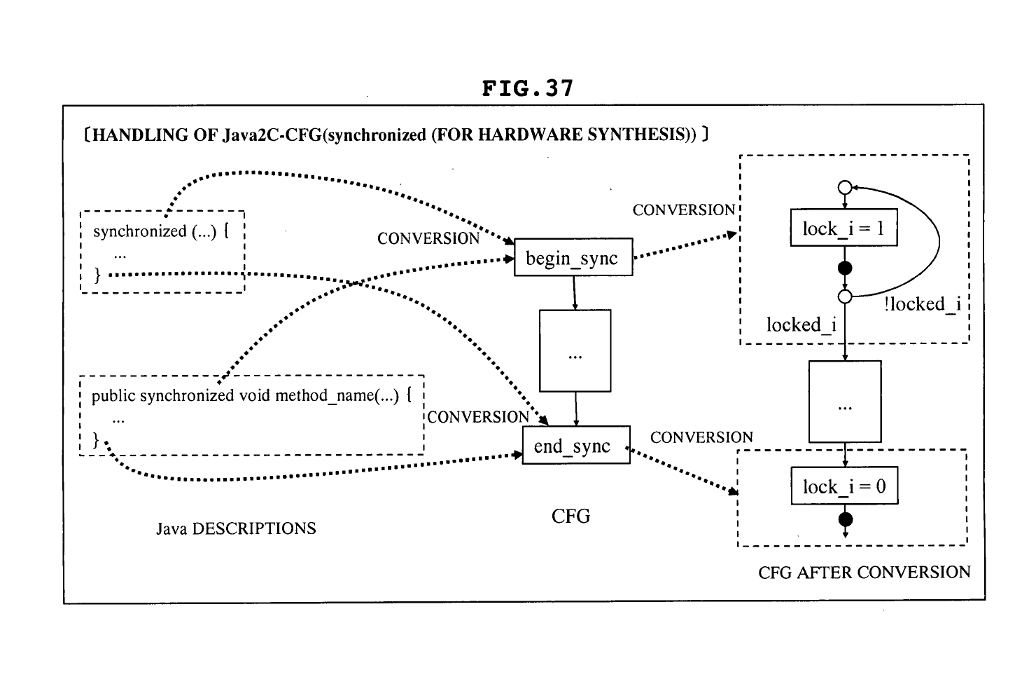

The handling of the “synchronized” operation (for hardware synthesis) will be explained. As exemplified in FIG. 37, the CFG is generated by expressing the start of the “synchronized” operation as a node which is labeled as “begin_sync” on the CFG, and the end thereof as a node which is labeled as “end_sync”. Thereafter, both the nodes are respectively converted as indicated in FIG. 37.

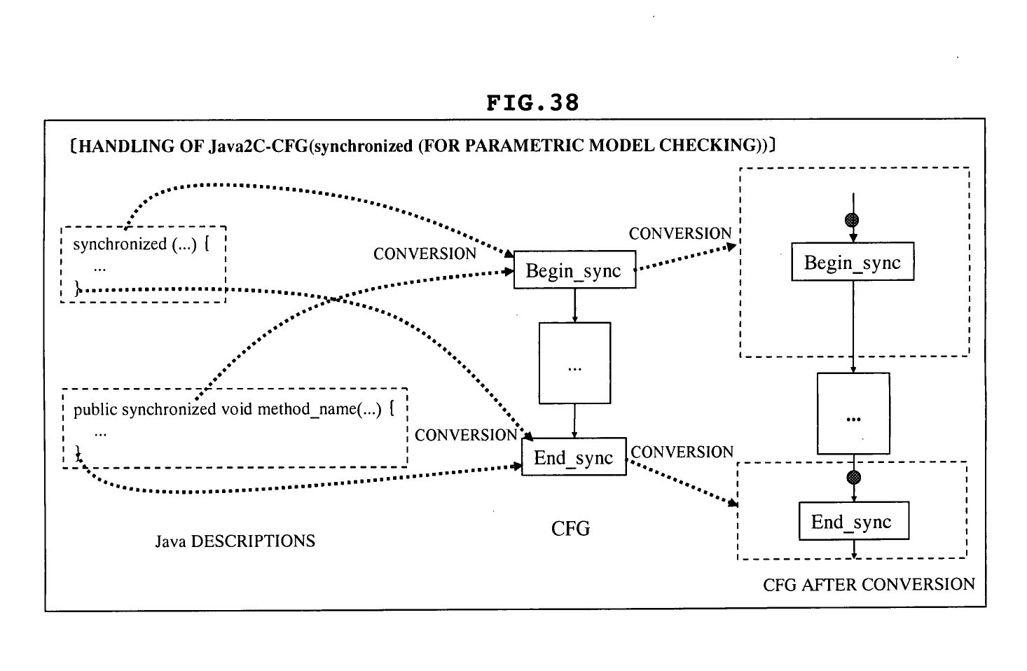

The handling of the “synchronized” operation (for parametric model checking) will be explained. As exemplified in FIG. 38, the CFG is generated by expressing the start of the “synchronized” operation as a node which is labeled as “Begin_sync” on the CFG, and the end thereof as a node which is labeled as “End_sync”. Thereafter, both the nodes are respectively converted as indicated in FIG. 38.

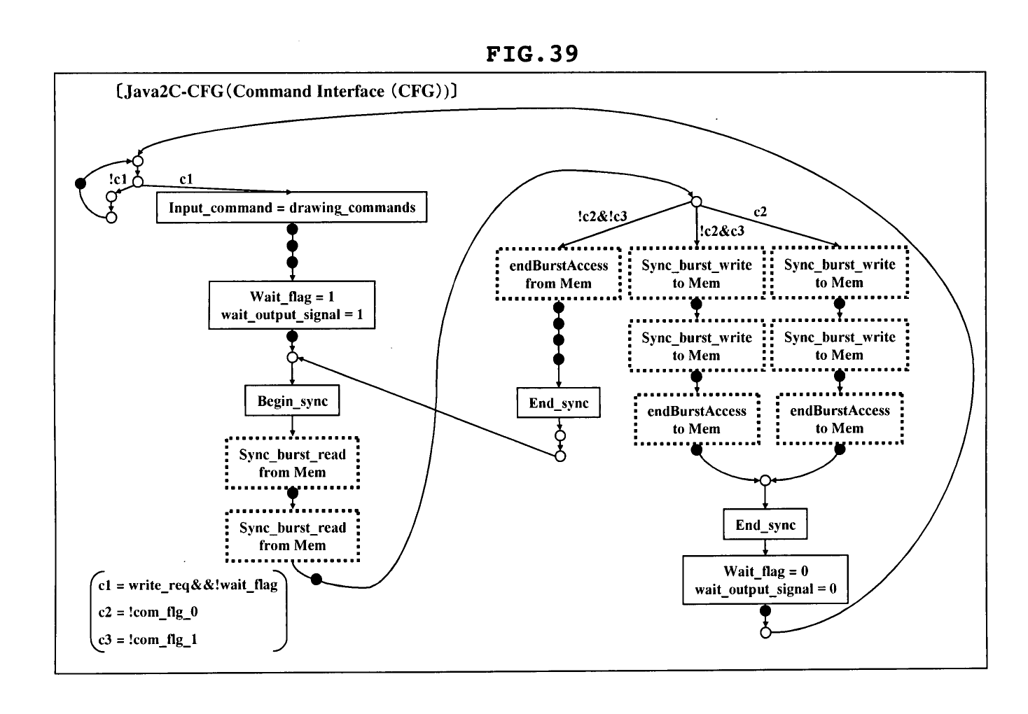

According to the above, in the case of the command interface, the CFG is as shown in FIG. 39. A “getWriteSignal( )” method is a description for performing the simulation, and it is revised as an external input signal “write_req” in an input to the processing system. A description which corrects a variable “dcom_index” expressive of the number of input test vectors is also deleted. Besides, a method “drawing_commands” is expressed as arrays, and it is also given for performing the simulation. This method is so handled that a description in which the input variable “drawing_commands” is entered into an internal variable “input_variable” is input to the processing system.

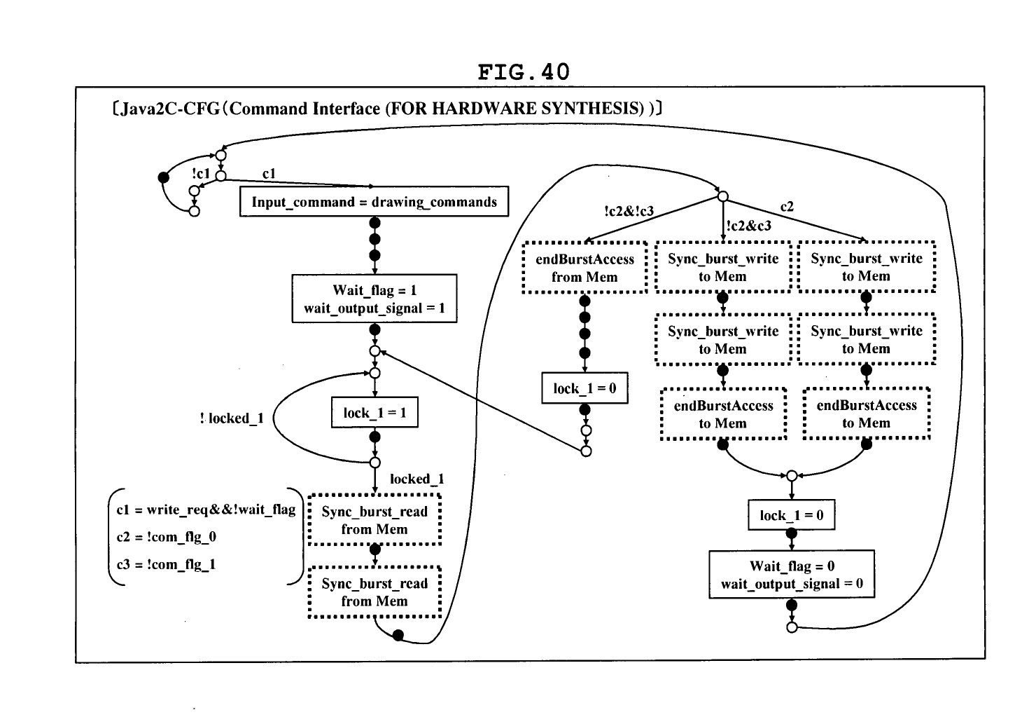

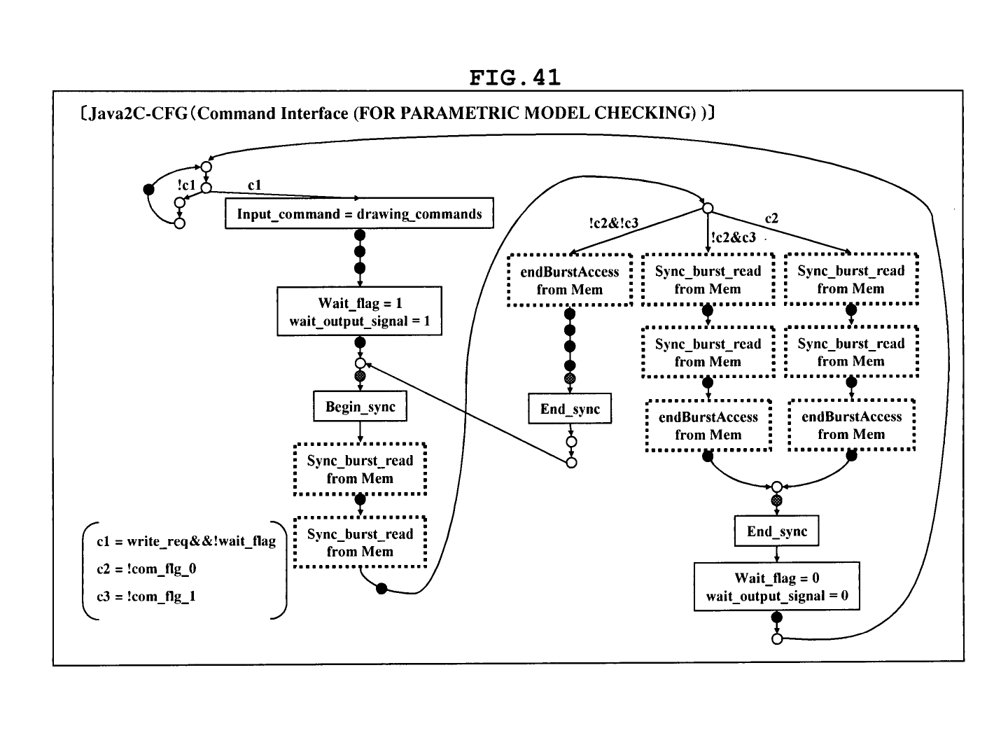

Regarding the command interface, the CFG for the hardware synthesis is shown in FIG. 40, and the CFG for the parametric model checking is exemplified in FIG. 41.

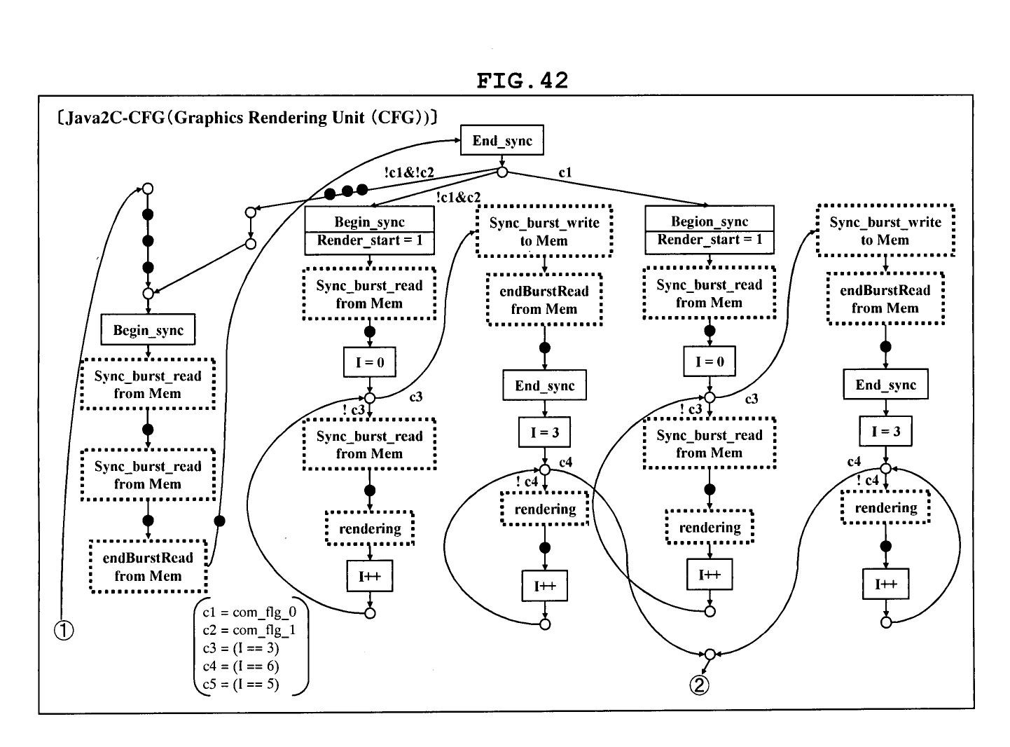

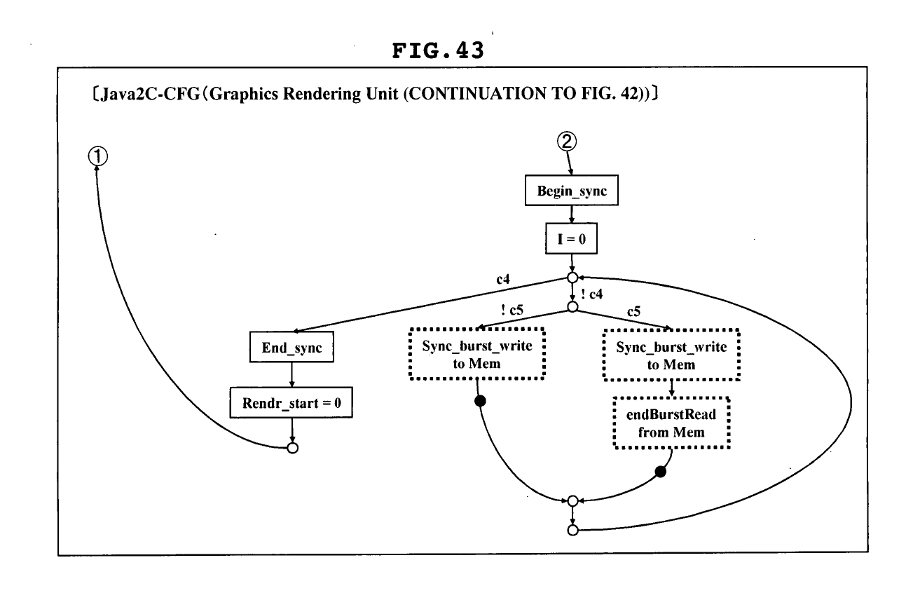

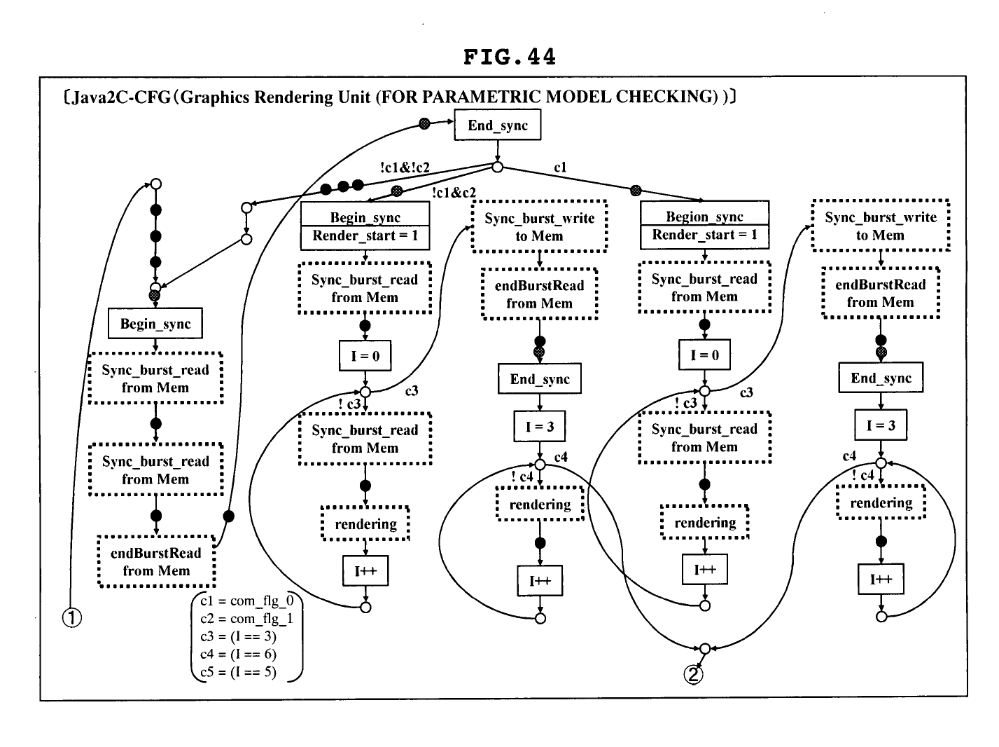

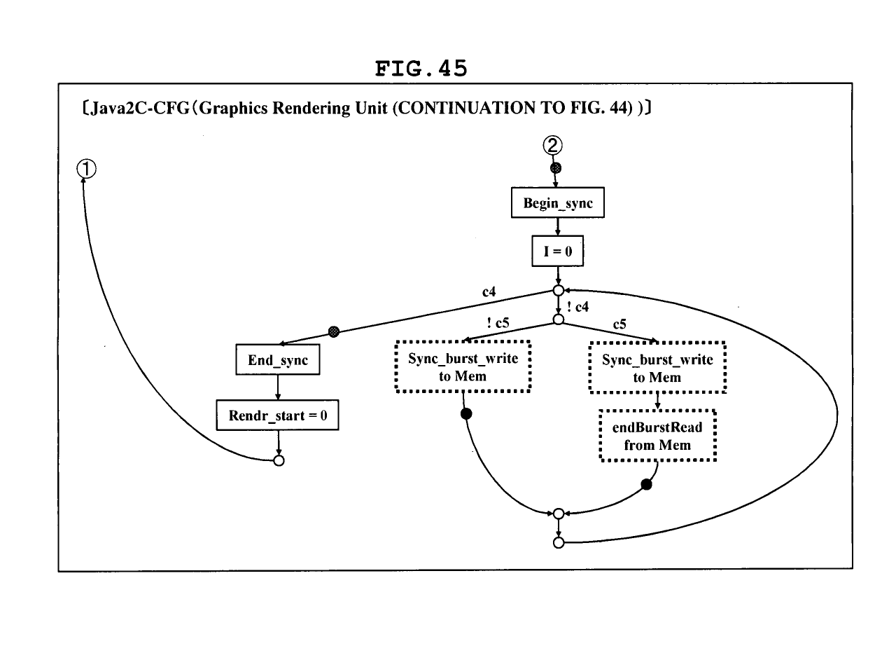

Regarding the graphics rendering unit, the CFG thereof is exemplified in FIGS. 42 and 43, and the CFG thereof for the parametric model checking is exemplified in FIGS. 44 and 45.

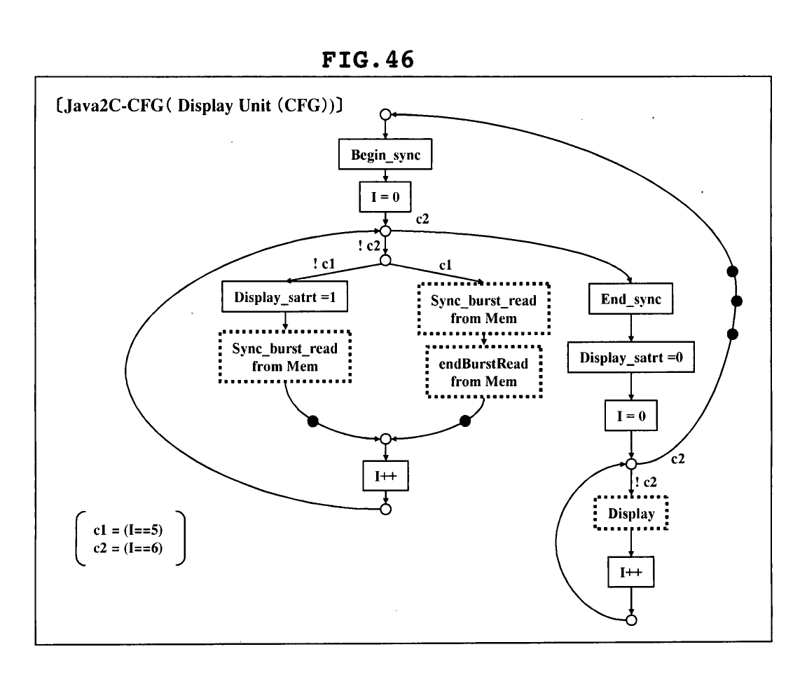

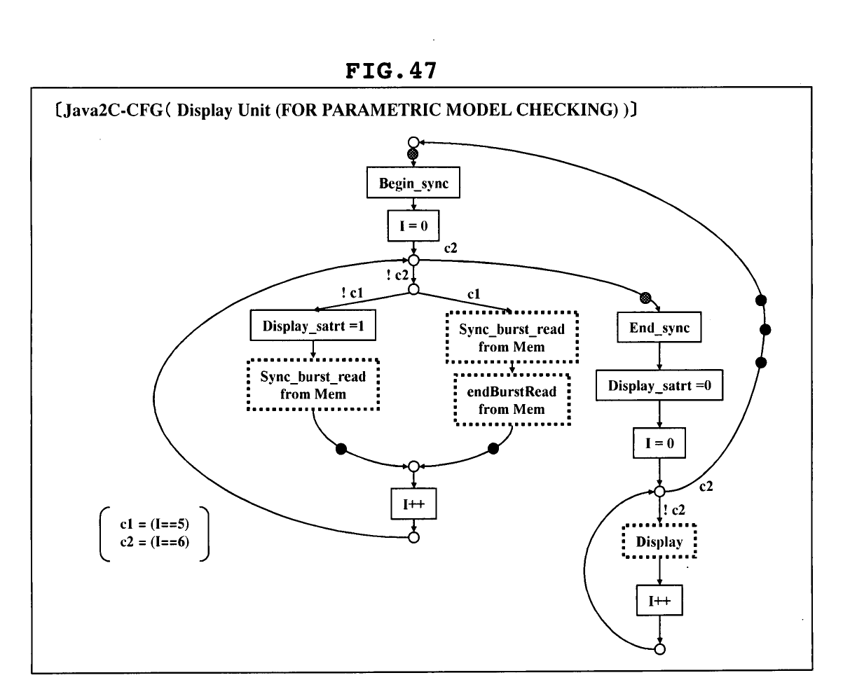

Regarding the display unit, the CFG thereof is exemplified in FIG. 46, and the CFG thereof for the parametric model checking is exemplified in FIG. 47.

Exemplified in FIG. 48 is the linked state of respective start nodes in the CFG of the command interface, the CFG of the graphics rendering unit and the CFG of the display unit.

The fixed priority scheduler will be explained. This scheduler identifies the number of the “run( )” methods having actually generated the CFGs of the top level, and creates states in a set of signals “locked_i” for giving bus ownership notifications to the respective devices. Because of the single bus system, it is sufficient that states are established in which only one of the signals “locked_i” is “1”, the others being “0”. Besides, a state where all the signals “locked_i” are “0” is also created. When state transition branches which are executed by receiving bus ownership request signals “lock_i” on the basis of priority information are provided, the fixed priority scheduler for bus ownership management can be constructed. Especially, the state where all the signals “locked_i” are “0” is used as the start state of a reset release mode. Besides, a temporal restriction “1<=t<=k1” shall be imposed on each state transition. This parameter is a parameter which is determined by the later parametric model checking. Besides, in a case where, for example, where each transition is made a 2-clock transition by setting k1=2, it shall be construed that an output value holds a preceding value until any change occurs.

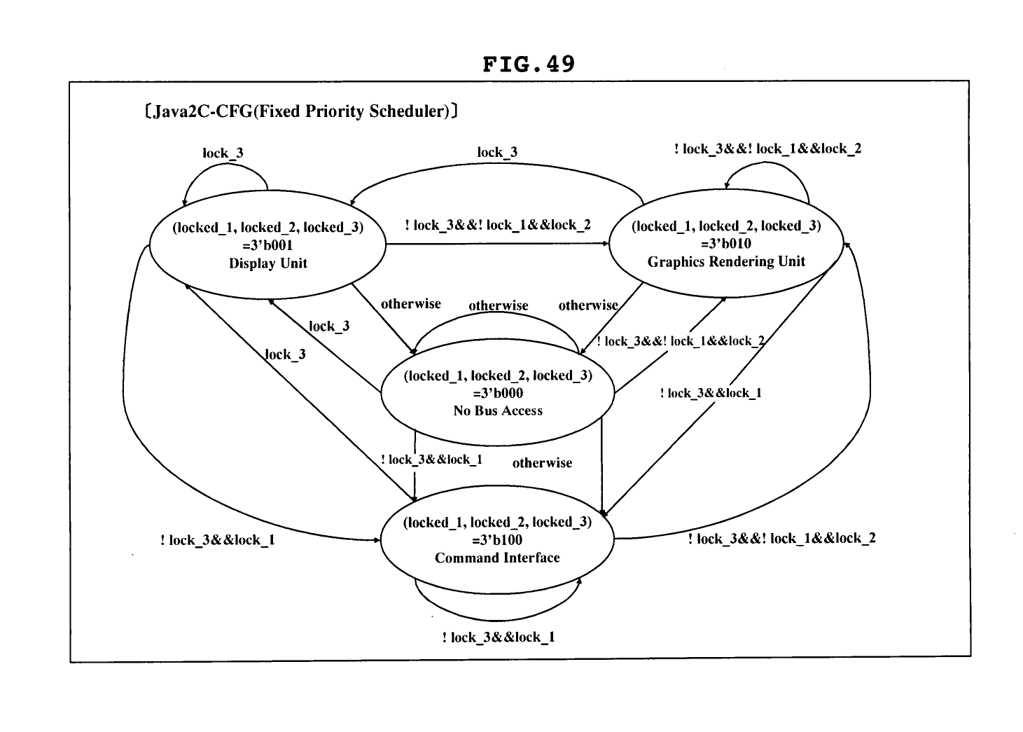

The fixed priority scheduler corresponding to this example is exemplified in FIG. 49. The significances of signals in the figure are:

lock_1: Bus ownership request signal from Command interface

lock_2: Bus ownership request signal from Graphics rendering unit

lock_3: Bus ownership request signal from Display unit

locked_1: Bus ownership acquisition notification signal to Command interface

locked_2: Bus ownership acquisition notification signal to Graphics rendering unit

locked_3: Bus ownership acquisition notification signal to Display unit Incidentally, since the priority levels of the bus ownership acquisitions are: Display Unit>Command Interface>Graphics Rendering Unit, transitional conditions become:

lock_3: Transition to Display unit

!lock_3&&lock_1: Transition to Command interface

!lock_3&&!lock_&&lock_2: Transition to Graphics rendering unit

otherwise: Transition to State where all “locked_i” signals are “0”

<<Abstraction of Each CFG>>

The abstraction process of each CFG will be explained. First, the algorithm of the process will be outlined. A time transitional condition “0<=t<=ki” is imposed on each “Basic Block”, and a condition “0<=t<=k1” is imposed on the “Begin_sync” node and “End_sync” node. Regarding the node expressive of the communication method, a condition “1<=t<=kb1” is imposed on a burst start, a condition “0<=t<=kb2” is imposed on a burst operation, and a condition “0<=t<=kb3” is imposed on a burst end. However, considering that the burst start requires at least 2 cycles, that the burst operation requires at least one cycle and that the burst end requires at least one cycle, the cycle restrictions are corrected for the node expressive of the communication method in abstracting nodes by merge as stated below. The abstraction is performed by regarding as clock boundaries, the nodes on which restrictions are imposed, except the “Begin_sync” and “End_sync” nodes. “BasicBlock” means a line of statements (for example, a assignment statement or a conditional branch statement) that is being programmed, and the line has neither branch nor junction, and, in addition, a statement is carried out straight till the last from the top, and a line of statements is a subset of a program.

The communication method has all its operating contents abstracted, and successive nodes are collected into one node. Assuming, for example, that the nodes are the burst start (1<=t<=kbl), the clock boundary (t=1), 3 times of (the burst operation (0<=t<=kb2)+the clock boundary (t=1)), the burst end (0<=t<=kb3) and the clock boundary (t=1), they are collected into one node as a clock boundary which has the following cycle restriction:
6<=t<=(kb1+1−1)+3(kb2+1−1)+(kb3+1−1)=kbl+3kb2+kb3 (>=2+3*1+1=6)
Besides, the fork nodes are all supposed to be of nondeterministic forks. Regarding the “BasicBlock” node, only variables for use in an input RPCTL are left, the other variables being abstracted. In a case where any part corresponding to the “BasicBlock” as exists below the fork node is the same as parts in different forks, one part is left, the others being deleted.

Especially, regarding the loop node, a fixed-number-of-times loop which does not include “break” or “continue” is subjected to unrolling, and otherwise, the loop is deleted by providing a set of CFG nodes which have a cycle restriction 0<=t<=kloop as a whole immediately before a condition branch that quits the loop. Here, a condition which the variable “kloop” ought to satisfy shall be separately calculated. Further, successive clock boundaries are collected into one by executing a percolation-based movement, and the transition cycle restriction is updated.

Here, owing to the parameterization of each clock boundary, the transition cycle restriction imposed on the clock boundary signifies a cycle restriction on a transition from the clock boundary to the next clock boundary.

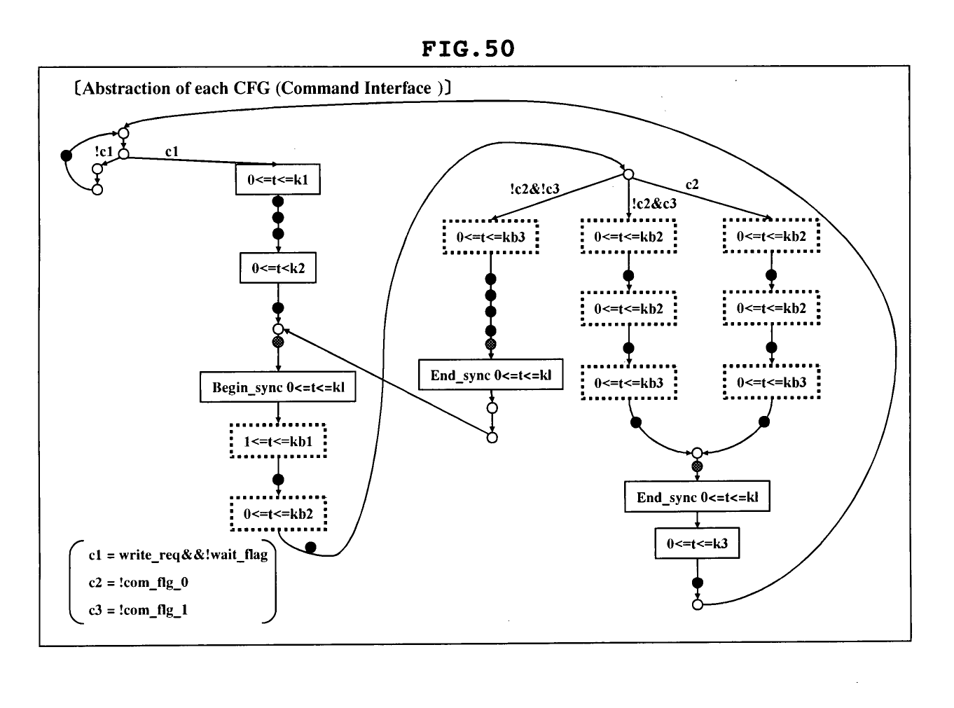

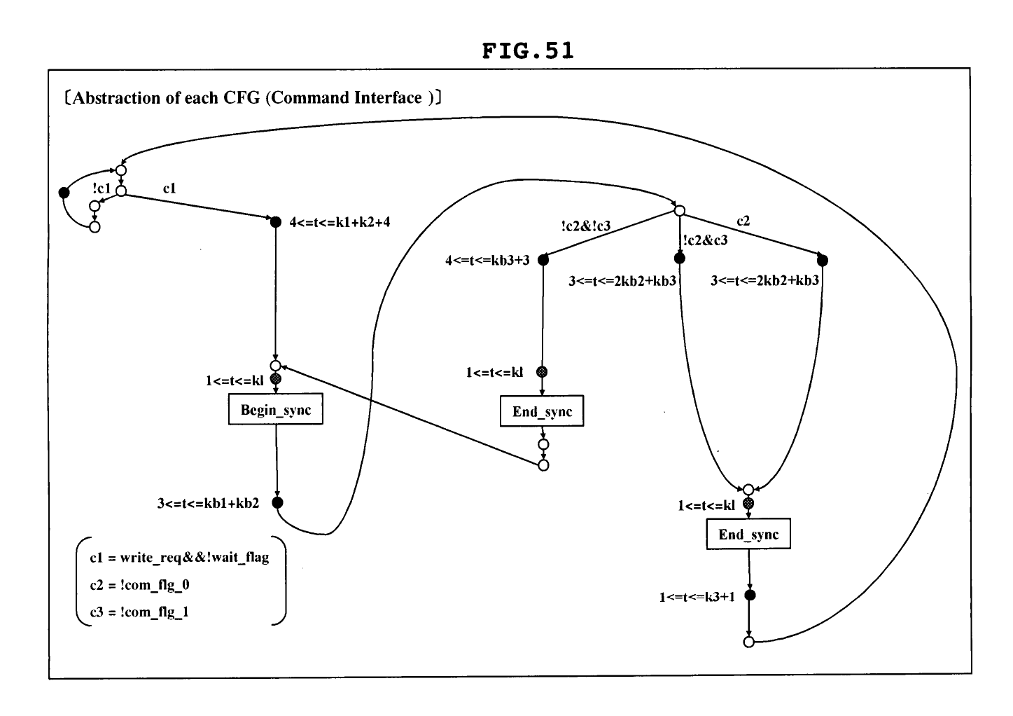

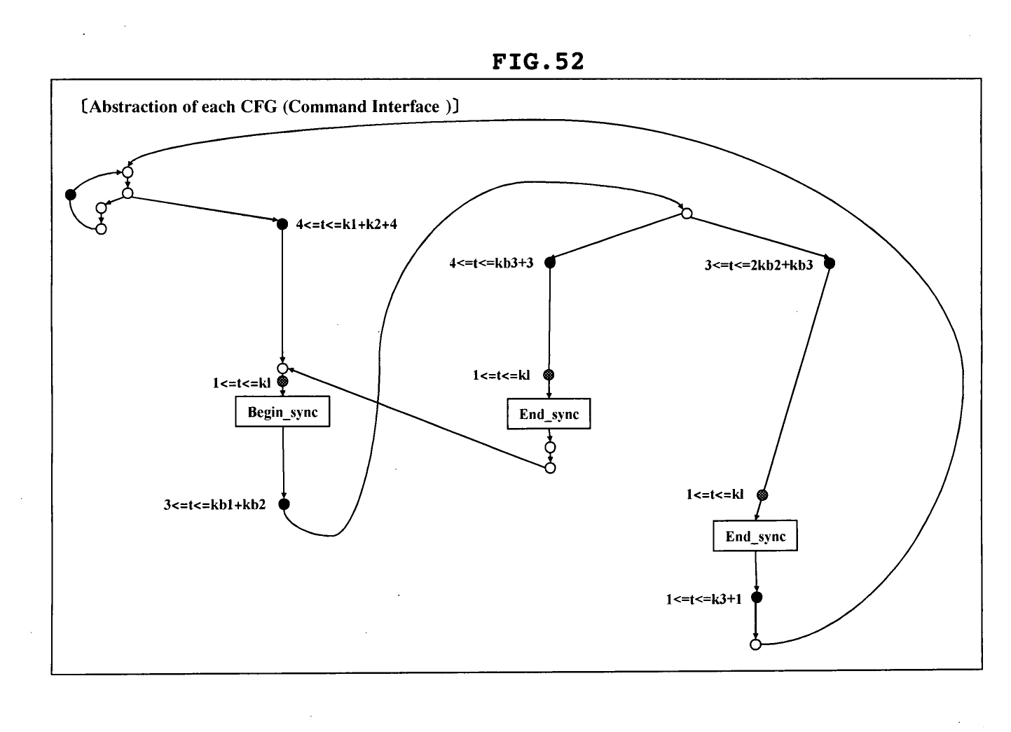

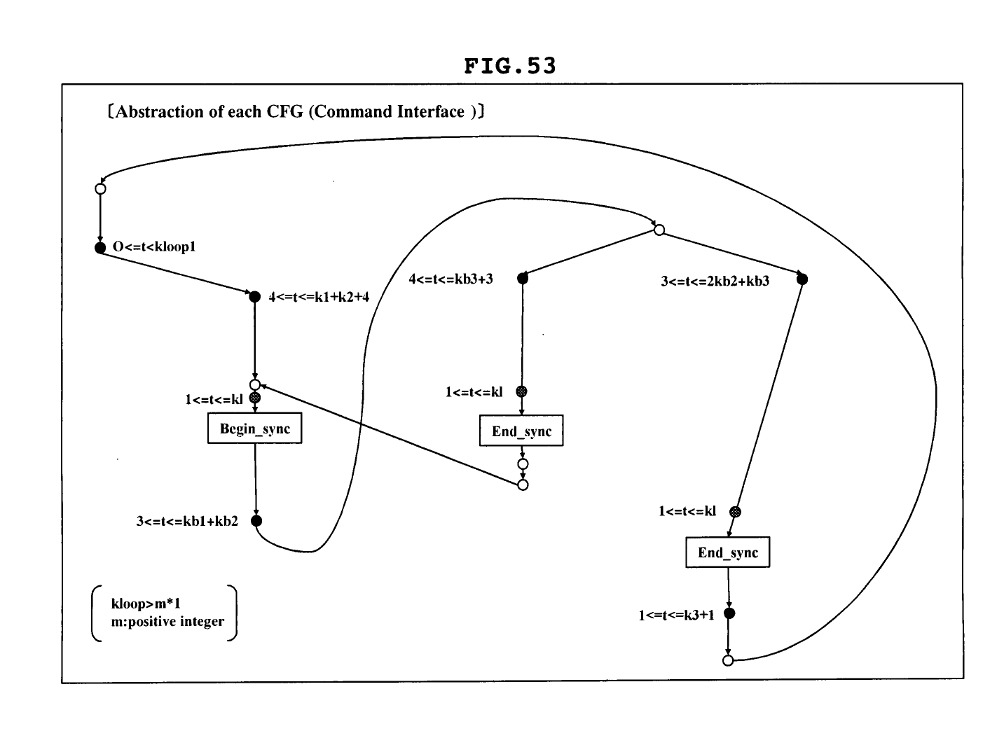

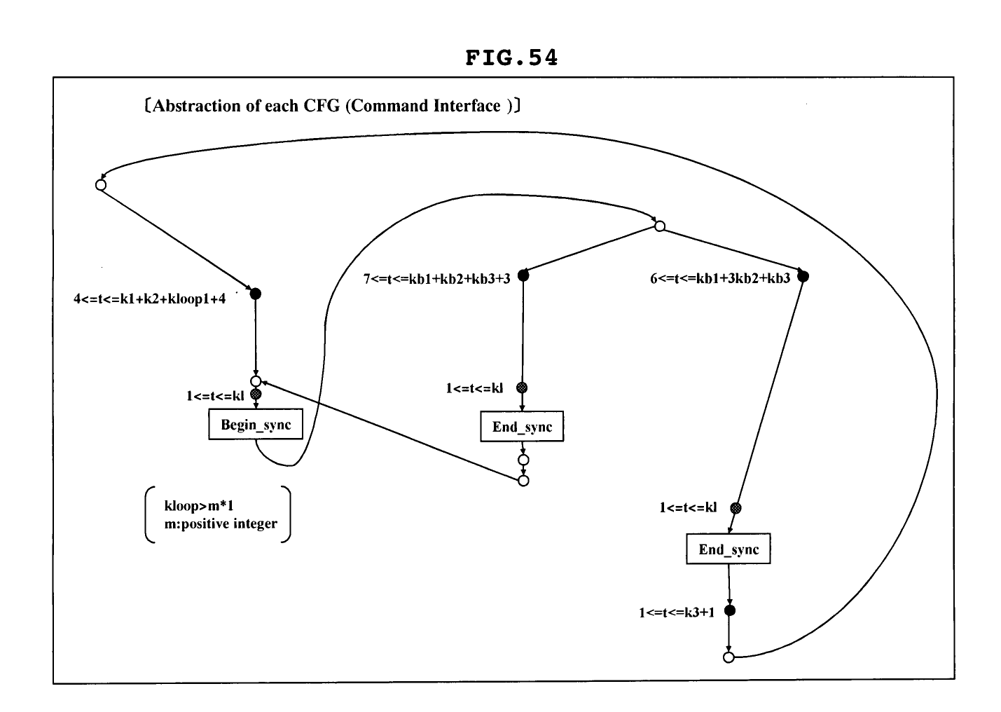

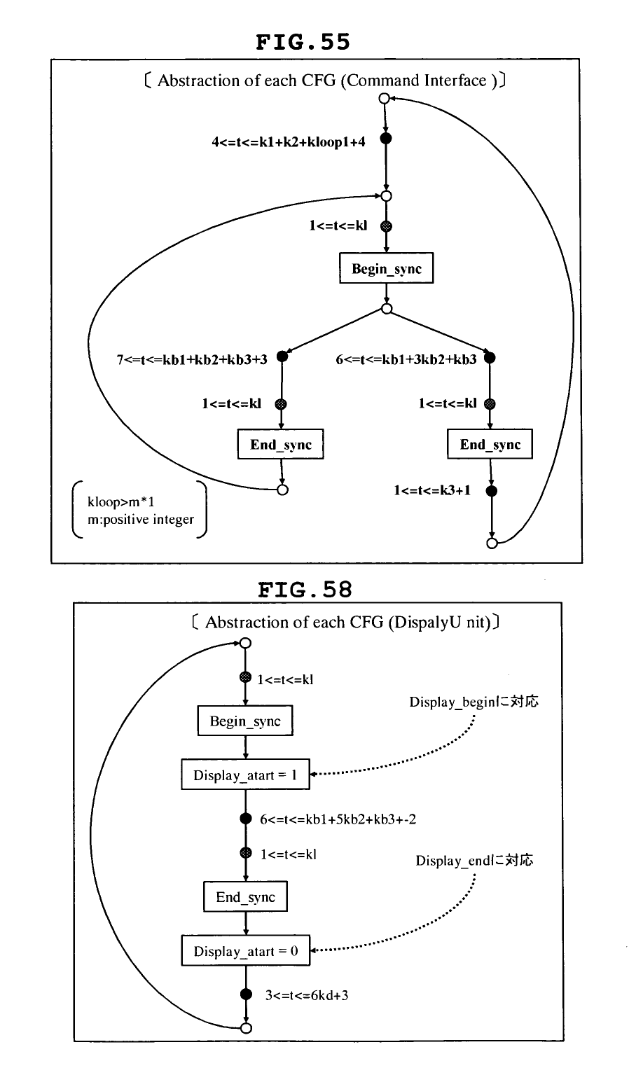

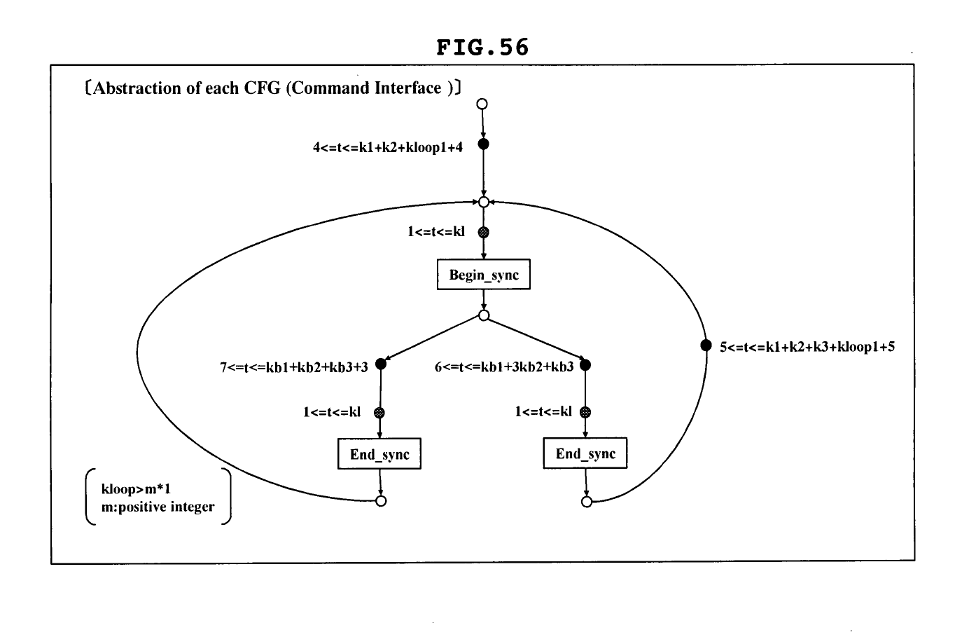

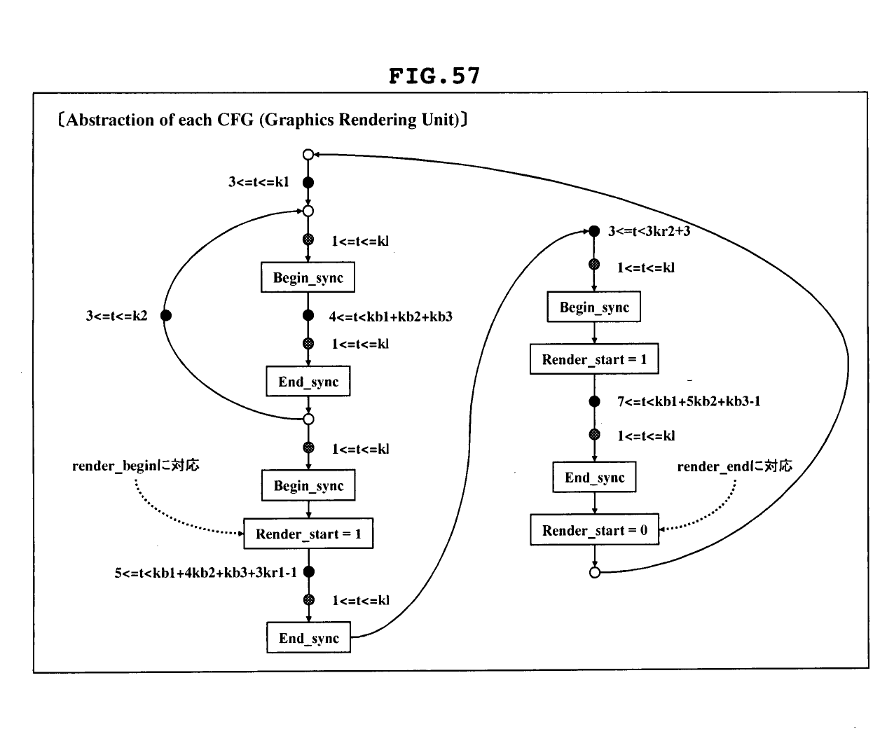

The situation of the abstraction for each CFG of the command interface is exemplified in FIGS. 50 through 56 in due course. The result of the abstraction process for each CFG of the graphics rendering unit is exemplified in FIG. 57. The result of the abstraction process for each CFG of the display unit is exemplified in FIG. 58.

<<C-CFG2C-TNFA>>

A conversion process from a C-TNFA to a TNFA will be explained. The “TNFA” is a temporal automaton, each transition of which is expressed in the following form: s-a@?t[P(t)]→s′ Here, the significances of the individual symbols are: s, s′: states, a: operation (omissible), @?t: assignment to “t”, of time which has lapsed since visit to state “s” till execution of operation “a”, P(t): temporal restriction (logic link of linear inequality concerning “t”). Besides, the transitional form signifies “Transition from the state “s” to the state “s′” after the lapse of the “t” unit time, only in the case where “t” satisfies the temporal restriction P(t)”.

The “C-TNFA” is a model in which a plurality of TNFAs operate in parallel, and in which an operation “sync” can execute, at most, only one TNFA. Especially, another TNFA cannot interrupt successive operations “sync”. Incidentally, it is possible to impose on each TNFA, a temporal restriction for affording an upper limit to the transition from an initial state to the initial state.

Next, a conversion process from a C-CFG to the C-TNFA will be explained. First, the conversion algorithm of the process will be outlined. A part held between descriptions “Begin_sync” and “End_sync” is identified, and is set as a “sync” block. A clock boundary node which does not exist in the “sync” block is set as a state allotment candidate. Besides, in a case where a signal required for a verification property is given as a “BasicBlock” even in the “sync” block, a clock boundary node before or behind the “BasicBlock” is set as a state allotment candidate. Lastly, a clock boundary introduced by converting the descriptions “Begin_sync” and “End_sync” is set as a state allotment candidate. The CFG is converted into the TNFA in such a way that the state allotment candidates obtained are allotted so as not to concur, and that a section from each state to another state is traversed by the DFS (Depth First Search). A transition corresponding to the “sync” block is detected for the obtained TNFA, and is set as a “sync” transition. The number of states is decreased by collecting into one transition, transitions which are not successive transitions.

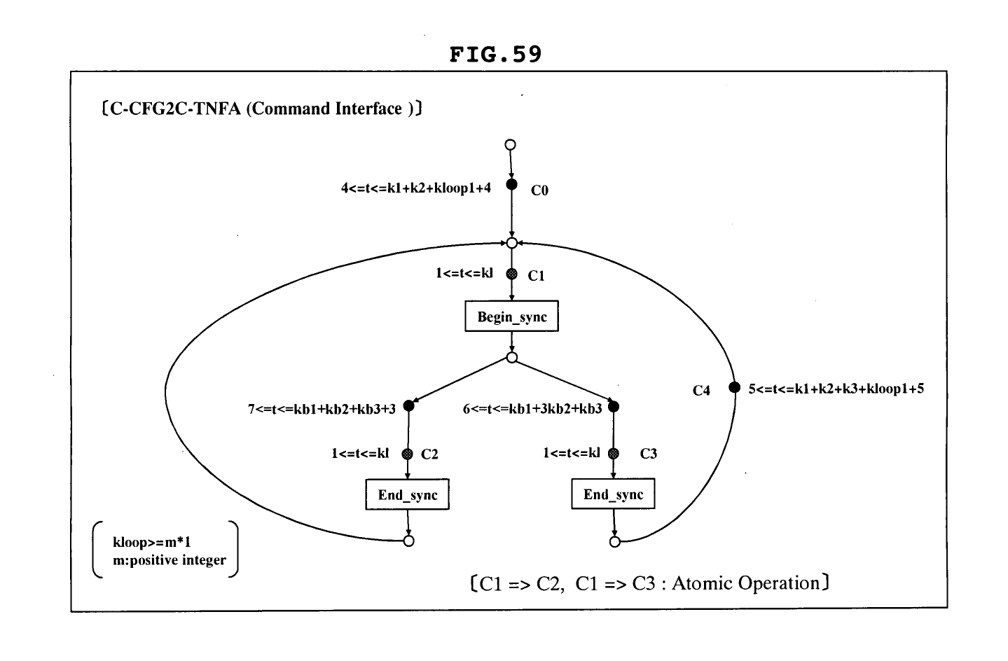

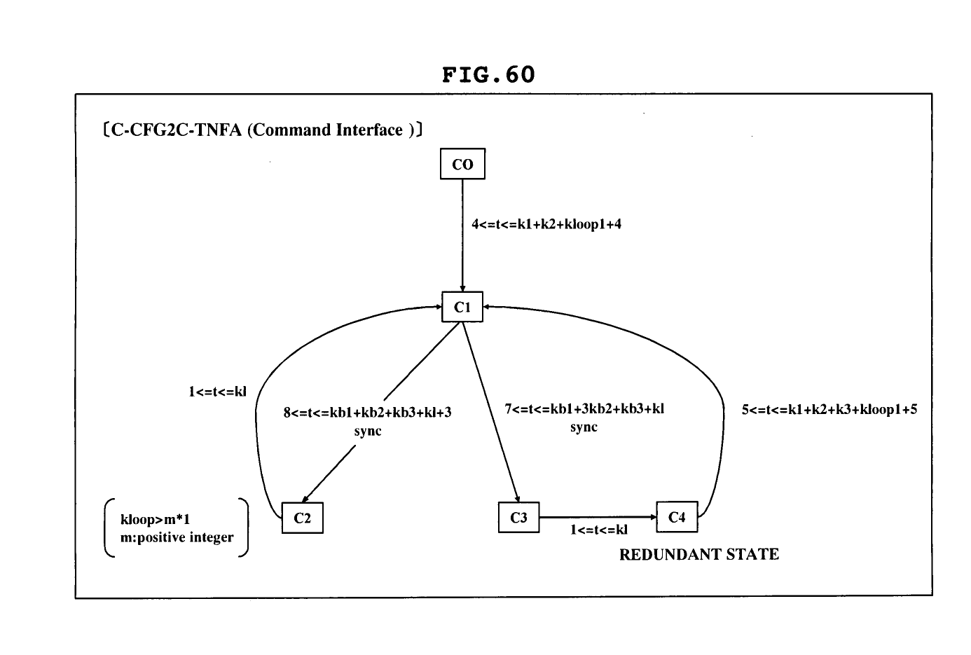

The situation of the conversion of the CFG of the command interface into the TNFA is exemplified in FIGS. 59 through 61 in due course.

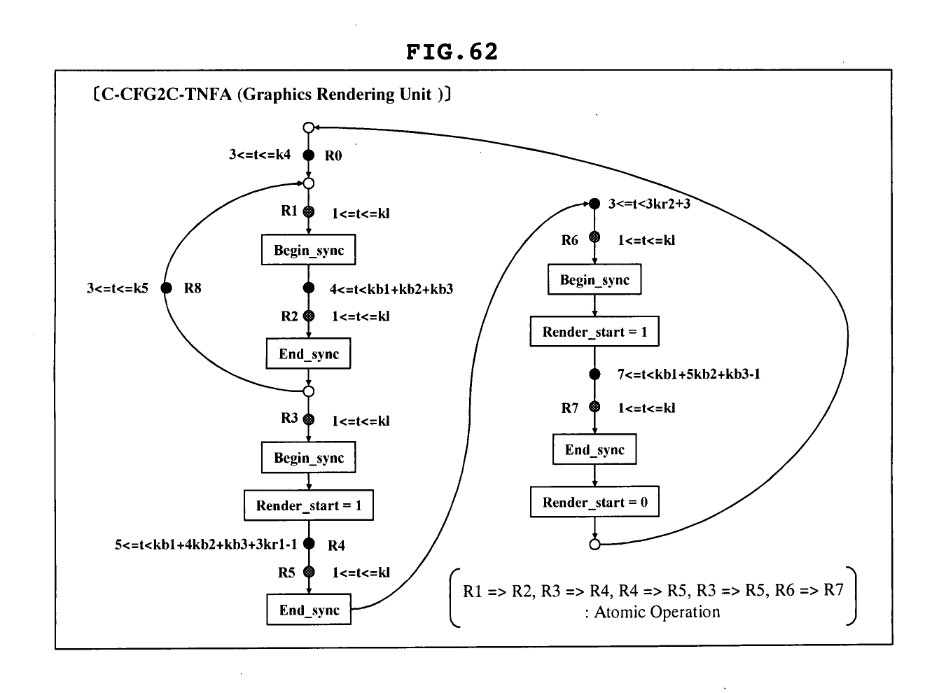

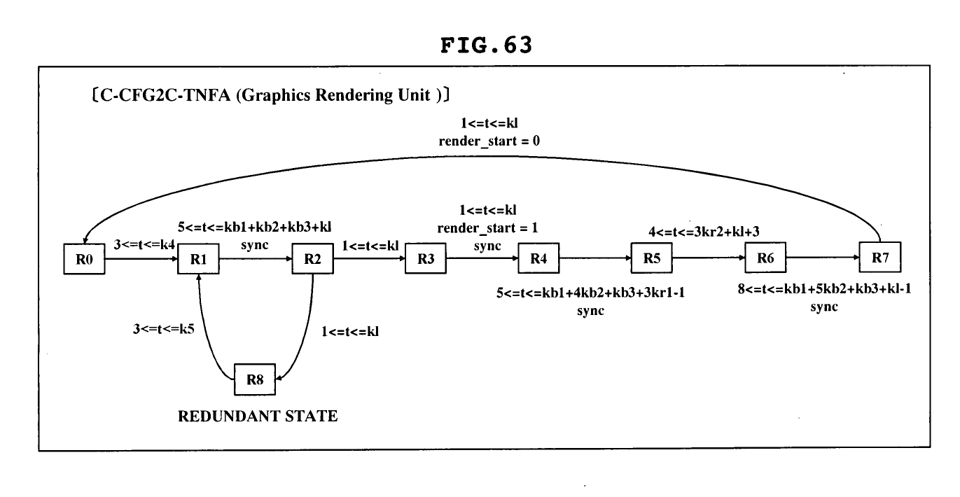

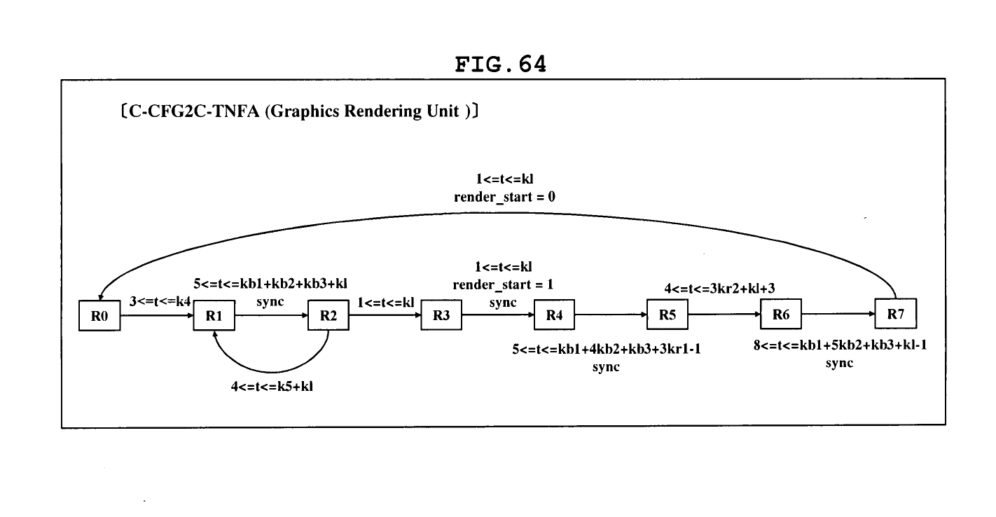

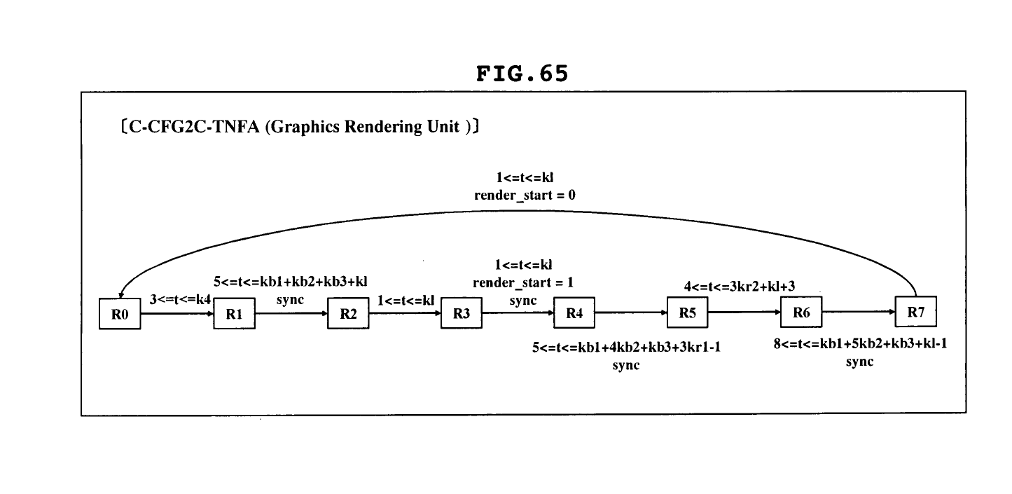

The situation of the conversion of the CFG of the graphics rendering unit into the TNFA is exemplified in FIGS. 62 through 65 in due course. Referring to FIG. 65, the verification property is “that rendering is started after the end of the acquisition of displaying data and is sometimes ended before the next display start, and that data transfer cycles are included in the rendering start and end, while a display is ended within “n” cycles”. Since this is the verification property premised on the start of the rendering, the verification does not require a transition from “R2” to “R1” as expresses that any unexecuted rendering command does not exist on the unified memory before the end of the display data acquisition, in the TNFA corresponding to the graphics rendering unit. Accordingly, the transition is deleted.

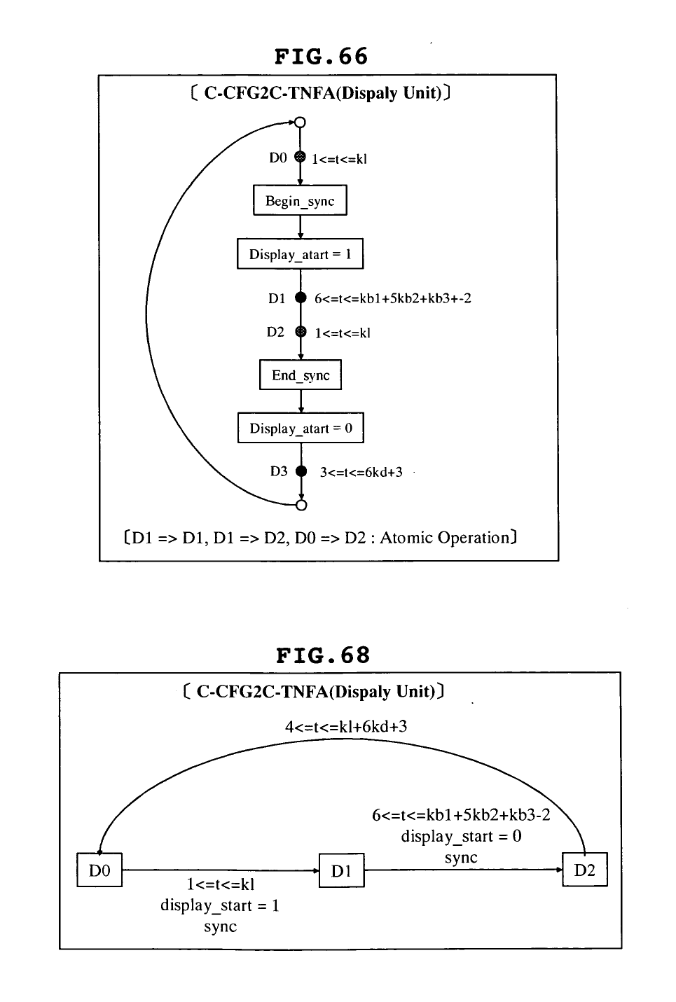

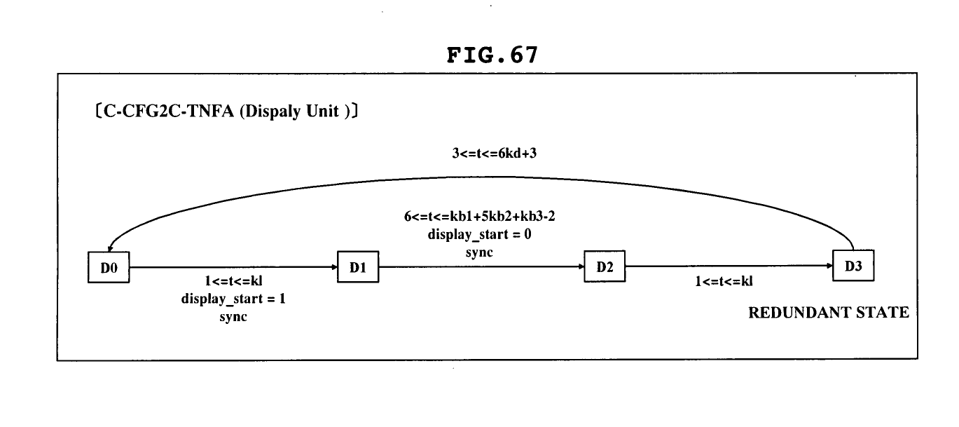

The situation of the conversion of the CFG of the display unit into a TNFA is exemplified in FIGS. 66 through 68 in due course.

<<C-TNFA2TNFA>>

A conversion algorithm from the C-TNFA to the TNFA will be outlined. First, a product TNFA is constructed from the C-TNFA in conformity with the following policies (1)-(5):

(1) The “sync” operation and any other operation are interleaved with each other. Here, it is expressed that, while the “sync” operation is proceeding, the operation which need not acquire bus ownership, namely, the operation which is not the “sync” operation (in general, two or more operations) can be executed in parallel. However, the parallel transition of another TNFA during the execution of the “sync” operation for one transition has a limit imposed on the number of times which a transition branch is transited, and the upper limit of the transition time period of each transition as satisfies the number of times is derived. Especially, the number of times shall be begun at “1”, and it shall be incremented one by one until a significant solution is obtained.

(2) In a case where a plurality of “sync” operations are executable, a transition is done by the highest static priority. Here, an immobile state “s” undergoes a transition to “age(s,t)” (a state where only the time “t” has lapsed in the state “s”). However, any other operation cannot interrupt successive “sync” transitions.

(3) Transitions after the state “age(s,t)” are corrected as to the time “t”, as follows: If s-[P(t1)]→ is conditional, age(s,t)-[P(t+t1)]→s′[t+t1/t1] is set. Here, “s[e/t]” expresses that the variable “t” which appears in the transitional condition from the state “s” is substituted by a formula “e”. By the way, in a case where the reconstructed formula “P(t)” is a contradictory formula, the pertinent transition shall be deleted, and all states which arrive at only the transition shall be deleted.

(4) The time variables “t” of individual transitions are altered to different names, as follows: s-[P(t)]→s′-[Q(t)]→s″ is altered to s-[P(t1)]→s′-[Q(t2)]→s″. Since each transitional condition becomes a formula including also the time variable of the preceding transition, on account of the correction concerning the state “age(s,t)”, the alteration is needed for distinguishing them.

(5) In a case where the TNFA on which an upper limit has been imposed is existent, and where the transition between states including an initial state does not satisfy the TNFA after the construction, those of intermediate states which exist in transitions satisfying the upper limit are excluded from states to-be-deleted, and the states which are not excluded are deleted.

Incidentally, upon the appearance of a transition which accompanies a variable that is used in an RPCTL excluded from a subject for abstraction at the step of the abstraction of each CFG, the TNFA is constructed up to the next state, the “abstraction of TNFA” is called in a good place to leave off, in the creation conforming to the constructional policies, and the TNFA under construction is abstracted.

Next, the conversion process from the C-TNFA to the TNFA will be explained in detail. First, the upper limit of transition time periods as based on the number of times of transitions is determined. More specifically, there is found the intense concatenation component of each TNFA, there are found a longest path within the intense concatenation component which maximizes the total of the lower-limit transition time periods of individual transitions passing through transition branches only once, and that one of the tops on the path which minimizes the lower limit of the transition time periods to the tops of succeeding stages, and therefore there are found two paths of the longest path and another path in which path to the succeeding-stage top is added to the longest path. Subsequently, the total of the lower-limit transition time periods of the respective paths is found. Thus, the following is found: Command Interface: 22 23 Graphics Rendering Unit: 28 29 Display Unit: 11 12 Now, values which are obtained by subtracting “1” from the total of the second lower-limit transition time periods of each TNFA are found: Command Interface: 22 Graphics Rendering Unit: 28 Display Unit: 11 The upper-limit time period of the transitions of each TNFA is determined by affording the minimum value of values found for the other TNFAs. If the obtained upper-limit value of the temporal transitions is contradictory, is checked by comparing it with the upper-limit value of the transitions to which the upper limits have already been afforded. If a contradiction exists, the number of times of transitions is increased to 2. Otherwise, the logic link of the linear inequality is constructed by affording the upper limit found for the transitions to which the upper limits have not been afforded. Especially, in the case of increasing the number of times, it is sufficient to calculate a value which is the product between the total of the lower-limit transition time periods of the longest paths and the number of times, and a value which is the sum between the product value and the minimum transition time period found before.

Incidentally, also in a case where the parametric model checking has been performed and where the parameter condition does not have a solution of non-negative integer, the process shall be advanced by increasing the number of times. Here, a linear programming method is employed for the calculation of the non-negative integer solution. Concretely, there is calculated a solution which minimizes the sum of parameters, within a range in which a parameter condition obtained using the free software “LP-SOLV” is satisfied. A case where the solution thus obtained is insignificant, shall be processed by, for example, affixing the minimum value of the parameters.

Here in case of this example, under the assumption that the transition branch can be transited only once, the following is found as the upper limits of the transition time periods of the individual TNFAs: Command Interface: 11 Graphics Rendering Unit: 11 Display Unit: 22 Also, the logic link of linear inequalities as indicated below is obtained without the occurrence of any contradiction: 0<=k1+k2+kloop1<=7 && 5<=kb1+kb2+kb3+k1<=8 && 7<=kb1+3kb2+kb3+k1<=11 && 1<=k1<=11 && 1<=k1+k2+k3+kloop1+k1<=6 && 3<=k4<=11 && 5<=kb1+kb2+kb3+k1<=11 && 6<=kb1+4kb2+kb3+3kr1<=12 && 1<=3kr2+k1<=8 && 9<=kb1+5kb2+kb3+k1<=12 && kr1=kb2−1 && 8<=kb1+5kb2+kb3<=24 && 1<=k1+6kd<=19 Besides, assuming that the transition branch can be transited, at most, twice, the following is found as the upper limits of the transition time periods of the individual TNFAS: Command Interface: 22 Graphics Rendering Unit: 22 Display Unit: 44 and the logic link of linear inequalities as indicated below is obtained: 0<=k1+k2+kloop1<=18 && 5<=kb1+kb2+kb3+k1<=19 && 7<=kb1+3kb2+kb3+k1<=22 && 1<=k1<=22 && 1<=k1+k2+k3+kloop1+k1<=17 && 3<=k4<=2 && 5<=kb1+kb2+kb3+k1<=22 && 6<=kb1+4kb2+kb3+3kr1<=23 && 1<=3kr2+k1<=19 && 9<=kb1+5kb2+kb3+k1<=23 && kr1=kb2-1 && 8<=kb1+5kb2+kb3<=46 && 1<=k1+6kd<=41 This process is a technique called “Assume Guarantee Reasoning”, and the performance thereof in the parametric analysis is not known.

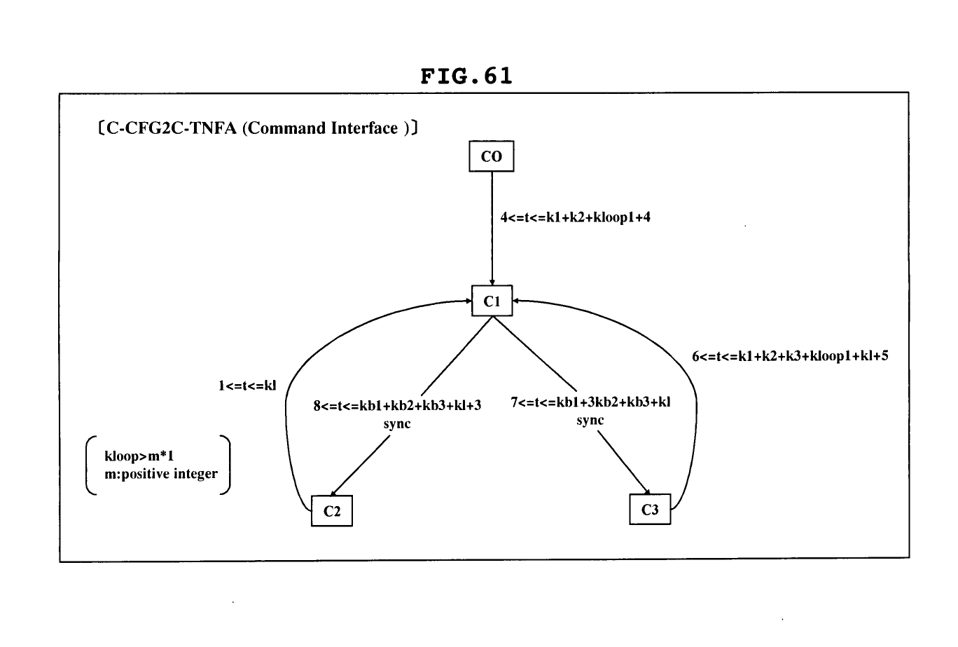

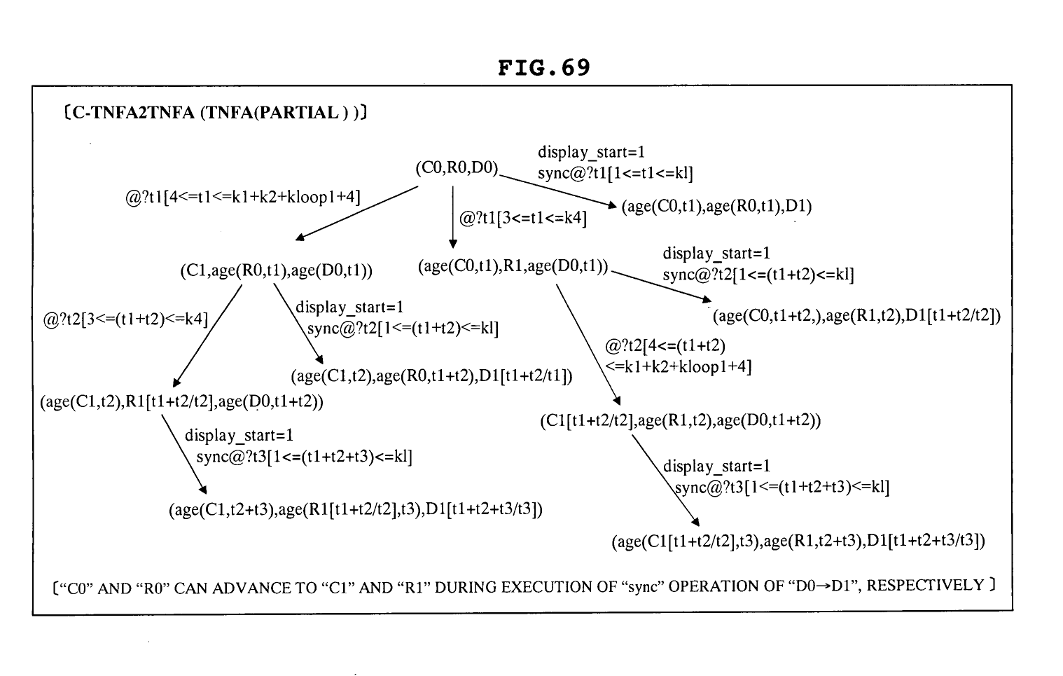

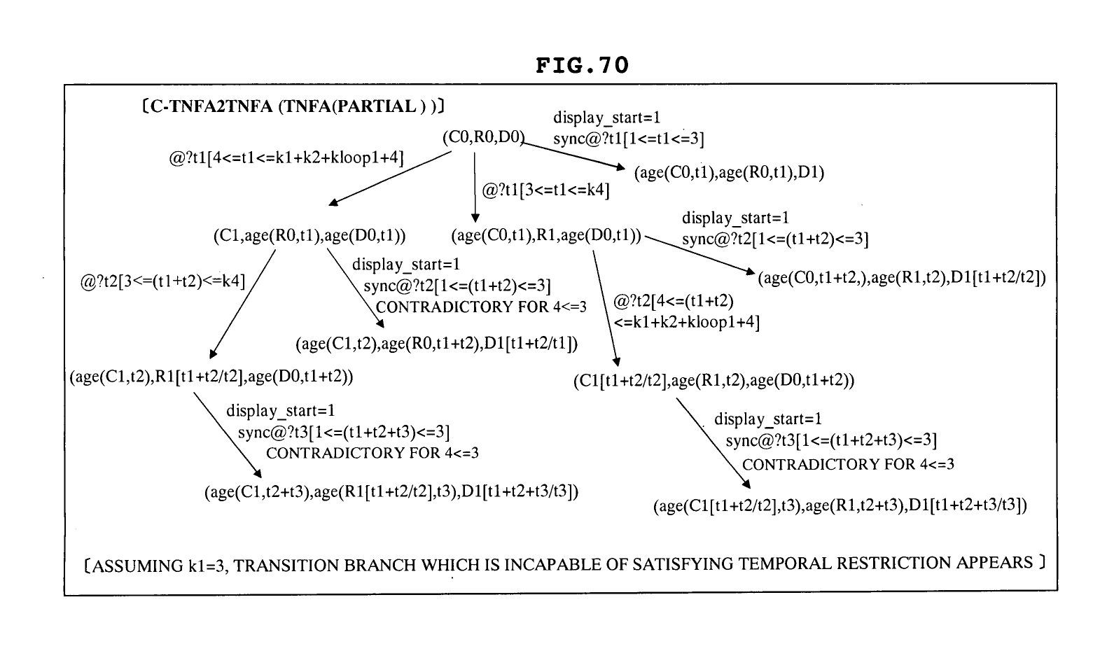

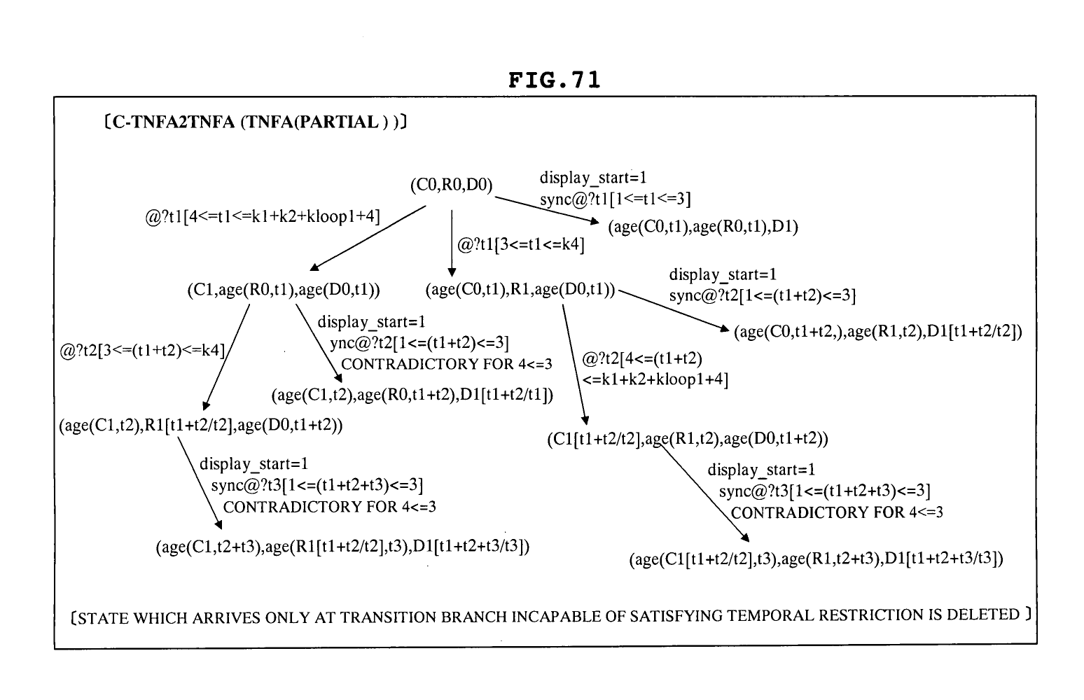

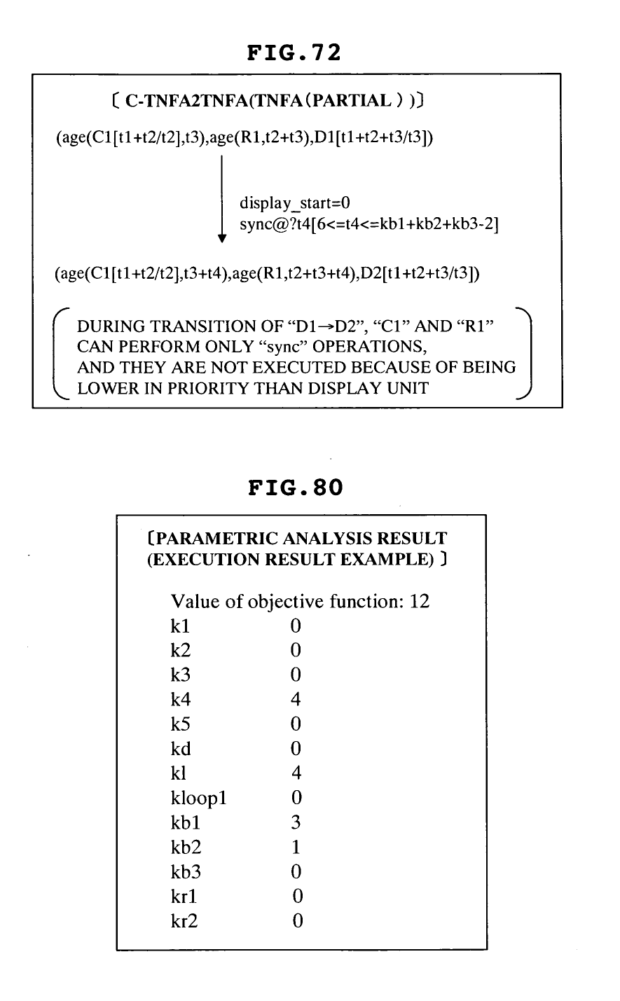

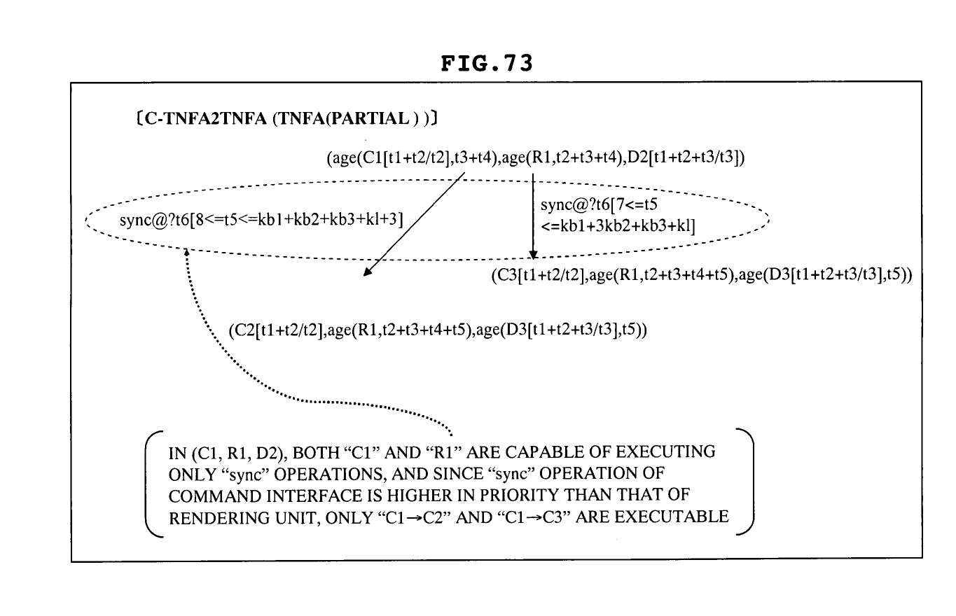

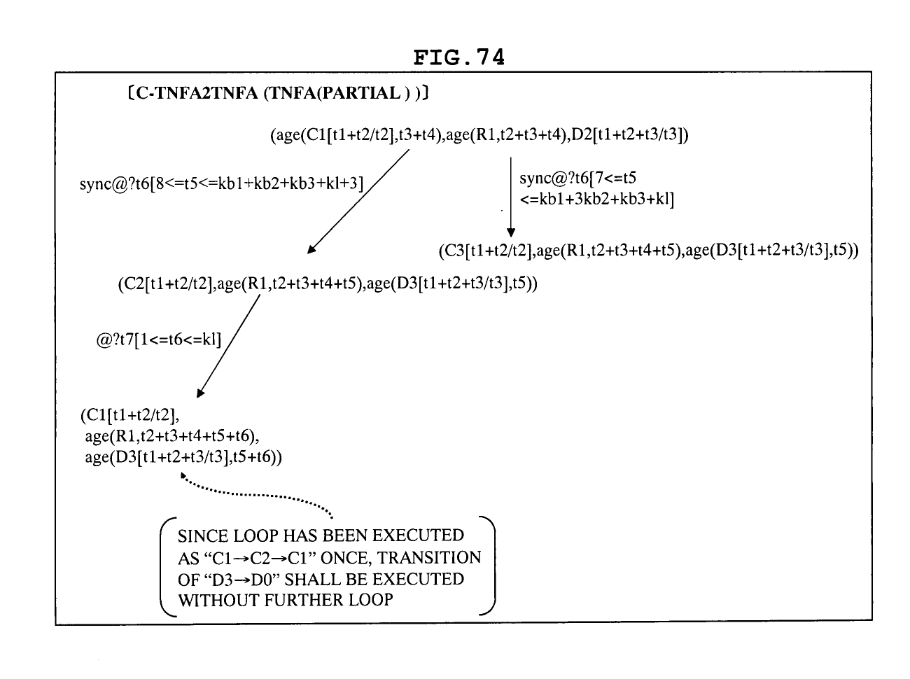

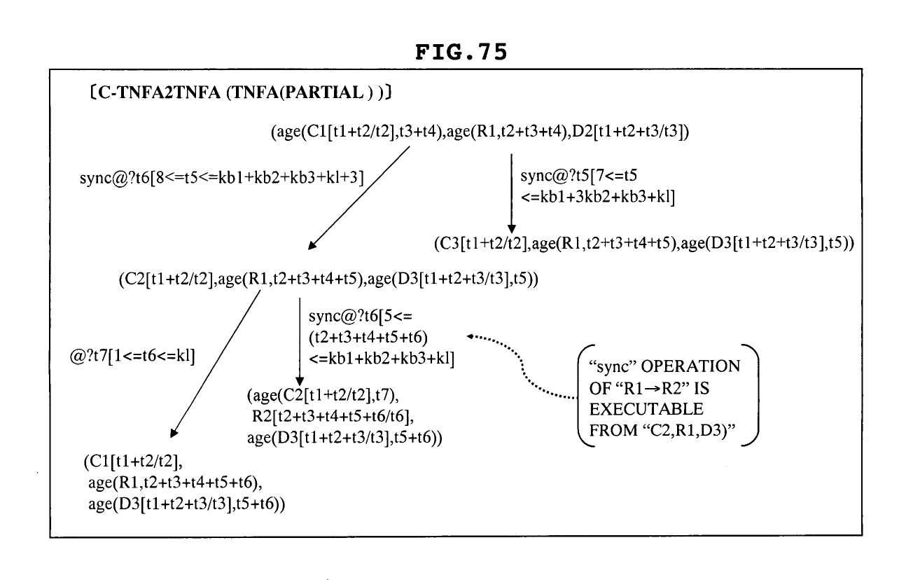

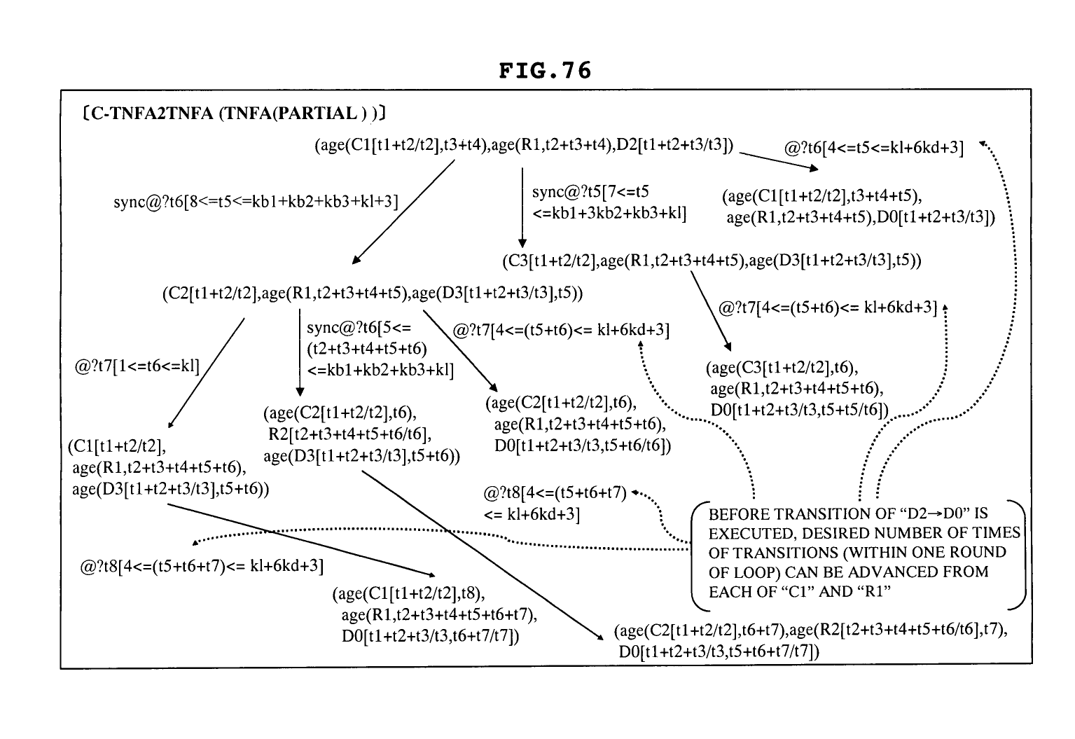

A constructional example of the product TNFA of the TNFAs obtained in FIGS. 61, 64 and 68 is shown in FIG. 69. A course in which the TNFAs are obtained on the basis of the product TNFA is shown in FIGS. 70 through 76.

<<Abstraction of TNFA>>

An abstraction process for the TNFA will be explained. First, the algorithm of the process will be outlined. In the TNFA, only a transition branch in which values have been assigned to variables left in the abstraction, and the start node and end node of the transition branch are left, and while tops and sides are being traversed with a start point at a top to-be-left, until a top to-be-left appears next, a transition time period is recomputed, whereby all the other tops are abstracted. However, states corresponding to leaves are excluded from subjects for the abstraction.

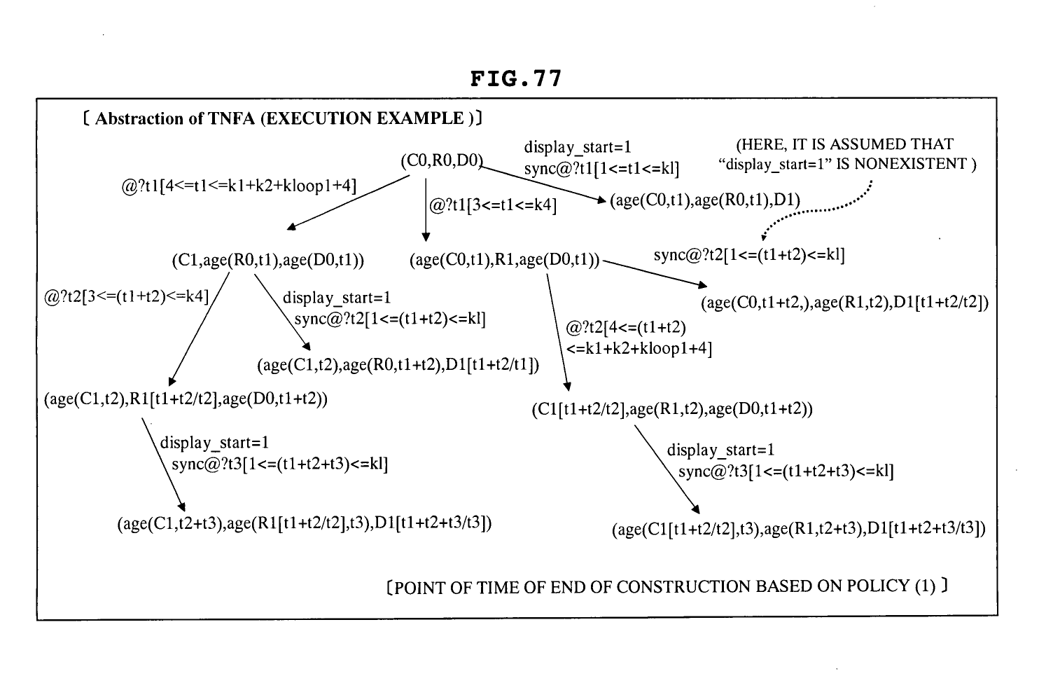

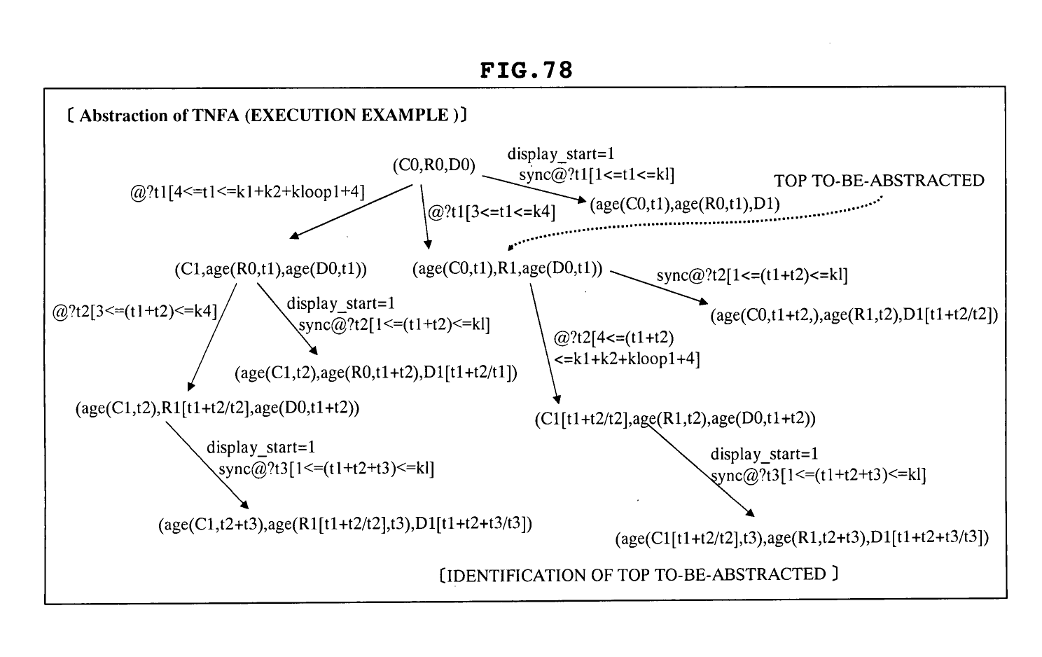

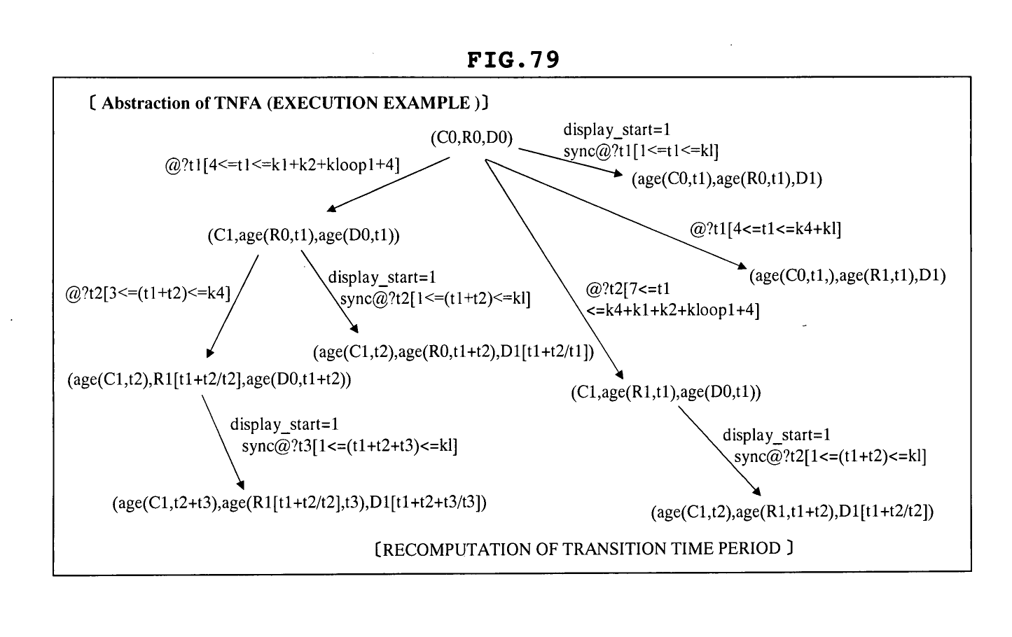

In the preceding example, the TNFA has been constructed only till the stage at which the performance of the abstraction has not occurred yet. Therefore, the preceding example is somewhat revised intentionally so as to necessitate the abstraction, and parts of the course of the process in the case where the “abstraction of TNFA” has been opportunely called at the C-TNFA2TNFA are shown in FIGS. 77 through 79. Here, a concrete value shall not be given to the variable “k1”.

<Parametric Analysis Result>>

When a parameter condition is derived as to the following verification property under the restriction of one time of transitions and at the maximum search depth value of 16 by employing the algorithm stated in the document mentioned before: EF(<displayend>((AF(<renderbegin>true)) and ((AF(<renderend>true)) AU (<displaybegin>true)))) the following condition is obtained: 0<=kd && 0<=kr2 && 0<=krl && 0<=kb3 && 0<=kb2 && 0<=kb1 && 0<=kloop1 && 0<=k5 && 4<=k4 && 0<=k3 && 0<=k1 && 0<=k2 && 12<=kb1+9kb2+kb3 && 4<=k1) A logical product is taken between this parameter condition and the parameter condition found before as obtained from the restriction of one time of transitions: 0<=k1+k2+kloop1<=7 && 5<=kb1+kb2+kb3+k1<=8 && 7<=kb1+3kb2+kb3+k1<=11 && 1<=k1<=11 && 1<=k1+k2+k3+kloop1+k1<=6 && 3<=k4<=11 && 5<=kb1+kb2+kb3+k1<=11 && 6<=kb1+4kb2+kb3+3kr1<=12 && 1<=3kr2+k1<=8 && 9<=kb1+5kb2+kb3+k1<=12 && krl=kb2−1 && 8<=kb1+5kb2+kb3<=24 && 1<=k1+6kd<=19 and as to the obtained parameter condition, the linear programming problem of minimizing the total of individual parameter values as is an objective function is solved by the free software “LP_SOLVE”. Then, a solution in FIG. 80 is obtained.

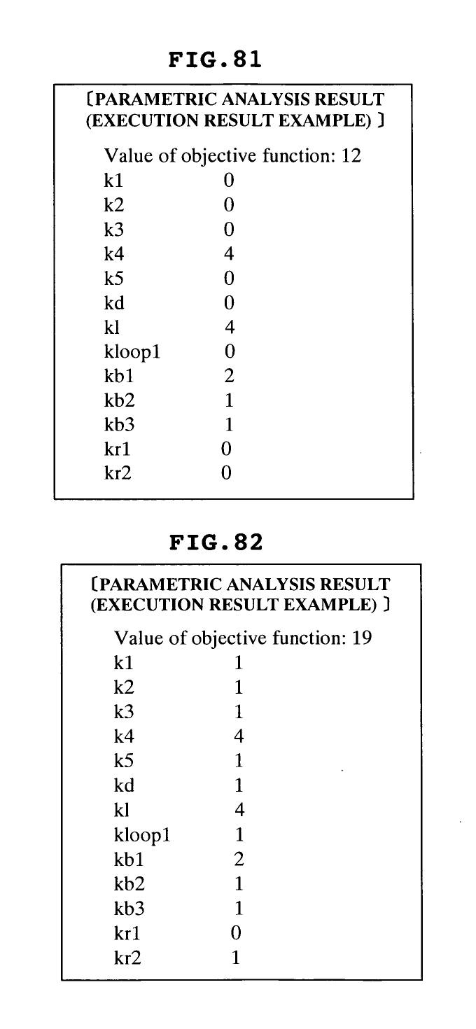

In the result in FIG. 80, a bus access end notification must be given in zero cycle, and a rendering cycle “kr” and a display cycle “kd” are zero, so that the solution cannot be said significant. Therefore, the restrictions of kb1=2, kb2=1 and kb3=1 have been added, whereupon a solution in FIG. 81 has been obtained.

Even in the result in FIG. 81, the rendering cycle “kr2” and the display cycle “kd” are zero, so that the solution cannot be said significant. Therefore, the restriction that parameter variables except “kr1” are at least “1” has been further added besides the restrictions of kb1=2, kb2=1 and kb3=1, whereupon a solution in FIG. 82 has been obtained. Hereinafter, the parameter values of this solution shall be adopted for the ensuing discussions.

<<Hardware Synthesis>>

A hardware synthesis process will be first outlined. Hardware is generated in conformity with policies (1)-(11).

(1) Bus commands are allotted on the basis of the sorts of communication methods registered in the “Register” class beforehand.

(2) Which devices in which any shared registers exist are accepted as user information, and in-device addresses corresponding to the numbers of the registers in the respective devices are allotted.

(3) The number of devices (“run( )” methods) to which shared registers are allocated is acquired, and global addresses are allotted to the devices to which the shared registers are allotted.

(4) Those methods except communication methods which have not been in-lined (expanded) are in-lined. (It should be noted that the methods except the methods designated as the communication methods are in-lined beforehand.)

(5) The execution cycles of the “Basic Block” as obtained from a parametric analysis result are reflected on the synthesizing CFGs of individual devices.

(6) The CFG of each device is transformed, and is converted into a model in which a communication method and the other control flow parts communicate with each other.

(7) A bus command generation description is inserted into a part corresponding to the communication method, within the CFG after the conversion as has been obtained in the preceding policy (6). The communication method becomes a CFG which consists of descriptions for outputting a global address, a shared register address and a bus command, and for executing either of data reading and writing, and cycles which are required for generating and accepting signals therefor are determined by the result of a parametric analysis.

(8) A shared register generates an address decoder which generates the array indexes of registers within each device, and an address decoder which identifies a global address, within the device allocated with shared register addresses, an output tristate is connected to the output of the shared register, and the logical sum of signals expressive of data input stages from individual devices is employed as a tristate enable signal. Regarding the input of the shared register, internal variables hold previous values unless an acceptance operation occurs, and hence, for the signals from a bus, it is sufficient to be connected to the shared register. The shared register renders a data acceptance decision on the basis of the logical sum of the signals expressive of the data input stages from the individual devices. Herein, these operations are expressed as CFGs. (Even when the shared register exists within the pertinent device itself, it shall be regarded as being accessed in accordance with this scheme.)

(9) The signal communication relations (input, output) of each CFG obtained by transformation or the like are identified (input/output for a bus), and they are respectively identified as modules.

(10) Each CFG is converted into an HDL in accordance with the “hardware synthesis from cycle-accurate program descriptions”

(11) A repeater circuit is inserted into a bus in the form of an HDL.

Regarding the allotment of the bus commands, bus access methods registered in this example are “sync_read”, “sync_write”, “sync_burst_read”, “sync_burst_write” and “end_Burst_Access”. However, when the CFGs of the individual “run( )” methods are analyzed, the bus access methods actually used are “sync_burst_read”, “sync_burst_write” and “end_Burst_Access”, and hence, the bus commands are allotted as follows: sync_burst_read 2′b00 sync_burst_write 2′b01 end_Burst Access 2′b01 NOP 2′b11

Regarding the address allotment, the shared register is allocated to only the unified memory, and the allocated shared register has the following addresses in accordance with the specifications of the unified memory: mem_con_reg.current_value[0]: command flag 0, mem_con_reg.current_value[1]: rendering command 0, mem_con_reg.current_value[2]: command flag 1, mem_con_reg.current_value[3]: rendering command 1, mem_con_reg.current_value[4]: rendering source data, and displaying data after rendering, mem_con_reg.current_value[5]: rendering source data, and displaying data after rendering, mem_con_reg.current_value[6]: rendering source data, and displaying data after rendering, mem_con_reg.current_value[7]: rendering source data, and displaying data after rendering, mem_con_reg.current_value[8]: rendering source data, and displaying data after rendering, mem_con_reg.current_value[9]: rendering source data, and displaying data after rendering. Incidentally, it is assumed that the bit widths of the individual registers are designated by user information, and that they are 32 bits (unsigned int), respectively.

Since bus access methods do not make byte accesses in the registers, the addresses of the individual registers are determined as follows: mem_con_reg.current_value[0]: 4′b0000, mem_con_reg.current_value[1]: 4′b0001, mem_con_reg.current_value[2]: 4′b0010, mem_con_reg.current_value[3]: 4′b0011, mem_con_reg.current_value[4]: 4′b0100, mem_con_reg.current_value[5]: 4′b0101, mem_con_reg.current_value[6]: 4′b0110, mem_con_reg.current_value[7]: 4′b0111, mem_con_reg.current_value[8]: 4′b1000, mem_con_reg.current_value[9]: 4′b1001.

Besides, regarding the address allotment, the device to which the shared register is allotted is only the unified memory, so that the global address is not allocated.

By the way, in this example, the shared register is allotted to only one device, but this does not lack in generality in the ensuing description. The fact will be clarified by indicating processing steps later.

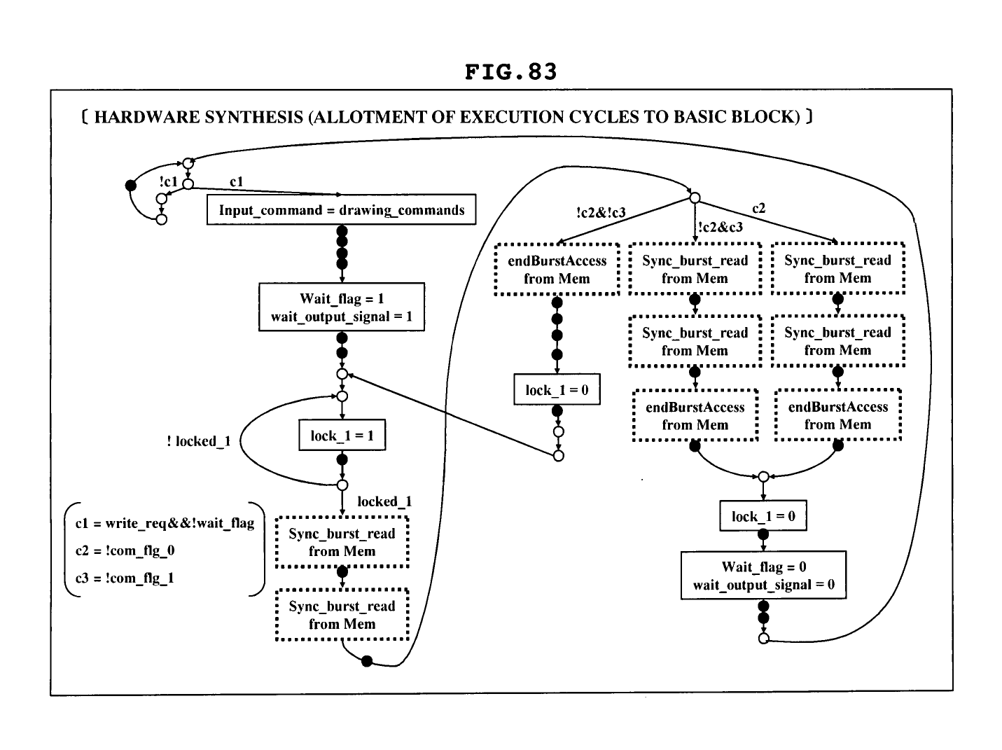

Regarding the allotment of execution cycles to the “BasicBlock”, only the command interface will be referred to here. Especially, k1=4, kb1=2, kb2=1, kb3=1 and k1=k2=k3=1 will be mentioned in accordance with the parameter values found before. A clock boundary in the number of cycles allotted under each “BasicBlock” is inserted on the basis of the parameter condition. Here, it should be noted that the bus access method is not a subject to-be-handled. Further, it should be noted that, although the given parameters are exemplified, generality is not lost. A CFG after transformation will be indicated later. Incidentally, it should be noted that the value of the parameter “k1” does not directly exert influence on the hardware synthesizing CFG of each device. This value exerts influence on only the fixed priority scheduler. An example of the allotment of the execution cycles to the “Basicblock” is shown in FIG. 83.

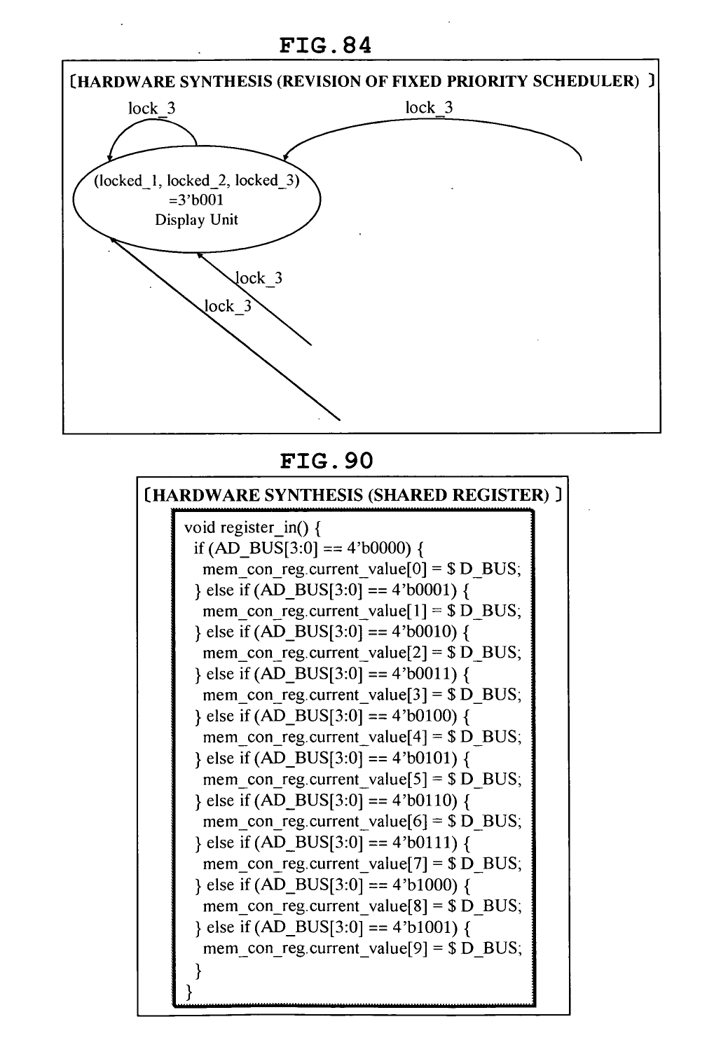

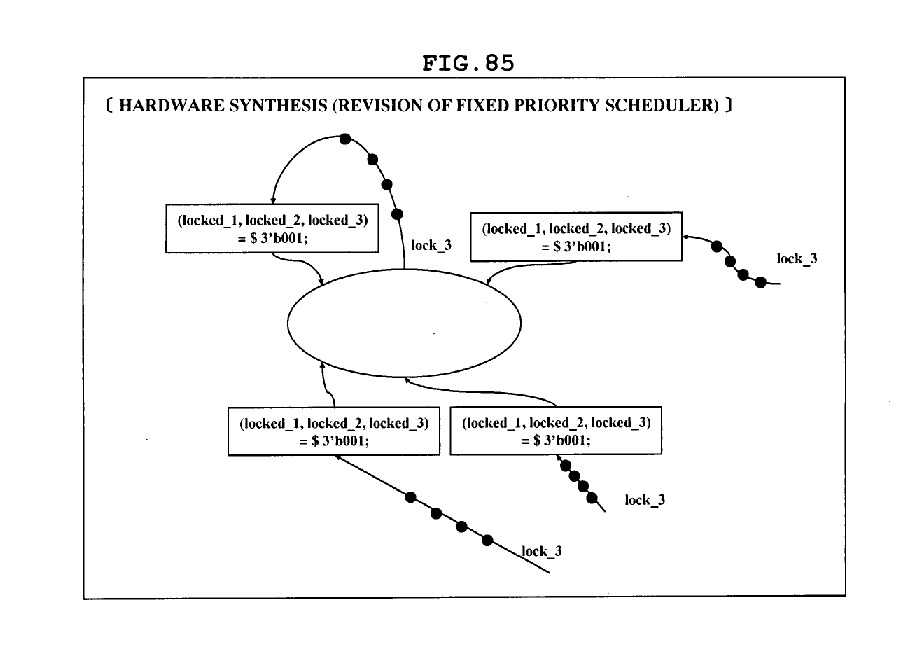

Regarding the revision of the fixed priority scheduler, the transition cycle of the FSM (Finite State Machine) already obtained is altered to the value “k1”. That is, it is sufficient that 4 clock boundaries are added to each transition branch. HDL generation from here is possible in the following way: A transition from each state is expressed into a fork node anew. Besides, a signal assignment in each state is substituted by a form in which the “BasicBlock” is provided directly below the last clock boundary on the transition branch arriving at the state, and in which a register assignment statement is described in the “BasicBlock”, whereby the FMS itself is regarded as the CFG. Thus, the “HDL generation from the cycle-accurate descriptions” is employed. The CFG transformed by employing part of the fixed priority scheduler as shown in FIG. 84 is shown in FIG. 85.

Regarding the transformation of the CFG, the bus access methods are bundled up from within the original CFG, and the communication node between the resulting bus access method and the original CFG is provided. Concretely, the following steps are performed:

1) At the stage of the CFG generation for the hardware synthesis, a clock boundary has been added to the clocks of the bus access method including a clock boundary, directly below a node expressive of the bus access method. The added clock boundary is deleted.

2) The node expressive of the bus access method is substituted by a “BasicBlock” which performs the following processing: (1) “1” is assigned to an output signal “start_comm”. (2) A bus command is assigned to an output signal “bus_cmd”. In case of burst transfer, in an initial cycle, there are performed: <1> assignment of “0” to output signal “init”, <2> concatenation of address of device to-be-accessed and address of shared register, and assignment of resulting address to output signal “address”, <3> clock boundary insertion xnbf, <4> assignment of input signal “data_in” to variable for assignment, subject to read method, <5> assignment of value or variable to-be-output to output signal “data_out”, subject to write method, and <6> clock boundary xmbf. Here, nbf+mbf=kb1 holds. In this example, nbf=mbf=1 is set.

In the case of the burst transfer, at a transfer end, <1> clock boundary insertion xn is performed. Here, n=kb3 holds. In this example, n=1 is set.

In the case of the burst transfer, otherwise, there are performed: <1> assignment of “1” to output signal “init”, <2> concatenation of address of device to-be-accessed and address of shared register, and assignment of resulting address to output signal “address”, <3> clock boundary insertion xnb, <4> assignment of input signal “data_in” to variable for assignment, subject to read method, <5> assignment of value or variable to-be-output to output signal “data_out”, subject to write method, and <6> clock boundary xmb. Here, nb+mb=kb2 holds. In this example, nb=0 and mb=1 are set.

In case of single transfer, there are performed: <1> concatenation of address of device to-be-accessed and address of shared register, and assignment of resulting address to output signal “address”, <2> clock boundary insertion xns, <3> assignment of input signal “data_in” to variable for assignment, subject to read method, <4> assignment of value or variable to-be-output to output signal “data_out”, subject to write method, and <5> clock boundary xms. Here, ns+ms=ks holds. (3) “0” is assigned to the output signal “start_comm”.

3) Isolated nodes expressive of the bus access methods are created, and the communication nodes thereof with the “BasicBlock” generated by the substitution are provided. The communication nodes are as follows: start_comm: “Basicblock”→Isolated node bus_cmd: “BasicBlock”→Isolated node address: “BasicBlock”→Isolated node data_in: Isolated node→“BasicBlock” data_out: “BasicBlock”→Isolated node

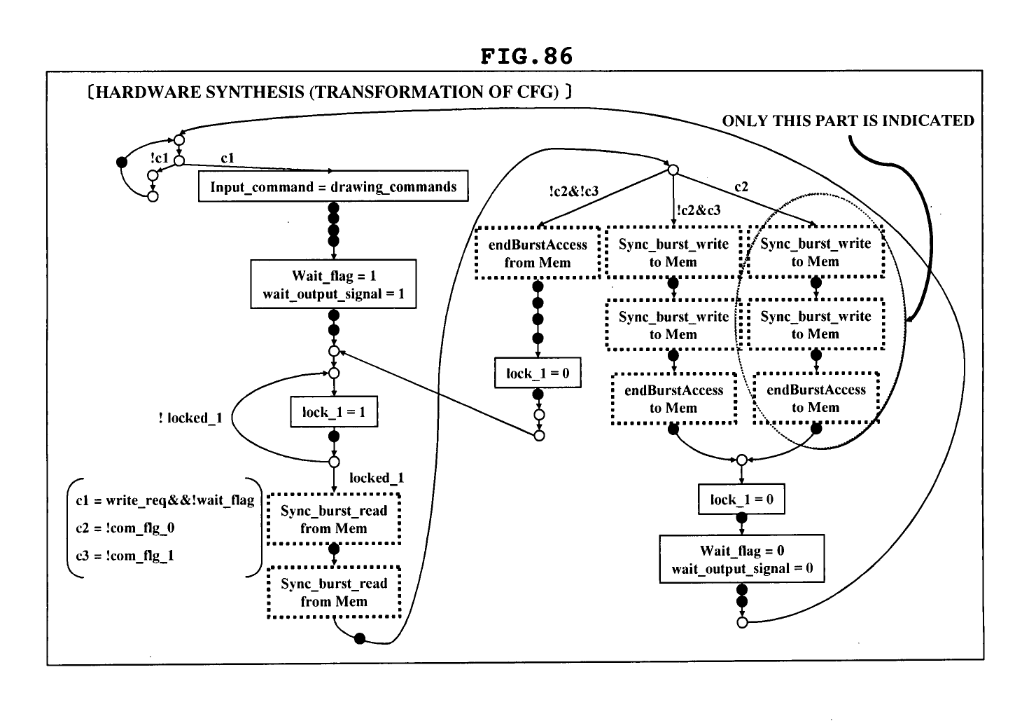

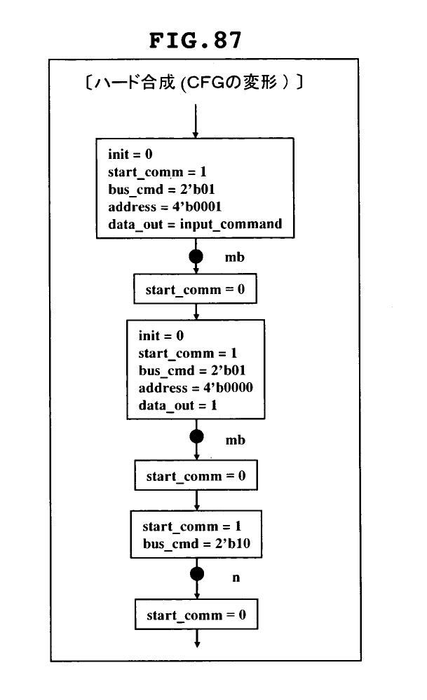

Parts of the CFG of the command interface after the transformation are shown in FIGS. 86 and 87. In FIG. 87, variables indicated sideward of clock boundaries are parameters, which signify that the clock boundaries are generated in those numbers.

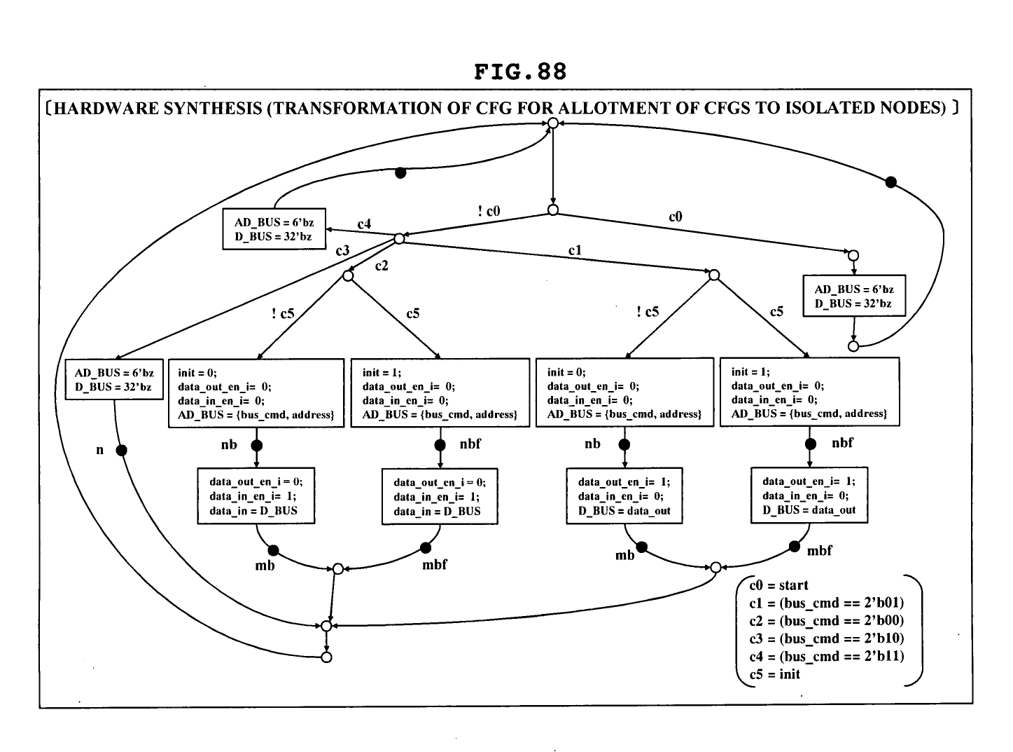

Regarding the allotment of CFGs to the isolated nodes, a CFG in FIG. 88 is automatically generated. Especially in FIG. 88, “AD_BUS” denotes an address bus, while “D_BUS” denotes a data bus. “data_in_en_i” denotes a data input stage, and “data_out_en_i” a data output stage. Here, “i” expresses the indexes of the individual devices. Besides, the bus width of the address bus is set at the total of the bit width of an allotted bus command and that of an address, while the bus width of the data bus is set at the bit width of each register to-be-accessed. Further, variables written sideward of clock boundaries are parameters, which signify that the clock boundaries are generated in those numbers. Incidentally, the values of the respective variables are equal to the values of the variables used in the course of the transformation of the CFG.

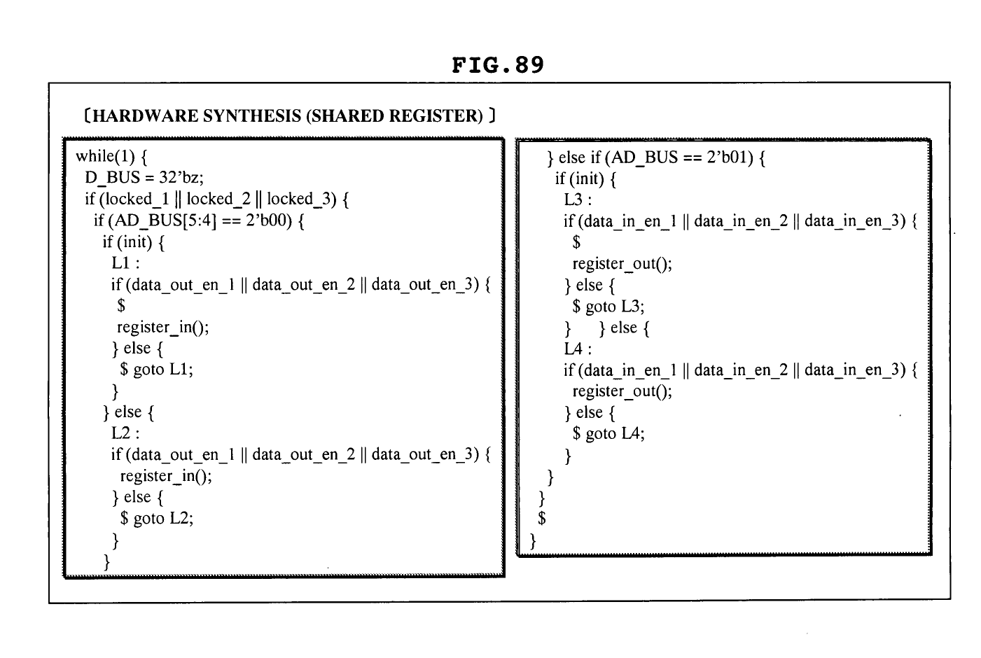

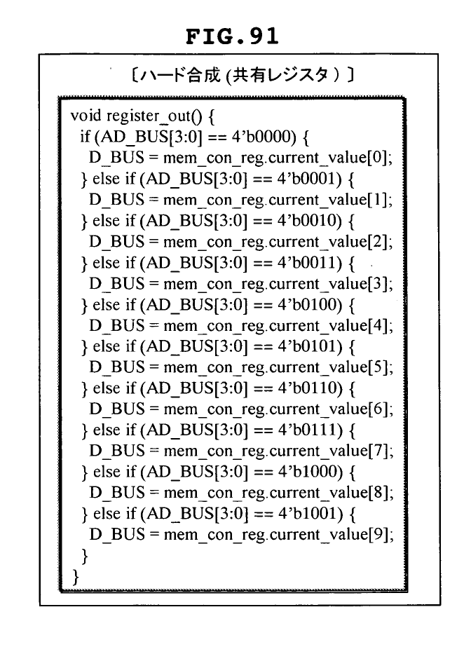

Regarding the shared register, a CFG which corresponds to descriptions in FIG. 89 as subjected to in-line expansion may be generated. Herein, separations to the input and output of the input/output variables AD_BUS and D-BUS shall not be performed. Besides, in optimization on the CFG, variable optimizations for the variables AD_BUS and D-BUS shall not be performed. Pseudo C descriptions concerning the shared register are shown in FIGS. 89, 90 and 91. Regarding the HDL generation from the cycle-accurate descriptions, reference can be had to a preceding application (Japanese Patent Application No. 2002-300073), the inventors of which are the same as in this patent application.

Although the invention made by the inventors has been concretely described above in conjunction with embodiments, it is needless to say that the present invention is not restricted to the embodiments, but that it is variously alterable within a scope not departing from the purport thereof.

By way of example, regarding the construction of a product automaton, “Assume Guarantee Reasoning” has been performed on the basis of the number of times of passes through transition branches in constructing a TNFA product automaton, but it ought to be performed on the basis of the number of times of passes through “sync” operations. The reasons therefor are that the “sync” operation signifies a bus access operation, so how many times a TNFA operating in parallel has performed the “sync” operations corresponds to how many times a device corresponding to the TNFA has made bus accesses, and that, not only the condition of transition cycles, but also information on the maximum number of times of bus accesses which each device makes during the execution of the verification property of the condition is obtained by “Refinement” and parametric model checking. With this technique, however, a combinatorial explosion can occur, and hence, any tree-pruning at high speed is necessitated.

Regarding the construction of the product automaton, it has been performed this time that the necessary condition satisfying the verification property is found as bounded model checking without closely examining the termination property of the parametric model checking, but a sufficient condition ought to be found. Therefore, a study on the termination property of an algorithm needs to be further made.

Regarding the expansion of a bus model, it is also allowed to handle a multiple-bus system which includes, not only a single bidirectional bus, but also a unidirectional bus or a local bus, or in which buses are hierachized through a bus bridge.

Besides, although only a horizontal retrace time period has been handled, also a vertical retrace time period ought to be modeled, and a sufficient condition for ending the rendering of at least one frame during the display of one frame needs to be found.

The present invention is extensively applicable to a data processing system which synthesizes the hardware of a digital circuit from a language capable of describing parallel operations, and so forth.

What is claimed is:

1. A system development method comprising:
a step of inputting program descriptions which define a plurality of devices by employing a program language capable of describing parallel operations;
a step of converting the input program descriptions into an intermediate expression;
a step of generating parameters which satisfy a real-time restriction, for the intermediate expression; and
a step of synthesizing circuit descriptions which are based on a hardware description language, on the basis of the generated parameters.

2. A system development method as defined in claim 1, wherein the intermediate expression is a member selected from the group consisting of a concurrent control flow flag, a temporal automaton with a concurrent parameter, and a temporal automaton with parameters.

3. A system development method as defined in claim 2, wherein parametric model checking is performed for the parameter generation.

4. A system development method as defined in claim 3, wherein the real-time restriction is given by RPCTL.

5. A system development method as defined in claim 4, wherein the program descriptions define the devices by using a “run” method, and define clock synchronizations of the devices by using barrier synchronizations.

6. A data processing system comprising:
a computer;
said computer inputting program descriptions which define a plurality of devices by employing a program language capable of describing parallel operations, converting the input program descriptions into an intermediate expression, generating parameters which satisfy a real-time restriction, for the intermediate expression, and synthesizing circuit descriptions which are based on a hardware description language, on the basis of the generated parameters.

7. A data processing system as defined in claim 6, wherein the program descriptions define the devices by using a “run” method and define clock synchronizations of the devices by using barrier synchronizations.
